(19) United States
(12) Patent Application Publication
(10) Pub. No.: US 2021/0105196 A1
(43) Pub. Date: Apr. 8, 2021

(54) SUPPORT GROUP COMMUNICATIONS WITH SHARED DOWNLINK DATA

(71) Applicants: Ngoc Dung DAO, Ottawa (CA); Xu LI, Nepean (CA)

(72) Inventors: Ngoc Dung DAO, Ottawa (CA); Xu LI, Nepean (CA)

(73) Assignee: HUAWEI TECHNOLOGIES CO., LTD., Shenzhen (CN)

(21) Appl. No.: 17/035,312

(22) Filed: Sep. 28, 2020

Related U.S. Application Data
(60) Provisional application No. 62/911,038, filed on Oct. 4, 2019.

(51) Int. Cl. H04L 12/26; H04L 12/851; H04L 12/18; H04L 12/891

(52) U.S. Cl. CPC H04L 43/026; H04L 43/08; H04L 43/028; H04L 12/185; H04L 47/41; H04L 47/24

(57) ABSTRACT

Method and system for group communications with shared downlink data are provided. An aspect of the disclosure provides a method for switching the downlink delivery method between a unicast delivery and a shared delivery so that downlink resource usage is reduced. The method performed by a session management function (SMF) includes, receiving a request from a network exposure function (NEF) for modifying the session of a previously established packet data unit session for a user equipment. The request from the NEF indicates a switch of a downlink delivery method. The method further includes sending instructions to other network functions to implement the modification. The method further includes sending a response to the NEF confirming the execution of the request from the NEF.

### CROSS-REFERENCE TO RELATED APPLICATION

This application claims the benefit of priority to the U.S. Patent Application having Ser. No. 62,911,038 and entitled “SUPPORT GROUP COMMUNICATIONS WITH SHARED DOWNLINK DATA” filed Oct. 4, 2019, which is hereby incorporated by reference in its entirety.

### FIELD OF THE INVENTION

The present disclosure generally relates to the field of communications networks, and particular embodiments or aspects relate to methods and systems for supporting group communication with shared downlink (DL) data.

### BACKGROUND

In group communications scenarios, a communication network may not be aware of the group communications among a specific group of users, and may be unable to improve the use of the network resources. Group communications may involve, for example, a group of game devices connected to a game server or in the context of video or voice conferencing, in which one user may receive shared video data from other users, receive control signal from the application server (AS), and send its uplink video data.

In the case of public safety networks, group communications may occur among a group of public officers, each officer using a mobile device connected to a centralized operator. Each officer may speak using his or her device while others can listen. Further, the device of the centralized operator may send control signal to each device of the officers.

In these group communication examples, members of the group, a UE for example, may not know the existence of a shared data in the downlink and how to access the shared data. Each UE member may receive shared data over a unicast or a multicast or a broadcast radio channel, however, these method of receiving shared data may not be an efficient use of the network resources.

Further, if the UE member moves to a new radio node, the UE may not know how to continue receiving the shared data such that the network resources are optimized.

Accordingly, there is a need for a system and method that at least partially addresses one or more limitation of the prior art.

This background information is intended to provide information that may be of possible relevance to understanding problems solved by the present disclosure. No admission is necessarily intended, nor should be construed, that any of the preceding information constitutes prior art against the present disclosure.

### SUMMARY

It is an object of the present disclosure to obviate or mitigate at least one disadvantage of the prior art.

An aspect of the disclosure provides for a method by a session management function (SMF). The method includes receiving, from a network exposure function (NEF), a request for a protocol data unit (PDU) session modification, the request associated with at least one PDU session of at least one user equipment (UE), the request further indicating a switching between one of two different downlink delivery methods. The method further includes sending instructions to other network functions according to the request. The method further includes sending, to the NEF, a response indicating a result of the request. The method allows for switching the downlink delivery method for reducing downlink resource usage. The method further provides for reducing downlink resource usage by releasing or deactivating downlink user plane resources of associated PDU sessions.

In some embodiments, the request further includes at least one of: packet filter information; an indication to release network resources assigned to at least one DL QoS flow of the at least one UE; an indication to deactivate network resources assigned to the at least one DL QoS flow of the at least one UE; time information, and location information. In some embodiments, the step of sending instructions to other network functions according to the request includes sending, to at one user plane function (UPF), instructions to monitor one or more DL quality of service (QoS) flow associated with at least one packet detection rule (PDR), and receiving, from the at least one UPF, a notification indicating that no packets were detected for the DL QoS flow. In some embodiments, the SMF receives the notification after an expiration of a time period included in the instructions. In some embodiments, the request includes an indication to release network resources assigned to at least one DL quality of service flow (QoS). In some embodiments, the step of sending instructions to other network functions according to the request includes sending an N4 session modification request to at least one user plane function (UPF) to release information of the at least one DL QoS flow. In some embodiments, the information of the at least one DL QoS flow includes a packet filter in at least one of a packet detection rule (PDR) and a packet forwarding action rule (FAR). In some embodiments, the request includes an indication to deactivate network resources assigned to at least one DL QoS flow. In some embodiments, the step of sending instructions to other network functions according to the request includes sending an N 4 session modification request to at least one user plane function (UPF) to release at least one packet forwarding action rule (FAR) associated with the at least one DL QoS flow. In some embodiments, the method further includes receiving, from the at least one UPF, a notification indicating detection of a packet associated with the at least one DL QoS flow. In some embodiments, the step of sending instructions to other network functions according to the request includes sending to a radio access network (RAN) node, via an AMF, information indicating one or more of: addition, modification, and removal of one or more DL quality of service (QoS) flows, wherein the information including one or more of: a QoS profile and a QoS flow identifier (QFI). In some embodiments, the two different DL delivery methods include a first DL delivery method being a unicast delivery associated with a unicast PDU session of the at least one PDU session and a second DL delivery method being a multicast/broadcast (MB) delivery associated with a MB session of the at least one PDU session. In some embodiments, the request includes information on DL Quality of Service (QoS) flow of the unicast PDU session used for delivering shared data and information on the MB session. In some embodiments, the switching is from the second DL method to the first DL method, and the request includes a list of at least one UE identifier for receiving data according to the first DL delivery method; and one or more locations associated with the first DL delivery method.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 is a block diagram of an electronic device within a computing and communications environment that may be used for implementing devices and methods in accordance with representative embodiments of the present disclosure;

FIG. 2 is a communication model between multiple UEs and an application server, according to an embodiment of the present disclosure;

FIG. 3 illustrates a service-based architecture 300 for a 5G or Next Generation Core Network (5GCN/NGCN/NCN) to support group communications, according to an embodiment of the present disclosure;

FIG. 4 is an illustration of a simplified 5G system supporting group communications, according to an embodiment of the present disclosure;

FIG. 5 is a procedure for switching from a unicast delivery to MB delivery, according to an embodiment of the present disclosure;

FIG. 6 is an illustration of a method to switch downlink delivery method triggered by the AF, according to an embodiment of the present disclosure;

FIG. 7A and FIG. 7B are illustrations of UE or network requested protocol data unit (PDU) Session Modification procedure (for non-roaming and roaming with local breakout scenario), according to an embodiment of the present disclosure;

FIG. 8A and FIG. 8B are illustrations of an Xn based inter NG-RAN handover procedure without UPF re-allocation, according to an embodiment of the present disclosure;

FIG. 9 is an illustration of a PDU Session Establishment authentication/authorization procedure by a DN-AAA server, according to an embodiment of the present disclosure;

FIG. 10 is an illustration procedure for selecting an MB Session Anchor UPF for an MB session, according to an embodiment of the present disclosure;

FIG. 11A and FIG. 11B are illustrations of a UE-requested PDU Session Establishment for non-roaming and roaming with local breakouts, according to an embodiment of the present disclosure; and

FIG. 12A and FIG. 12B are illustrations of a method for using an existing PDU session to receive MB data within a UE or a network requested PDU session modification procedure for non-roaming and roaming with local breakout, according to an embodiment of the present disclosure.

FIG. 13 is an illustration of a method for distributing MB data to multiple UEs using individual N3 interface for each UE in the core network (CN) and individual unicast data radio bearers (DRB) for each UE.

FIG. 14 is an illustration of a method for distributing MB data to multiple UEs using a shared downlink N3 or N3MB interface in the CN for multiple UEs and individual DRB in the radio (R)AN for each UE.

FIG. 15 is an illustration of a method for distributing MB data to multiple UEs by using a shared downlink N3 or N3MB interface in the CN for multiple UEs and a shared MB DRB in the radio (R)AN for multiple UEs.

It will be noted that throughout the appended drawings, like features are identified by like reference numerals.

### DETAILED DESCRIPTION

In the following description, features of the present disclosure are described by way of example embodiments. For convenience of description, these embodiments make use of features and terminology known from communication system specifications, such as 4G and 5G networks, as defined by the Third Generation Partnership Project (3GPP). However, it may be understood that the present disclosure is not limited to such networks.

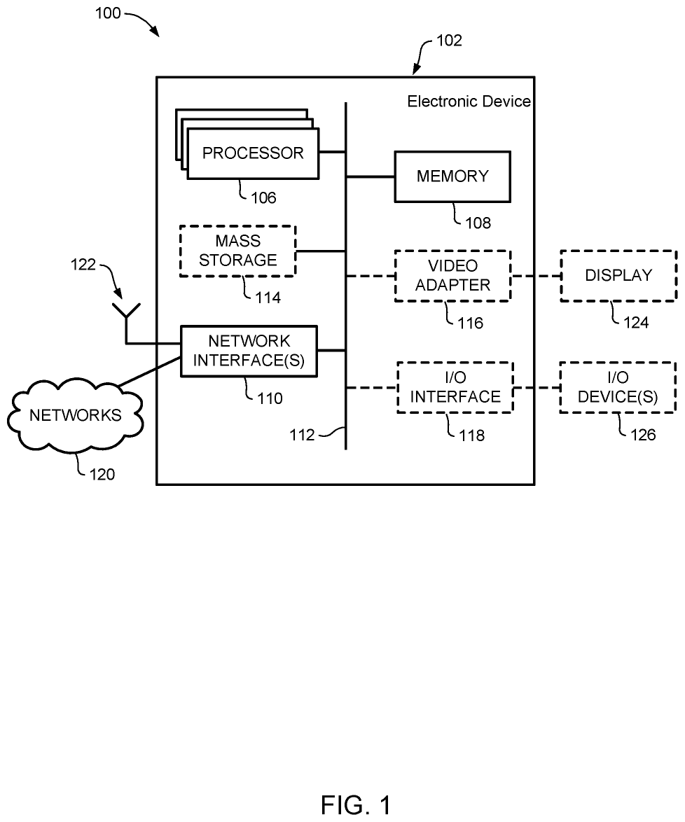

FIG. 1 is a block diagram of an electronic device (ED) 102 illustrated within a computing and communications environment 100 that may be used for implementing the devices and methods disclosed herein. In some embodiments, the electronic device 102 may be an element of communications network infrastructure, such as a base station (for example a NodeB, an enhanced Node B (eNodeB), a next generation NodeB (sometimes referred to as a gNodeB or gNB)), a home subscriber server (HSS), a gateway (GW) such as a packet gateway (PGW) or a serving gateway (SGW) or various other nodes or functions within an evolved packet core (EPC) network. In other embodiments, the electronic device 102 may be a device that connects to network infrastructure over a radio interface, such as a mobile phone, smart phone or other such device that may be classified as a User Equipment (UE). In some embodiments, ED 102 may be a Machine Type Communications (MTC) device (also referred to as a machine-to-machine (m2m) device), or another such device that may be categorized as a UE despite not providing a direct service to a user. In some references, an ED 102 may also be referred to as a mobile device (MD), a term intended to reflect devices that connect to mobile network, regardless of whether the device itself is designed for, or capable of, mobility. Specific devices may utilize all of the components shown or only a subset of the components and levels of integration may vary from device to device. Furthermore, a device may contain multiple instances of a component, such as multiple processors, memories, transmitters, receivers, etc. The electronic device 102 typically includes a processor 106, such as a Central Processing Unit (CPU), and may further include specialized processors such as a Graphics Processing Unit (GPU) or other such processor, a memory 108, a network interface 110 and a bus 112 to connect the components of ED 102. ED 102 may optionally also include components such as a mass storage device 114, a video adapter 116, and an I/O interface 118 (shown in dashed lines).

The memory 108 may comprise any type of non-transitory system memory, readable by the processor 106, such as static random-access memory (SRAM), dynamic random access memory (DRAM), synchronous DRAM (SDRAM), read-only memory (ROM), or a combination thereof. In specific embodiments, the memory 108 may include more than one type of memory, such as ROM for use at boot-up, and DRAM for program and data storage for use while executing programs. The bus 112 may be one or more of any type of several bus architectures including a memory bus or memory controller, a peripheral bus, or a video bus.

The electronic device 102 may also include one or more network interfaces 110, which may include at least one of a wired network interface and a wireless network interface. As illustrated in FIG. 1, network interface 110 may include a wired network interface to connect to a network 120, and also may include a radio access network interface 122 for connecting to other devices over a radio link. When ED 102 is network infrastructure, the radio access network interface 122 may be omitted for nodes or functions acting as elements of the Core Network (CN) other than those at the radio edge (e.g. an eNB). When ED 102 is infrastructure at the radio edge of a network, both wired and wireless network interfaces may be included. When ED 102 is a wirelessly connected device, such as a User Equipment, radio access network interface 122 may be present and it may be supplemented by other wireless interfaces such as WiFi network interfaces. The network interfaces 110 allow the electronic device 102 to communicate with remote entities such as those connected to network 120.

The mass storage 114 may comprise any type of non-transitory storage device configured to store data, programs, and other information and to make the data, programs, and other information accessible via the bus 112. The mass storage 114 may comprise, for example, one or more of a solid-state drive, hard disk drive, a magnetic disk drive, or an optical disk drive. In some embodiments, mass storage 114 may be remote to the electronic device 102 and accessible through use of a network interface such as interface 110. In the illustrated embodiment, mass storage 114 is distinct from memory 108 where it is included, and may generally perform storage tasks compatible with higher latency, but may generally provide lesser or no volatility. In some embodiments, mass storage 114 may be integrated with a memory 108 to form an heterogeneous memory.

The optional video adapter 116 and the I/O interface 118 (shown in dashed lines) provide interfaces to couple the electronic device 102 to external input and output devices. Examples of input and output devices include a display 124 coupled to the video adapter 116 and an I/O device 126 such as a touch-screen coupled to the I/O interface 118. Other devices may be coupled to the electronic device 102, and additional or fewer interfaces may be utilized. For example, a serial interface such as Universal Serial Bus (USB) (not shown) may be used to provide an interface for an external device. Those skilled in the art will appreciate that in embodiments in which ED 102 is part of a data center, I/O interface 118 and Video Adapter 116 may be virtualized and provided through network interface 110.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

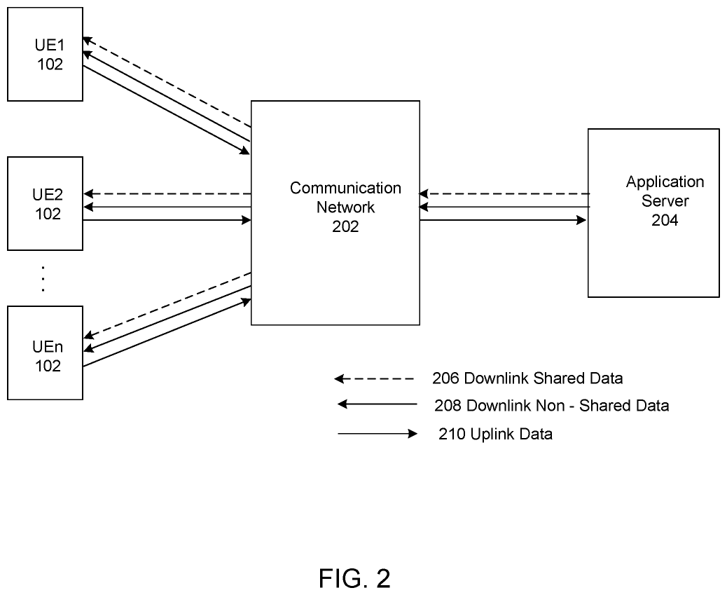

FIG. 2 is a communication network model between multiple UEs and an application server, according to an embodiment of the present disclosure. Referring to FIG.2, multiple UEs 102 (UE1, UE2 . . . UEn) are communicating with one application server (AS) 204 via the communication network 202. Each UE 102 receives non-shared data 208 and shared data 206 from the AS 204. Each UE 102 may send uplink data 210 to the AS 204. The uplink data 210 of one UE, for example UE1, may be sent to one or more UEs for example, UE2, as DL shared 206 or non-shared data 208.

The communication model of FIG. 2 may be found in many group communications scenarios. For example, a group of game devices may be connected to a game server in which the game devices are performing group communications as described in FIG. 2. Another example may be video or voice conferencing among group members, in which one user may receive shared video data from other users, receive control signal from the AS, and send its uplink video data to, for example, the AS. Another example may be group communications used in public safety network, such as a group of public officers, in which each officer may be using a mobile device connected to a centralized operator. Each officer may speak using his or her device while others listen. Further, the device of the centralized operator may send control signal to each device of officers.

In order to optimize the resource usage of a communication network, such as a mobile network, the communication network may need to be aware of group communications among a specific group of users. Embodiments in this disclosure provide methods for determining how a UE in group communications learns the existence of shared data in the downlink and how to access the shared data. Embodiments further provide for determining how a UE can continue receiving shared data when the UE moves to a new radio node. Embodiments further provide for determining how a UE may switch the delivery method of downlink shared data to optimize/improve the network resources. For example, a UE may switch the delivery method of downlink shared data from a unicast delivery to a multicast or broadcast delivery, thereby releasing the resources used for the unicast delivery.

A multicast session is a data session, in which a data source, such as an application server in a data network, sends the same data to multiple targeted UEs. A broadcast session is a data session, in which the data source sends the same data to any UEs at a location. The location could be a geographical area, where the network operator provides communication service by using wireless or wireline devices to transmit data to the UEs.

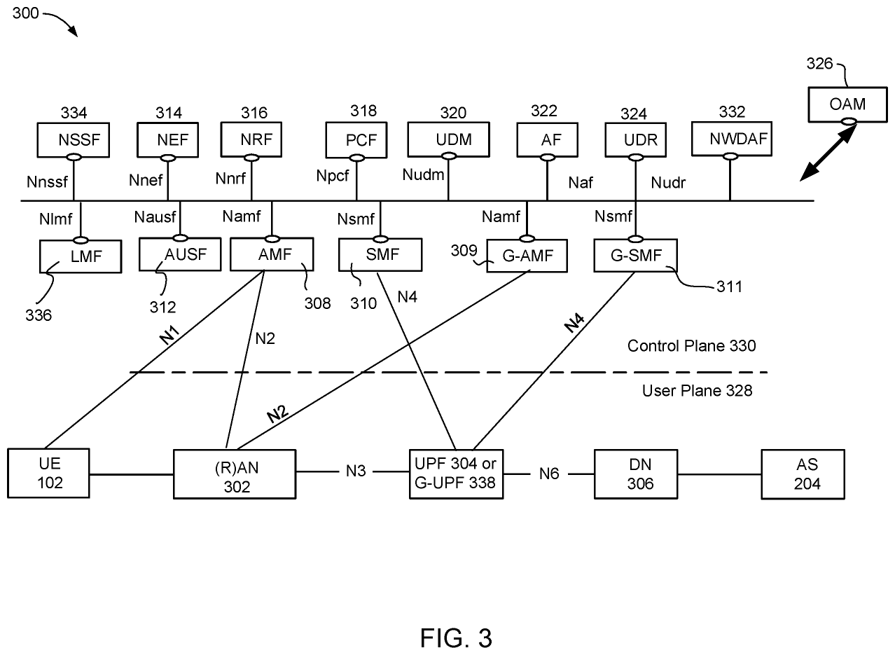

FIG. 3 illustrates a service-based architecture 300 for a 5G or Next Generation Core Network (5GCN/NGCN/NCN) to support group communications, according to an embodiment of the present disclosure. This illustration depicts logical connections between nodes and functions, and thus the illustrated connections should not be interpreted as direct physical connections. UE 102, which may be similar to ED 102, forms a radio access network connection with a (Radio) Access Network ((R)AN) node 302 (which may, for example, be an gNodeB (gNB)), which is connected to a User Plane (UP) Function (UPF) 304 such as a UP Gateway over a network interface providing a defined interface such as an N3 interface. UPF 304 provides a logical connection to a Data Network (DN) 306 over a network interface such as an N6 interface. The radio access network connection between the UE 102 and the (R)AN node 302 may be referred to as a Data Radio Bearer (DRB).

DN 306 may be a data network used to provide an operator service, or it may be outside the scope of the standardization of the Third Generation Partnership Project (3GPP), such as the Internet, a network used to provide third party service. In some embodiments DN 306 may represent an Edge Computing network or resource, such as a Mobile Edge Computing (MEC) network.

UE 102 also connects to the Access and Mobility Management Function (AMF) 308 through a logical N1 connection (although the physical path of the connection is not direct). The AMF 308 and Group AMF (G-AMF) 309 are responsible for authentication and authorization of access requests, as well as mobility management functions. In a service based view, AMF 308 and G-AMF 309 can communicate with other core network control plane functions through a service based interface denoted as Namf.

The Session Management Functions (SMF) 310 and Group SMF (G-SMF) 311, are network functions that are responsible for the allocation and management of IP addresses that are assigned to a UE 102 as well as the selection of a UPF 304 (or a particular instance of a UPF 304) for traffic associated with a particular session of UE 102. It will be appreciated that there will typically be multiple SMFs 310, in this illustration SMF 310 and G-SMF 311, in the network 300, each of which may be associated with a respective group of UEs 102, (R)AN nodes 302 or UPFs 304. The SMF 310 and G-SMF 311 can communicate with other core network functions, in a service based view, through a service based interface denoted as Nsmf. The SMF 310 and G-SMF 311 may also connect to a UPF 304 through a logical interface such as network interface N4.

The Authentication Server Function (AUSF) 312 provides authentication services to other network functions over a service based Nausf interface.

A Network Exposure Function (NEF) 314 can be deployed in the network to allow servers, functions and other entities such as those outside a trusted domain to have exposure to services and capabilities within the network. In one such example, an NEF 314 can act much like a proxy between an application server outside the illustrated network and network functions such as the Policy Control Function (PCF) 318, the SMF 310 and G-SMF 311, the Unified Data Management Function (UDM) 320, the AMF 308 and G-AMF 309, so that the external application server can provide information that may be of use in the setup of the parameters associated with a data session. The NEF 314 can communicate with other network functions through a service based Nnef network interface. The NEF 314 may also have an interface to non-3GPP functions.

A Network Repository Function (NRF) 316, provides network service discovery functionality. The NRF 316 may be specific to the Public Land Mobility Network (PLMN) or network operator, with which it is associated. The service discovery functionality can allow network functions and UEs connected to the network to determine where and how to access existing network functions, and may present the service based interface Nnrf.

The PCF 318 communicates with other network functions over a service based Npcf interface, and can be used to provide policy and rules to other network functions, including those within the control plane. Enforcement and application of the policies and rules is not necessarily the responsibility of the PCF 318, and is instead typically the responsibility of the functions to which the PCF 318 transmits the policy. In one such example the PCF 318 may transmit policy associated with session management to SMF 310 and/or G-SMF 311. This may be used to allow for a unified policy framework with which network behavior can be governed.

A Unified Data Management Function (UDM) 320 can present a service based Nudm interface to communicate with other network functions, and can provide data storage facilities to other network functions. Unified data storage can allow for a consolidated view of network information that can be used to ensure that the most relevant information can be made available to different network functions from a single resource. This can make implementation of other network functions easier, as they do not need to determine where a particular type of data is stored in the network. The UDM 320 may employ an interface, such as Nudr to connect to a User Data Repository (UDR) 324. The PCF 318 may be associated with the UDM 320 because it may be involved with requesting and providing subscription policy information to the UDR 324, but it should be understood that typically the PCF 318 and the UDM 320 are independent functions.

The PCF 318 may have a direct interface to the UDR 324 or can use Nudr interface to connection with UDR 324. The UDM 320 can receive requests to retrieve content stored in the UDR 324, or requests to store content in the UDR 324. The UDM 320 is typically responsible for functionality such as the processing of credentials, location management and subscription management. The UDR 324 may also support any or all of Authentication Credential Processing, User Identification handling, Access Authorization, Registration/Mobility management, subscription management, and Short Message Service (SMS) management. The UDR 324 is typically responsible for storing data provided by the UDM 320. The stored data is typically associated with policy profile information (which may be provided by PCF 318) that governs the access rights to the stored data. In some embodiments, the UDR 324 may store policy data, as well as user subscription data which may include any or all of subscription identifiers, security credentials, access and mobility related subscription data and session related data.

The Application Function (AF) 322 represents the non-data plane (also referred to as the non-user plane) functionality of an application deployed within a network operator domain and within a 3GPP compliant network. The AF 322 interacts with other core network functions through a service based Naf interface, and may access network capability exposure information, as well as provide application information for use in decisions such as traffic routing. The AF 322 can also interact with functions such as the PCF 318 to provide application specific input into policy and policy enforcement decisions. It should be understood that in many situations the AF 322 does not provide network services to other NFs, and instead is often viewed as a consumer or user of services provided by other NFs. An application outside the 3GPP network, can perform many of the same functions as AF 322 through the use of NEF 314.

The operations, administration and maintenance or management (OAM) 326 is a network management plane function which provides configuration, operations, and maintenance and support services for the Control Plane (CP) and UP functions.

The Network Data Analytics Function (NWDAF) 332 represents an operator managed network analytics logical function. The NWDAF 332 provides support for data collection from NFs in the CP 330 and UP 328, AF 322, and OAM 326. The NWDAF 322 can perform service registration in the NRF 316 to allow other NFs and AFs to discover the services of NWDAF 332. The NWDAF 332 support analytics information provisioning to other NFs, AF 322, and OAM 326. The NWDAF 332 communicates with other NFs over a service based Nnwdaf interface.

The Network Slice Selection Function (NSSF) 334 provides various functionalities including: selecting the set of Network Slice instances serving the UE 102, determining the Allowed NSSAI and, if needed, the mapping to the Subscribed Single Network Slice Selection Assistance Information (S-NSSAI); determining the Configured NSSAI and, if needed, the mapping to the Subscribed S-NSSAIs; and determining the AMF Set to be used to serve the UE 102, or, based on a configuration, a list of candidate AMF(s), possibly by querying the NRF 316. The NSSF 334 communicates with other NFs over a service based Nnssf interface.

The Location Management Function (LMF) 336 manages the overall co-ordination and scheduling of resources required for a UE that is registered with or is accessing the mobile network at a certain location. The LMF 336 may also: calculate or verify a final location of the UE, estimate the velocity of the UE, and estimate the achieved accuracy. The AMF 308 or G-AMF 309 may request the LMF 336 to provide location(s) of the UE 102 by using the Nlmf interface. The LMF 336 may communicate with the UE 102 to exchange location information related to UE positioning methods, such as UE-assisted and UE-based position methods. The LMF 336 may interact with other access networks, such as the 3GPP and non-3GPP networks, in order to obtain location information.

The UE 102 communicates with network functions that are in the User Plane (UP) 328, and the CP 330. The UPF 304 is a part of the CN UP 328 (DN 306 being outside the 5GCN). (R)AN node 302 may be considered as a part of the UP 328, but because it is not strictly a part of the CN, it is not considered to be a part of the CN UP 328. AMF 308, G-AMF 309, SMF 310, G-SMF 311, AUSF 312, NEF 314, NRF 316, PCF 318, and UDM 320 are functions that reside within the CN CP 330, and are often referred to as CP Functions. AF 322 may communicate with other functions within CN CP 330 (either directly or indirectly through the NEF 314), but is typically not considered to be a part of the CN CP 330.

Those skilled in the art will appreciate that there may be a plurality of UPFs, e.g., Intermediate-UPFs (I-UPF) connected in series between the (R)AN node 302 and the DN 306, and multiple data sessions to different DNs can be accommodated through the use of multiple UPFs.

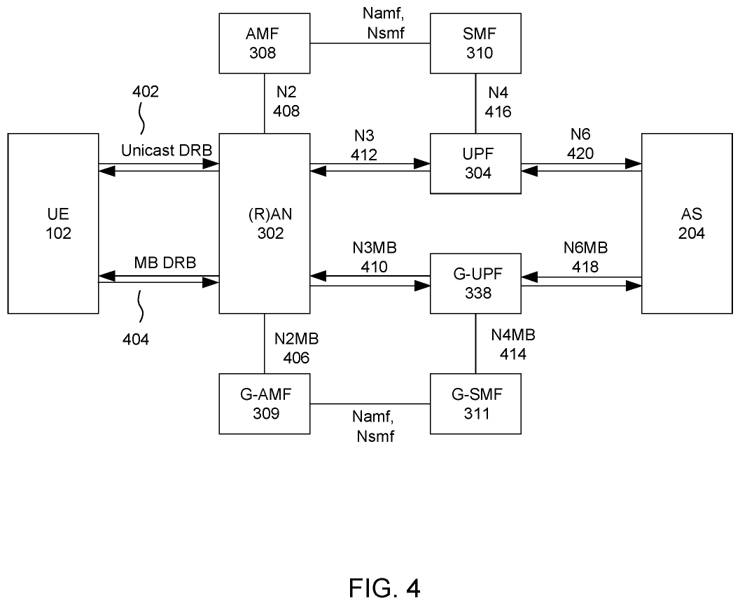

FIG. 4 is an illustration of a simplified 5G system supporting group communications, according to an embodiment of the present disclosure. Referring to FIG. 4, the UE 102 may receive both shared and non-shared data. Shared data is data that may be sent to one or more users (i.e. UEs). Non-shared data is data that may be sent to a single user (i.e. UE). The UE 102 may receive shared data in either unicast data radio bearer (DRB) 402 or multicast/broadcast (MB) DRB 404. The UE 102 may receive non-shared data over a unicast DRB 402.

The N2MB interface 406 may be the same as or different from the N2 interface 408. The N2MB interface 406 may be used to deliver the messages that have been designed for the N2 interface 408. The N3MB interface 410 is used to transport MB data between the (R)AN 302 and G-UPF 338. The N3MB interface 410 could use similar transport protocol as N3 interface 412. For example, the N3MB interface 410 could use GTP-U tunnel protocol, with additional features to indicate MB data and support IP multicast protocol for data distribution from the G-UPF 338 to one or more (R)AN nodes 302. The N3MB interface 410 may support uplink (UL) data transmission so that the (R)AN 302 may send UL messages generated by the UE 102 or by the (R)AN 302 to the G-UPF 338. N4MB interface 414 may be used to connect G-UPF 338 and G-SMF 311, as illustrated. N4MB interface 414 may be similar to or different form the N4 interface 416. The N4MB interface 414 may be used to deliver the messages that have been designed for the N4 interface 416. The N6MB interface 418 may be used to connect the AS 204 and the G-UPF 338. The N6MB interface 418 may be similar to or different from the N6 interface 420. The N6MB interface 418 may use the same protocols as or different protocols from than those used by the N6 interface 420. The N6MB interface 418 may support downlink (DL) packets sent from the AS 204 to the G-UPF 338 and may support UL packets sent from the UE 102, (R)AN 302, and G-UPF 338 to the AS 204 in the UL.

The switching from unicast downlink to MB downlink triggered by the AF will now be discussed.

According to an embodiment, the AF may request to switch the DL delivery method when the AF requests the mobile network to establish a MB session. Upon the switching of the DL delivery method, the UE associated with the MB session may receive MB data from a MB DRB, for example MB DRB 404, and the mobile network may remove the resources assigned for delivering shared DL data using the DL UP of a unicast PDU session, for example unicast DRB 402.

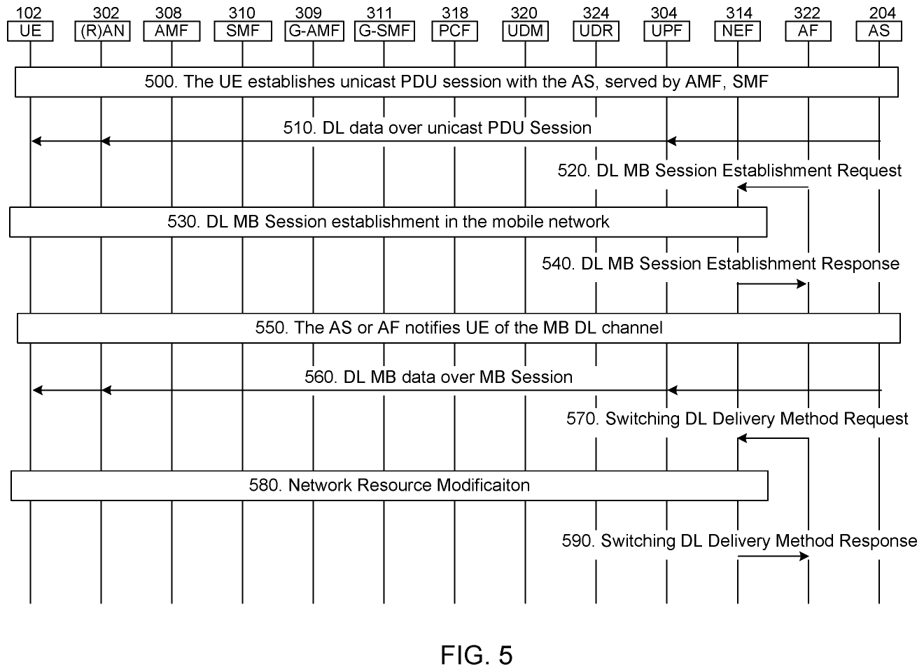

FIG. 5 is a procedure for switching from a unicast delivery to MB delivery, according to an embodiment of the present disclosure.

Referring to FIG. 5, when the UE 102 wants to communicate with the AS 204, at step 500, the UE 102 requests a PDU Session establishment. At this step, the AS 204 and the mobile network may not know which UEs may join a group communication session, since there can be multiple UEs connect to the AS 204.

A mobile network operator, using an OAM 326, may configure the CP functions such that the same AMF, or the same AMF instance, or the same AMF set is configured to serve a group of UEs. The AF 322 may notify the mobile network which UEs belong to the same group. The OAM 326 may configure the same group of NF(s), or the same group of NF instance(s), or the same group of NF sets to serve all unicast PDU Session and/or MB Sessions that are: connected to the same data network name(s) (DNN), and/or allowed to use same network slices with S-NSSAI(s), and/or accessing DN via the same DNAI(s), and/or using the same Application ID(s), and/or related to the same AF 322. The group of NFs could be one or any combination of NFs in the CP, for example AMF 308, G-AMF 309, SMF 310, G-SMF 311, UDM 320, UDR 322, PCF 318, NEF 314, NRF 316, LMF 336.

The SMF 310 and G-SMF 311 may be implemented by the same software instance or different software instances performing session management functionalities. The SMF 310 and G-SMF 311 may be implemented in different software or hardware modules. The SMF 310 and G-SMF 311 may be two software instances of the same SMF set.

The AMF 308 and G-AMF 309 may be implemented by the same software instance or different software instances performing functionalities to support access and mobility management. The AMF 308 and G-AMF 309 may be implemented by different software or hardware modules. The AMF 308 and G-AMF 309 may be two software instances of the same AMF set.

At step 510, the UE 102 receives data from the AS 204 over the established DL UP of the unicast PDU session. The UE 102 may receive data via UPF 304 and (R)AN 302 as illustrated. The DL unicast PDU session may have one or more DL QoS flows. For example, one QoS flow may carry the signaling or control data in the application layer from the AS 204 to the UE 102, and another QoS flow of the unicast PDU session may carry the shared data. The UE 102 may send UL data to the AS 204 by using one or more of QoS flows of the unicast PDU session.

At step 520, the AF 322 may decide to use MB delivery to reduce the number of resources that serve multiple identical or similar unicast DL flows. The AF 322 may send a request to establish DL MB Session Establishment to the mobile network. This request could be sent to a NF, such as the NEF 314. The message may comprise the following information: application information, MB session information, network slice information, and UE information. Application information may comprise an application ID (or External Application ID) to identify the application, AF Service ID, and AF ID. The MB session information may comprise information on packet filter to identify the MB packet flow to be delivered over the MB Session. The MB session information may further comprise QoS requirements, such as packet delay budget, packet error rate, packet loss rate and data rate of the MB data flow, which may include one or more of average bit rate, maximum bit rate, and guaranteed bit rate. Network slice information may include e.g. S-NSSAI, and Network Slice Instance (NSI) ID. The UE information may include a list of UE ID(s) that receive the MB data, e.g. Generic Public Subscription Identifier (GPSI), External UE ID. The UE information may further include the QoS flow(s) that may no longer be needed. The information to identify the QoS flow that may not be needed may include UE ID, UE address (e.g. IP or Ethernet Address), and packet filters of the QoS flow. Accordingly, the network resources that carry shared data over unicast PDU session may be removed or combined to save network resources in the (R)AN and in the CN. The packet filter may be, for example, an IP packet filter or Ethernet packet filter as defined in clause 5.7.6 of TS 23.502 Version 16.2.0 published in Sep. 24, 2019.

At step 530, the mobile network establishes a MB Session. Details of this step have been disclosed in the U.S. patent application Ser. No. 16/195,469, filed Nov. 19, 2018, titled “METHOD AND SYSTEM FOR MULTICAST AND BROADCAST SERVICES”, which is incorporated herein by reference in its entirety.

At step 540, the mobile network informs the AF 322 that the MB Session has been established. The NEF 314 may send a MB Session Establishment Response to the AF 322. The message may include the N6 (and/or N6MB) interface information (e.g. IP address and port number of the UPF 304 (or G-UPF 338), DNAI) and information to identify the MB Session in the radio interface (e.g. Temporary Mobile Group Identity (TMGI), or Radio Network Temporary Identifier (RNTI)).

At step 550, the AS 204 may send a message to the UE(s) 102, e.g. over a downlink of an existing unicast PDU session, to notify the UE(s) 102 about the MB Session. The message may include the information to identify the MB Session in radio interface, e.g. TMGI, RNTI. The UEs 102 may access a radio control channel to find the radio resources assigned to the MB Session by using the information provided by the AS 204, such as TMGI, and/or RNTI.

At step 560, the AS 204 sends shared data to UE(s) 102 over the MB Session as illustrated.

At step 570, the AF 322 may send a request to NEF 314 to indicate switching from unicast delivery to MB delivery in the downlink. The message may include one or more of following information: UE Group information, e.g. Internal Group ID, External Group ID, and/or TMGI; UE information which may include UE ID(s) that receive the MB data, e.g. GPSI, External UE ID; and information on DL QoS flow of unicast PDU session that may be removed. Accordingly, the network resources that carry shared data over unicast PDU session may be removed to save network resource. The information to identify the QoS flow that is to be removed may include one or more of following information: UE ID, UE address (e.g. IP or Ethernet address), and packet filters (e.g. IP or Ethernet packet filters) of this QoS flow.

At step 580, the mobile network performs network resource modification. For example, the mobile network may release network resources that are no longer needed to carry shared data over unicast DL of PDU sessions. The mobile network may release network resources by, for example, the SMF may send instructions to other network functions to implement the network resource modification. Examples of such instructions are discussed with respect to the example embodiments discussed herein. Further details of this step will be discussed elsewhere herein.

After the network resources are modified, at step 590, the NEF 314 may send a message Switch DL Delivery Method Response to the AF 322 to confirm the receiving of message in step 570. The message in step 590 may be sent after step 570 and/or before step 580.

The message in steps 570 and 590 can be implemented using a new service or modifying an existing service of the NEF 314. The following service Nnef_DLTrafficDeliveryMethod_Notify is an example. The service Nnef_DLTrafficDeliveryMethod_Notify may be used by a consumer network function, such as AF 322, in which the AF 322 may send downlink traffic information to the mobile network via NEF 314. The required input for this service is the AF Transaction Id, which refers to the request. The optional inputs for this service include, if available, the address (IP or Ethernet) of the UE, GPSI, DNN, S-NSSAI, External Group Identifier, TMGI. The optional inputs may further include: application identifier or traffic filtering information, AF-Service-Identifier, a list of DNAI(s) and corresponding routing profile ID(s) or N6 traffic routing information, Temporal validity condition and Spatial validity condition as described in TS 23.501 Version 16.2.0 published in Sep. 24, 2019, clause 5.6.7, indication of switching delivery method from multicast or broadcast to unicast, and indication of switching delivery method from unicast to multicast or broadcast. It should be noted that there can be multiple UEs. Each UE may have associated information to identify QoS flow, such as, UE ID (e.g. GPSI), an address of UE (e.g. IP or Ethernet address), DNN, S-NSSAI, External Group ID and/or TMGI, application identifier, and traffic filter information. The required outputs for the service include Operation execution result indication. There are no optional outputs for this service.

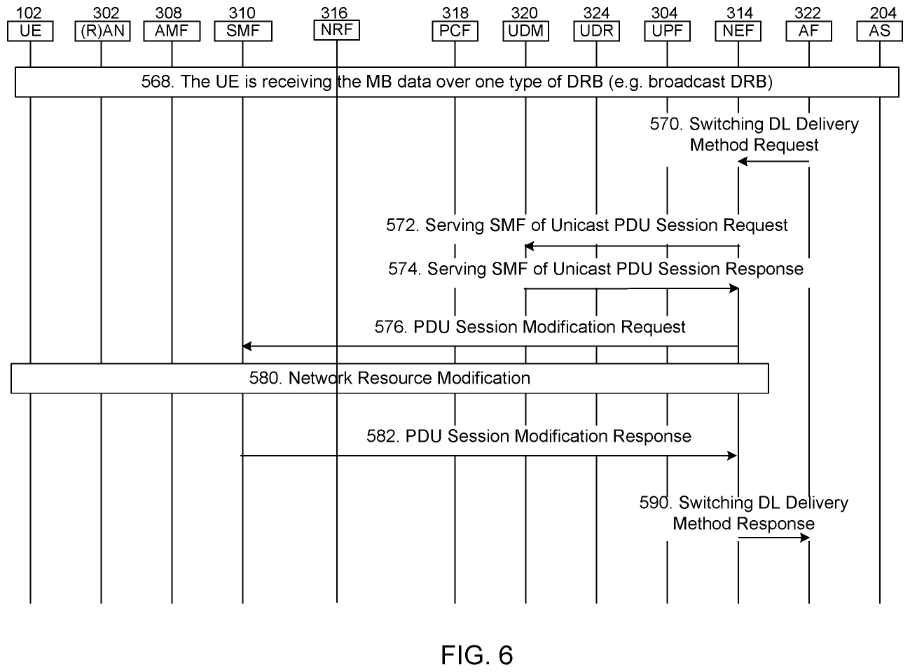

FIG. 6 is an illustration of a method to switch downlink delivery method triggered by the AF 322, according to an embodiment of the present disclosure.

Referring to FIG. 6, at step 568, UE 102 is receiving DL shared data on a radio channel, such as MB DRB of a MB Session and a unicast DRB of a unicast PDU Session. Step 568 may be similar to step 560 from FIG. 5.

During a (unicast) PDU Session establishment, the PCF 318 may send Policy and Charging Control (PCC) rules that include information on QoS flows that the UE 102 may use. For example, the UE 102 may send a request to establish a PDU session to communicate with an application server in a DNN using an S-NSSAI. The PCF may use the information provided by the UE 102 and UE subscription data in the UDM 320 and/or UDR 324 to determine PCC rules for the PDU session. The PDU session may support one or more QoS flows in the UL and DL, with certain QoS requirements.

At step 570, the AF 322 may send a request to the mobile network, e.g. to the NEF 314, to request (or notify) switching the DL delivery method from one type of delivery method to another method. For example, the AF 322 may request the mobile network to switch from a unicast delivery to multicast or broadcast delivery and/or switch from a multicast or broadcast delivery to unicast delivery.

In the request at step 570, the AF 322 may include one or more of following information: network information comprising one or more of DNN, S-NSSAI, NSI; application information comprising Application ID, External Application ID, Internal Application ID, AF-Service-ID, and AF ID. The AF 322 may further include in the request time information to apply the switching of the DL delivery method, for example, immediate use of the new delivery method or at a specific time in the future (for example time and date formats). The AF 322 may further include in the request the location (or service area) at which to use the new delivery method: e.g. the list of (R)AN node ID(s), the list of cell IDs, and/or geographic zone ID(s). The AF 322 may further include in the request UE Group information and UE information. The UE group information include, e.g. External Group ID, and/or TMGI; and the UE information may include UE ID(s) that receive the MB data: e.g. GPSI, External ID.

If the request is for switching from a unicast delivery to a multicast or broadcast delivery, the AF request may include information on DL QoS flow of unicast PDU sessions that are currently in use for delivering shared data and information on an existing MB session. The information on DL QoS flow may include one or more of following information: UE address (e.g. IP address or Ethernet address) and packet filter of this QoS flow. Information on MB Session may include one or more of following information: TMGI, External Group ID, and an indication of a previous AF request to establish MB Session.

If the request is for switching from a multicast or broadcast delivery to a unicast delivery, the AF request may include the list of UE ID(s) (e.g. GPSI, External ID) that will receive the unicast delivery method, and the locations (or service areas) that provide unicast delivery.

At step 572, the NEF 314 may discover the serving SMF of the unicast PDU Sessions by using a UDM service, e.g. Nudm_UECM_Get Request. To get the SMF serving functions of UEs, the NEF 314 may send one or more of following information to UDM 320: SMF as the NF Type, UE ID (e.g. Subscription Permanent Identifier (SUPI), or Generic Public Subscription Identifier (GPSI)), UE address (IP or Ethernet address), External Group ID, Internal Group ID, TMGI, application identifier, and traffic filter information.

Another method to discover the serving SMF of UEs is to use preconfigured information in the NEF 314 to determine which SMF instance, or which SMF set is configured to serve one or more of: UE group, PDU sessions accessing the same DN(s) (the same DNN(s)), the same AF(s), the same AF Service ID(s), the same network slice(s) represented by S-NSSAI(s) or NSI(s), or the same geographical area(s).

Another method to find the serving SMF of UEs is to use the NRF 316 services. This method is not shown in FIG. 5 or FIG. 6. The NEF 314 may send a message to the NRF 316, for example, Nnrf_NFDiscovery Request to discover the SMF instance and/or SMF set. The message may include UE ID(s) (e.g. GPSI(s), SUPI(s)), External Group ID(s), Internal Group ID(s), DNN(s), S-NSSAI(s), AF ID(s), AF Service ID(s), Application ID, locations (e.g. geographic zone ID(s), (R)AN ID(s), cell ID(s), tracking area ID(s) (TAI(s)), registration area(s)).

At step 574, the UDM 320 may inform the NEF 314 of the serving SMF(s) of individual unicast PDU Session using the Nudm_UECM_Get Response. For example, the UDM 320 may inform the NEF 314 of the serving SMF ID and PDU Session ID of the UE that the SMF is serving.

If in step 572, the NEF 314 sends an Nnrf_NFDiscovery Request to the NRF 316, the NRF 316 may send Nnrf_NFDiscovery Response to the NEF 314 that contains the information of the SMF instance or SMF set.

At step 576, the NEF 314 may send a PDU Session Modification Request to the SMF 310, the request associated with one or multiple PDU sessions of one or multiple UEs. For each UE, the request may include one or more of following information: the UE ID, PDU Session ID(s), an indication to release one or multiple DL QoS flows of one or multiple UEs, an indication to release all QoS flows of one or multiple UEs in the DL (or to release the DL user plane, the UL user plane may still be kept to transfer UL packets), an indication to deactivate one or multiple DL QoS flows of one or multiple UEs, an indication to deactivate all QoS flows in the DL (or to deactivate the DL user plane, the UL user plane may still be kept to transfer UL packets), information to identify QoS flows of PDU Session (e.g. PDU Session ID(s), QoS flow ID(s), IP address(es), Ethernet address(es), packet filter(s) of QoS flow(s), Application ID(s), DNAI(s)).

At step 580, the SMF 310 may perform the PDU Session Modification (Network Resource Modification) requested in the earlier step as described in other embodiments. The SMF 310 may send instructions to other network functions to implement the modification. Examples of such instructions are discussed with respect to the example embodiments discussed herein.

At step 582, the SMF 310 may send a PDU Session Modification Response to NEF 314. The message may include the result of step 580, for example, an indication that the request has been fulfilled, or the request is rejected and the rejection cause. The rejection cause may indicate the reason why the AF request in step 576 cannot be fulfilled. Examples of rejection cause may include one or more of following: system does not have enough resources, and the UE is out of MB service area.

At step 590, using the received information in step 582, the NEF 314 may send a message, for example, Switching DL Delivery Method Response, to the AF 322. The message may include the result, such as, the request has been fulfilled, or the request is rejected and the rejection cause. The rejection cause may indicate the reason why the AF request in step 576 cannot be fulfilled. Examples of rejection cause may include one or more of following: system does not have enough resources, and UE out of MB service area.

Referring to FIG. 5 and FIG. 6, step 580 may be implemented using a PDU session modification procedure.

Accordingly, embodiments discussed above and elsewhere herein, enable the AF 322 to request the mobile network to switch the DL delivery method from a unicast delivery to a multicast/broadcast delivery. The information of the message in step 570 indicates which UEs may be receiving shared data from the MB session. This information enables the mobile network to release resources that were used to carry shared data over DL QoS flows of unicast PDU sessions.

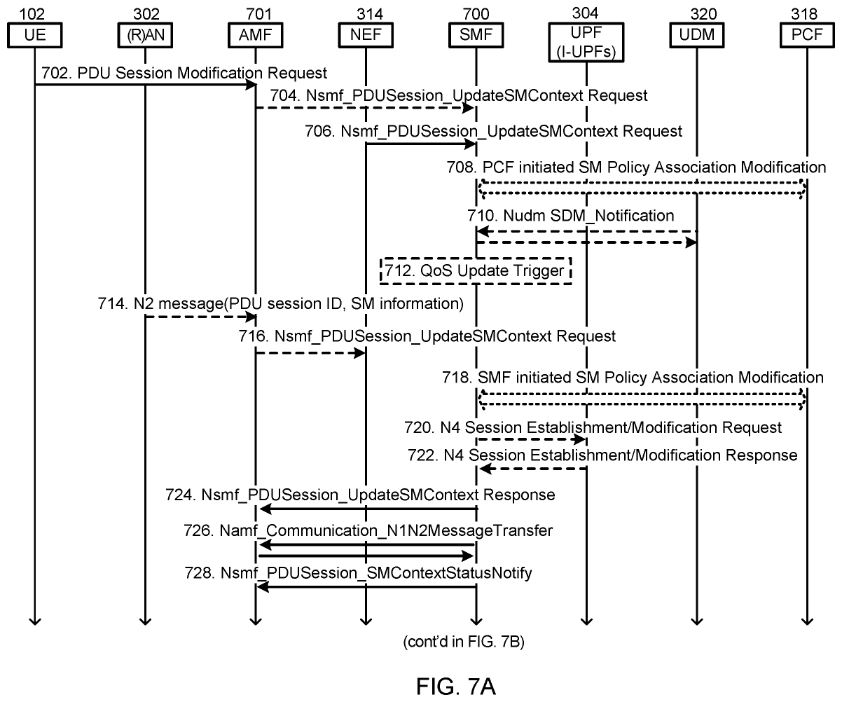

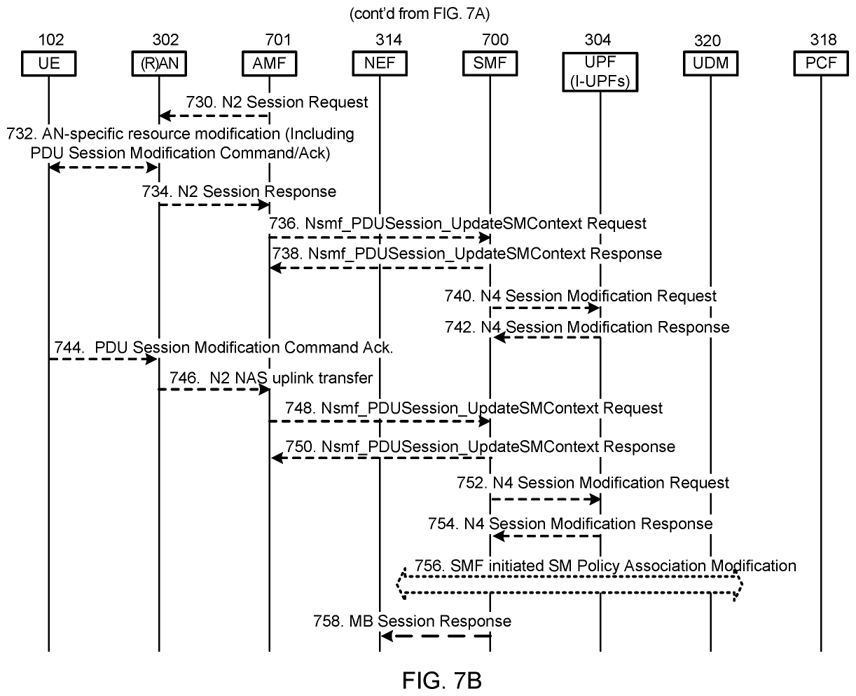

Switching from unicast downlink to MB downlink triggered by a UE or an AF (directly or via an NEF) will now be discussed. FIG. 7A and FIG. 7B are illustrations of UE or network requested PDU Session Modification procedure (for non-roaming and roaming with local breakout scenario), according to an embodiment of the present disclosure.

Referring to FIG. 7A and FIG. 7B are, the PDU Session Modification procedure may be triggered via one or more of the following steps: 702, 704, 706, 708, 710 712, 714 and 716 as will be further discussed.

Step 702 is a UE initiated PDU Session modification procedure. At step 702, the UE 102 initiates the PDU Session Modification procedure by the transmission of a Non-access stratum (NAS) message. The NAS massage my comprise N1 SM container (PDU Session Modification Request (PDU session ID, Packet Filters, Operation, Requested QoS, Segregation, SGSM Core Network Capability, Number Of Packet Filters, [Always-on PDU Session Requested])), PDU Session ID, and UE Integrity Protection Maximum Data Rate. Depending on the Access Type, if the UE 102 was in CM-IDLE state, this session management (SM) NAS message is preceded by the Service Request procedure. The NAS message is forwarded by the (R)AN 302 to the AMF 308 with an indication of User location Information.

At step 704, the AMF 308 invokes Nsmf_PDUSession_UpdateSMContext request (SM Context ID, N1 SM container (PDU Session Modification Request)) to SMF 700.

When the UE 102 requests specific QoS handling for selected service data flow(s) (SDF(s)), the PDU Session Modification Request includes Packet Filters describing the SDF(s), the requested Packet Filter Operation (add, modify, delete, deactivate) on the indicated Packet Filters, the Requested QoS and optionally a Segregation indication. The Segregation indication is included when the UE 102 recommends the network to bind the applicable SDF(s) on a distinct and dedicated QoS Flow, which may occur even if an existing QoS Flow can support the requested QoS. The network should abide by the UE request, but the network is allowed to proceed instead with binding the selected SDF(s) on an existing QoS Flow.

The UE 102 may request the network to add one or more QoS Flows to receive shared or non-shared data in the DL (or UL) by setting the “requested Packet Filter Operation” to “add”.

The UE 102 may request the network to delete one or more DL QoS flow by setting the “requested Packet Filter Operation” to “delete” for the indicated Packet Filters associated with the DL QoS flow. The UL QoS flows may remain unchanged.

The UE 102 may request the network to deactivate one or more DL QoS flow by setting the “requested Packet Filter Operation” to “deactivate” for the indicated Packet Filters associated with the DL QoS flow. The UL QoS flows may remain unchanged.

It should be noted that only one QoS Flow is used for traffic segregation. If the UE 102 makes subsequent requests for segregation of additional SDF(s), the additional SDF(s) are multiplexed on the existing QoS Flow that is used for segregation.

The UE 102 may not trigger a PDU Session Modification procedure for a PDU Session corresponding to a LADN when the UE 102 is outside the area of availability of the LADN.

The packet switch (PS) Data Off status, if changed, may be included in the protocol configuration options (PCO) in the PDU Session Modification Request message.

For a PDU Session which was established in the Evolved Packet System (EPS), when the UE 102 moves from EPS to 5GS for the first time, the UE 102 includes an Always-on PDU Session Requested indication in the PDU Session Modification Request message if it wants to change the PDU Session to an always-on PDU Session.

When PCF 318 is deployed, the SMF 700 further reports the PS Data Off status to PCF 318 if the PS Data Off event trigger is provisioned, the additional behaviour of SMF 700 and PCF 318 for 3GPP PS Data Off is defined in 3GPP TS 23.503, version 16.2.0, published in Sep. 24, 2019.

The SMF 700 may be the SMF that serves the unicast PDU session of the UE.

The 5GSM Core Network Capability is provided by the UE and handled by SMF 700 as defined in TS 23.501 clause 5.4.4b, version 16.2.0 published in Sep. 24, 2019.

The UE Integrity Protection Maximum Data Rate indicates the maximum data rate up to which the UE can support UP integrity protection.

The Number of Packet Filters indicates the number of supported packet filters for signalled QoS rules as described in TS 23.501 clause 5.17.2.2.2.

At step 706, in some embodiment, the NEF 314 may transfer the information received from the AF to another function, e.g. SMF 700, which may be a G-SMF 311. The G-SMF may trigger the PDU Session Modification. Accordingly, the NEF 314 (or G-SMF 311) may send a message, for example Nsmf_PDUSession_UpdateSMContext Request to the SMF 700. In some embodiments, if SMF 700 and G-SMF 311 are different entities, the NEF 314 may send info received from the AF to the G-SMF 311. Then the G-SMF 311 triggers the PDU session modification by sending a message to the SMF 700.

The NEF 314 may include one or more of following information: UE ID (e.g. SUPI, GPSI), PDU Session ID, an indication to Release Network Resources, an indication to Deactivate Network Resources, Packet Filter Information, Application ID, DNAI, Time Information, and Location Information. The Indication to Release Network Resources may indicate that one or more QoS flows carrying packets in the DL and/or UL associated with the Packet Filter Information is no longer needed, and that the network may release the network resources that are currently assigned to support the one or more QoS flow(s) no longer needed. The Indication to Deactivate Network Resources may indicate that one or more QoS flows carrying packets in the DL and/or UL associated with the Packet Filter Information may be not required at the moment, but may be requested again in the future. The Time information may indicate the time to apply the NEF request. Omission of Time Information may indicate that the NEF request is applied immediately. The Location Information may indicate the location where the NEF request is applied. The Location Information may be a cell ID or a RAN ID. Omission of Location Information may indicate that the NEF request is applied for all UE locations.

Step 708 is an SMF requested PDU Session modification trigger. The PCF 318 performs a PCF initiated SM Policy Association Modification procedure as defined in TS 23.502, clause 4.16.5.2 to notify the SMF 700 about the modification of policies. This may have been triggered by a policy decision or upon AF requests, e.g. Application Function influence on traffic routing as described in step 5 in clause 4.3.6.2, of TS 23.502.

At step 710, the UDM 320 updates the subscription data of SMF 700 by sending Nudm_SDM_Notification (including SUPI, Session Management Subscription Data) to SMF 700. The SMF 700 updates the Session Management Subscription Data and acknowledges the UDM 320 by returning an Ack with (SUP I).

At step 712, the SMF 700 may decide to modify the PDU Session based on a locally configured policy or a trigger from the (R)AN 302 (as described in TS 23.502 clause 4.2.6 and clause 4.9.1). The SMF requested modification may also be triggered if the UP connection is activated (as described in Service Request procedure in clause 4.2.3 of TS 23.502) and the SMF 700 has marked that the status of one or more QoS Flows are deleted in the 5GC but not synchronized with the UE 102 yet.

The UPF 304 may send a request to the SMF to activate one or more UL or DL QoS flows when the UPF 304 receives a packet with associated Packet Detection Rules (PDR) but without Forwarding Action Rules (FAR).

The SMF 700 may configure the UPF 304 to monitor one or more of UL or DL QoS flows associated with one or more of PDR. The SMF 700 may include a QoS Flow Deactivation Timer. When the UPF 304 detects that there are no packet for the monitored QoS flows after the QoS Flow Deactivation Timer expires, the UPF 304 may send a notification to the SMF 700 to indicate that there are no packets detected for monitored QoS flows. The UPF 304 may send to the SMF 700 one or more of following information: QoS Flow Identifier (QFI), 5G QoS Identifier (5QI), PDR, FAR, that are associated with the QoS flows with no detected packets.

In detecting DL packets, the UPF 304 may trigger the activation of UP of the PDU session.

If the SMF 700 receives one of the triggers in steps 706, 708, 710, or 712, the SMF 700 starts an SMF requested PDU Session Modification procedure.

Step 714 is an AN initiated PDU Session modification procedure. At step 714, the (R)AN 302 indicates to the SMF 700 when the AN resources onto which a QoS Flow is mapped are released irrespective of whether the notification control is configured. The (R)AN 302 sends an N2 message comprising PDU Session ID and N2 SM information to the AMF 701. The N2 SM information includes the QFI, User location Information and an indication that the QoS Flow is released.

At step 716, the AMF 701 (which may be AMF 308) invokes Nsmf_PDUSession_UpdateSMContext Request (SM Context ID, N2 SM information) toward NEF 314.

In the case that the notification control is configured for a guaranteed bit rate (GBR) Flow, the (R)AN 302 sends an N2 message (PDU Session ID, N2 SM information) to SMF 700 when the (R)AN 302 decides that the QoS targets of the QoS Flow cannot be fulfilled or can be fulfilled again, respectively. The N2 SM information includes the QFI and an indication that the QoS targets for that QoS Flow cannot be fulfilled or can be fulfilled again, respectively. The AMF 701 invokes Nsmf_PDUSession_UpdateSMContext Request (SM Context ID, N2 SM information) toward NEF 314. If the PCF 318 has subscribed to the event, SMF 700 reports this event to the PCF 318 for each PCC Rule for which notification control is set, as discussed in steps 718, 720 and 722 below. Alternatively, if dynamic PCC does not apply for this DNN, and dependent on locally configured policy, the SMF 700 may start SMF requested PDU Session Modification procedure, as discussed in step 726 below.

At step 718, the SMF 700 may need to report some subscribed event to the PCF 318 by performing an SMF initiated SM Policy Association Modification procedure as defined in clause 4.16.5.1 of TS 23.502. This step may be skipped if the PDU Session Modification procedure is triggered by step 708 or 712. If dynamic PCC is not deployed, the SMF 700 may apply local policy to decide whether to change the QoS profile.

Steps 720 to 738 are not invoked when the PDU Session Modification requires only action at a UPF (e.g. gating).

At step 720, if redundant transmission has not been activated for the PDU session and the SMF 700 decides to perform redundant transmission for a new QoS Flow, then the SMF 700 allocates an additional CN Tunnel Info if CN Tunnel Info is allocated by the SMF 700. The additional CN Tunnel Info is provided to the UPF 304 via N4 Session Modification Request. The SMF 700 also indicates, in the request, the UPF 304 to perform packet duplication and elimination for the QoS Flow.

If redundant transmission has been activated for the PDU Session, and the SMF 700 decides to stop redundant transmission, the SMF 700 indicates, in the request, the UPF 304 to release the CN Tunnel Info which is used as the redundancy tunnel of the PDU Session. The SMF 700 also indicates, in the request, the UPF 304 to stop packet duplication and elimination for the corresponding QoS Flow(s).

It should be noted that the method to perform elimination and reordering on RAN/UPF based on the packets received from the two GTP-U tunnels (referring to the redundant transmission) is up to RAN/UPF implementation. The two GTP-U tunnels are terminated at the same RAN node and UPF.

If redundant transmission has not been activated for the PDU Session and the SMF 700 decides to perform redundant transmission for a new QoS Flow with two I-UPFs between the PSA UPF and the NG-RAN, then the SMF 700 allocates CN Tunnel Info of the two I-UPFs if CN Tunnel Info is allocated by the SMF 700. The CN Tunnel Info of the two I-UPFs is provided to the I-UPFs via N4 Session Establishment Request messages including UL CN Tunnel Info of the PSA UPF. An N4 Session Modification Request message including the DL CN Tunnel Info of the two I-UPFs is sent to the PSA UPF. The SMF 700 indicates the PSA UPF to perform packet duplication and elimination for the QoS Flow.

If the UE 102 or NEF 314 request is for the release of network resources assigned to support one or more QoS flows, the SMF 700 may send an N4 Session Modification request to the UPF 304 to release all information of QoS flow(s), such as packet filters in the PDR and packet FAR.

If the UE 102 or NEF 314 request is for the deactivation of network resources assigned to support one or more QoS flows, the SMF 700 may send an N4 Session Modification request to the UPF 304 to release FAR(s) associated with the deactivated QoS flows. The PDR in the UPF 304 may still have packet filters of the deactivated QoS flow(s). For the deactivated QoS flows, the UPF 304 may be able to detect the packets in the DL (or UL) sent from N6 interface. If there is no FAR, the UPF 304 will send a message to the SMF 700 to notify the arrival of DL packets. The SMF 700 may activate the user plane to support the QoS flows by sending the FAR for the Packet Filter Set.

If a user plane is activated to deliver packets of one or more UL and/or DL QoS flows, the SMF 700 may send to the UPF 304 the one or more FAR associated with one or more PDR currently stored in the UPF 304.

At step 722, the UPF 304 responds to the SMF 700 with an N4 Session Establishment/Modification Response. If redundant transmission has not been activated for the PDU session and the SMF 700 indicated the UPF 304 to perform packet duplication and elimination for the QoS Flow in step 720, the UPF 304 allocates an additional CN Tunnel Info if CN Tunnel Info is allocated by UPF 304. The additional CN Tunnel Info is provided to the SMF 700.

If redundant transmission has not been activated for the PDU Session and the SMF 700 decides to perform redundant transmission for new QoS Flow with two I-UPFs in step 720, the UPF 304 allocate CN Tunnel Info if CN Tunnel Info is allocated by UPF. The CN Tunnel Info of two I-UPFs is provided to the SMF 700.

For UE or AN initiated modification, at step 724, the SMF 700 responds to the AMF 701 through Nsmf_PDUSession_UpdateSMContext (N2 SM information (PDU Session ID, QFI(s), QoS Profile(s), Session-aggregate maximum bit rate (AMBR)), N1 SM container (PDU Session Modification Command (PDU Session ID, QoS rule(s), QoS rule operation, QoS Flow level QoS parameters if needed for the QoS Flow(s) associated with the QoS rule(s), Session-AMBR, [Always-on PDU Session Granted]))). The QoS Profile, QoS rule and QoS Flow level QoS parameters may are described in clause 5.7 of TS 23.501.

If the PDU Session Modification was requested by the UE 102 to modify a PDU Session to an always-on PDU Session, the SMF 700 may include an Always-on PDU Session Granted indication in the PDU Session Modification Command to indicate whether the PDU Session is to be changed to an always-on PDU Session or not.

The N2 SM information carries information that the AMF 701 provides to the (R)AN 302. The N2 SM information may include the QoS profiles and the corresponding QFIs to notify the (R)AN 302 that one or more QoS flows were added, or modified. The N2 SM information may further include only QFI(s) to notify the (R)AN 302 that one or more QoS flows were removed, for example when the UE 102 requests the SMF 700 to release or deactivate network resources supporting one or more QoS flows in step 702. The SMF 700 may indicate for each QoS Flow whether redundant transmission may be performed by a corresponding redundant transmission indicator. If the PDU Session Modification was triggered by the (R)AN Release as discussed in steps 714 and 716, the N2 SM information carries an acknowledgement of the (R)AN Release. If the PDU Session Modification was requested by the UE 102 for a PDU Session that has no established User Plane resources, the N2 SM information provided to the (R)AN 302 includes information for establishment of User Plane resources.

If redundant transmission has been activated for the PDU Session, and the SMF 700 decides to stop the redundant transmission, the SMF 700 indicates the (R)AN 302 to release the AN Tunnel Info which is used as the redundancy tunnel of the PDU Session. The SMF 700 also indicates the (R)AN 302 to stop packet duplication and elimination for the corresponding QoS Flow(s).

The N1 SM container carries the PDU Session Modification Command that the AMF 701 is to provide to the UE. The N1 SM container may include the QoS rules, QoS Flow level QoS parameters if needed for the QoS Flow(s) associated with the QoS rule(s) and corresponding QoS rule operation and QoS Flow level QoS parameters operation to notify the UE that one or more QoS rules were added, removed, modified, or deactivated.

For SMF requested modification, at step 726, the SMF 700 invokes Namf_Communication_N1N2MessageTransfer comprising N2 SM information (PDU Session ID, QFI(s), QoS Profile(s), Session-AMBR), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR)).

If the UE 102 is in connection management (CM)-IDLE state and an asynchronous type communication (ATC) is activated, the AMF 701 updates and stores the UE context based on the Namf_Communication_N1N2MessageTransfer and steps 730, 732, 734, 736, and 738 of FIG. 7B are skipped. When the UE 102 is reachable e.g. when the UE enters CM-CONNECTED state, the AMF 701 forwards the N1 message to synchronize the UE context with the UE.

For SMF requested modification due to updated SMF-Associated parameters from the UDM 320, at step 728, the SMF 700 may provide the SMF derived CN assisted RAN parameters tuning to the AMF 701. The SMF 700 invokes Nsmf_PDUSession_SMContextStatusNotify (SMF derived CN assisted RAN parameters tuning) towards the AMF 701. The AMF 701 stores the SMF derived CN assisted RAN parameters tuning in the associated PDU Session context for the associated UE.

Referring to FIG. 7B, at step 730, the AMF 701 may send N2 PDU Session Request (N2 SM information received from SMF 700, NAS message (PDU Session ID, N1 SM container (PDU Session Modification Command))) Message to the (R)AN 302.

At step 732, the (R)AN 302 may issue AN specific signalling exchange with the UE 102 that is related with the information received from SMF 700. For example, in case of a NG-RAN, an RRC Connection Reconfiguration may take place with the UE modifying the necessary (R)AN resources related to the PDU Session.

The (R)AN 302 may consider the updated CN assisted RAN parameters tuning to reconfigure the AS parameters.

At step 734, the (R)AN 302 may acknowledge the N2 PDU Session Request by sending an N2 PDU Session Ack (N2 SM information (List of accepted/rejected QFI(s), AN Tunnel Info, PDU Session ID, Secondary RAT usage data), User location Information) Message to the AMF 701. In case of Dual Connectivity, if one or more QFIs were added to the PDU Session, the Master RAN node may assign one or more of these QFIs to a next generation (NG)-RAN node which was not involved in the PDU Session earlier. In this case, the AN Tunnel Info includes a new N3 tunnel endpoint for QFIs assigned to the new NG-RAN node. Correspondingly, if one or more QFIs were removed from the PDU Session, a (R)AN node may no longer be involved in the PDU Session, and the corresponding tunnel endpoint is removed from the AN Tunnel Info. The NG-RAN may reject QFI(s) if it cannot fulfil the User Plane Security Enforcement information for a corresponding QoS Profile due to, e.g. the UE Integrity Protection Maximum Data Rate being exceeded.

If the PLMN has configured secondary radio access technology (RAT) usage reporting, the NG-RAN node may provide RAN Usage Data Report.

If the redundant transmission has not been activated for the PDU session, and the SMF 700 indicates to the RAN 302 that one of the QoS Flow may perform redundant transmission, the RAN 302 includes an additional AN tunnel info in N2 SM information.

At step 736, the AMF 701 forwards the N2 SM information and the User location Information received from the (R)AN 302 to the SMF 700 via Nsmf_PDUSession_UpdateSMContext service operation. At step 738, the SMF 700 replies with an Nsmf_PDUSession_UpdateSMContext Response. The N2 SM information may include Secondary RAT Usage Data.

If the (R)AN 302 rejects QFI(s), the SMF 700 is responsible for updating the QoS rules and QoS Flow level QoS parameters if needed for the QoS Flow(s) associated with the QoS rule(s) in the UE accordingly.

At step 740, the SMF 700 may update the N4 session of the UPF(s) that are involved in the PDU Session Modification by sending N4 Session Modification Request message to the UPF 304. At step 742, the UPF 304 sends an N4 Session Modification Response to SMF 700.

If new QoS Flow(s) are to be created, the SMF 700 updates the UPF 304 with UL PDRs of the new QoS Flow.

If the UE 102 or NEF 314 request is for the release of network resources assigned to support one or more QoS flows, the SMF 700 may send an N4 Session Modification request to the UPF 304 to release all information of QoS flow(s), such as packet filters in the PDR(s) and packet FAR.

If the UE 102 or NEF 314 request is for the deactivation of network resources assigned to support one or more QoS flows, the SMF 700 may send an N4 Session Modification request to the UPF 304 to release FAR(s) associated with the deactivated QoS flows. The PDR in the UPF 304 may still have packet filters of the deactivated QoS flow(s). For the deactivated QoS flows, the UPF 304 may be able to detect the packets in the DL (or UL) sent from N6 interface. If there is no FAR, the UPF 304 will send a message to the SMF 700 to notify the arrival of DL packets. The SMF 700 may activate the user plane to support the QoS flows by sending the FAR for the Packet Filter Set.

If a user plane is activated to deliver packets of one or more UL and/or DL QoS flows, the SMF 700 may send to the UPF 304 the one or more FAR associated with one or more PDR currently stored in the UPF 304.

Step 740 and 742, allows the UL packets with the QFI of the new QoS Flow to be transferred.

It should be noted that if an additional AN Tunnel Info is returned by RAN 302 in step 734, the SMF 700 informs the UPF 304 about this AN Tunnel Info for redundant transmission. In the case of redundant transmission with two I-UPFs, the SMF 700 provides AN Tunnel Info to the two I-UPFs. If the CN Tunnel Info of the two I-UPFs is allocated by the UPFs in step 722, the SMF 700 also provides the DL CN Tunnel Info of the two I-UPFs to the UPF (PSA).

At step 744, the UE 102 acknowledges the PDU Session Modification Command by sending a NAS message (PDU Session ID, N1 SM container (PDU Session Modification Command Ack)) to (R)AN 302.

At step 746, the (R)AN 302 forwards the NAS message to the AMF 701.

At step 748, the AMF 701 forwards the N1 SM container (PDU Session Modification Command Ack) and User Location Information received from the (R)AN 302 to the SMF 700 via Nsmf_PDUSession_UpdateSMContext service operation. At step 750, the SMF 700 replies with an Nsmf_PDUSession_UpdateSMContext Response.

If the SMF initiated modification is to delete QoS Flows (e.g. triggered by the PCF 318) which do not include QoS Flow associated with the default QoS rule and the SMF 700 does not receive a response from the UE 102, the SMF 700 marks that the status of those QoS Flows is to be synchronized with the UE 102.

At step 752, the SMF 700 may update the N4 session of the UPF(s) 304 that are involved by the PDU Session Modification by sending an N4 Session Modification Request (N4 Session ID) message to the UPF 304. For a PDU Session of Ethernet PDU Session Type, the SMF 700 may notify the UPF 304 to add or remove Ethernet Packet Filter Set(s) and forwarding rule(s).

At step 754, the UPF 304 may respond to SMF 700 with an N4 Session Modification Response.

It should be noted that the UPFs 304 that are impacted in the PDU Session Modification procedure depends on the modified QoS parameters and on the deployment. For example, in case of the session AMBR of a PDU Session with an UL Classifier (CL) changes, only the UL CL is involved. This also applies to step 740 and 742.

At step 756, if the SMF 700 interacted with the PCF 318 in step 708 or 718, the SMF 700 notifies the PCF 318 whether the PCC decision could be enforced or not by performing an SMF initiated SM Policy Association Modification procedure as defined in clause 4.16.5.1 of TS 23.502.

The SMF 700 notifies any entity that has subscribed to User Location Information related with PDU Session change.

If step 708 is triggered to perform Application Function influence on traffic routing by step 5 in clause 4.3.6.2 of TS 23.502, the SMF 700 may reconfigure the User Plane of the PDU Session as described in step 6 in clause 4.3.6.2 of TS 23.502.

At step 758, the SMF 700 may send a message to the NEF 314 in response to the request in step 706. The SMF 700 may send, for example, an Nsmf_PDUSession_UpdateSMContext Response to confirm the execution of the NEF request in step 706.

To allow identifying a UE's serving functions, some existing services of the UDM 320 may be modified using one or more of following information: UE address (IP or Ethernet address), External Group ID, Internal Group ID, TMGI, application identifier, and traffic filter information.

An existing service of the UDM 320 may be the Nudm_UECM_Registration service operation. This service operation registers a UE's serving NF (if NF Type is AMF, SMSF) or Session's serving NF (if NF Type is SMF) on the UDM 320. This service operation permits the authorization, if applicable, to register the NF service consumer in the UDM for the UE (e.g. based on UE roaming/RAT restrictions applicable when NF type is AMF). If the registration is successful, the NF service consumer is set as a serving NF for the corresponding UE/Session context. When the consumer is an AMF or SMF, the consumer is implicitly subscribed to be notified when it is deregistered in UDM 320. This notification is done by means of Nudm_UECM_DeregistrationNotification operation. When the consumer is an AMF or an SMF, it may optionally use the Nudm_UECM_Registration service operation to subscribe to notifications of the need for Proxy-Call Session Control Function (P-CSCF) Restoration. This notification is done by means of Nudm_UECM_PCscfRestoration operation. More information regarding P-CSCF restoration procedures is provided in TS 23.380 version 16.1.0 published in Sep. 18, 2019.

The required inputs for the Nudm_UECM_Registration service operation are the following: NF ID, SUPI, Permanent Equipment Identifier (PEI), NF Type, Access Type (if NF Type is AMF, Short Message Service Function (SMSF)), PDU Session ID (if NF Type is SMF). If NF Type is SMF, the required inputs further include: DNN or Indication of Emergency Services, Packet Data Network Gateway Control (PGW-C)+SMF fully qualified domain name (FQDN) for S5/S8 if the PDU Session supports EPS interworking. If NF type is AMF and Access Type is 3GPP access, the required inputs further include the Registration type. If NF type is SMSF the required input further include: SMSF Mobile Application Part (MAP) address and/or Diameter address.

The optional inputs for the Nudm_UECM_Registration service operation include: P-CSCF Restoration notification information, Globally Unique AMF Identifier (GUAMI), backup AMF(s) (if NF Type is AMF), “Homogeneous Support of IMS Voice over PS Sessions” indication (if NF Type is AMF), UE SRVCC capability (if NF Type is AMF), indication that access is from Evolved Packet Data Gateway (ePDG) (may be sent if NF Type is SMF and PDU Session is setup via S2b). Backup AMF(s) is sent only once by the AMF 701 to the UDM 320 in its first interaction with the UDM 320.

Further optional inputs for the Nudm_UECM_Registration service operation include: UE address (IP or Ethernet address), External Group ID, Internal Group ID, TMGI, application identifier, and traffic filter information.

The required outputs for the Nudm_UECM_Registration service operation include the Result indication; and there are no optional outputs for this service operation.

When the UE information changes, the NF may update the UE information that this NF is serving in the UDM. The NF may use the Nudm_UECM_Update service operation of the UDM 320. The NF/consumer may use this service operation to update some UE related information (e.g. UE capabilities, Intersystem continuity context, PGW-C+SMF FQDN for S5/S8 interface).

The required inputs for the Nudm_UECM_Update service operation include: NF ID, SUPI, NF type, and UE context information. The optional inputs for this service operation may include: “Homogeneous Support of IMS Voice over PS Sessions” indication (if NF Type is AMF) and PGW-C+SMF FQDN for S5/S8 interface (if NF Type is SMF). Further optional inputs may include: UE address (IP or Ethernet address), External Group ID, Internal Group ID, TMGI, application identifier, and traffic filter information.

The required outputs for the Nudm_UECM_Update service operation include the Result Indication; and there is no optional outputs for this service operation.

Another UDM service that may be used is the Nudm_UECM_Get service operation. This service operation permits the NF consumer to request from the UDM 320 the NF ID or SMS address of the NF serving the UE.

The required inputs for the Nudm_UECM_Get service operation include UE ID, NF Type, and Access Type (Access Type is included only when the NF type indicates AMF). The optional inputs for this service operation include UE address (IP or Ethernet address), External Group ID, Internal Group ID, TMGI, application identifier, and traffic filter information.

The required outputs for the Nudm_UECM_Get service operation include SUPI, NF ID or SMS address of the NF corresponding to the NF type requested by NF consumer. The optional outputs for this service operation, if the NF is SMF, may include the PDU Session ID.

An alternative solution to the one presented above, for example in FIG. 6, is that the NEF 314 may send the Switching DL Delivery method to another control plane function, such as the UDR 324 or the PCF 318.

Accordingly, the embodiments discussed above permit the deactivation of DL user plane resources service QoS flows of (unicast) PDU session triggered by the UE.

Service and session continuity during handover will now be discussed.

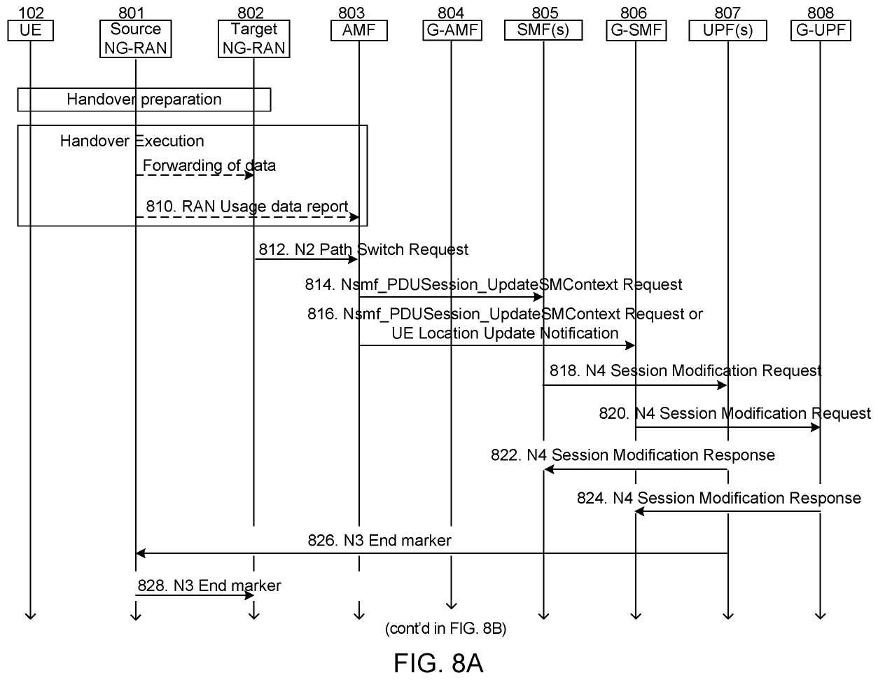

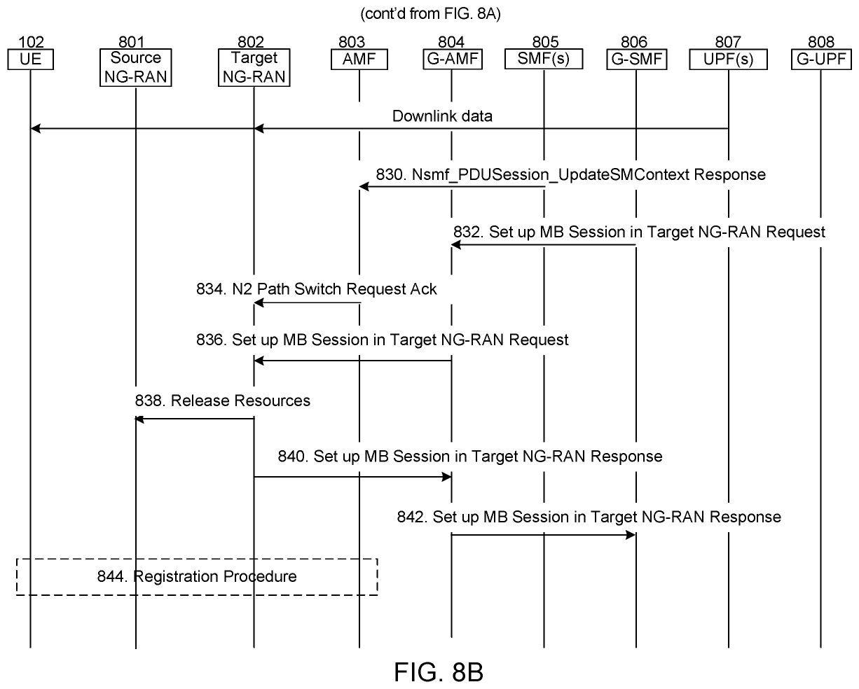

FIG. 8A and FIG. 8B are illustrations of an Xn based inter NG-RAN handover (HO) procedure without UPF re-allocation, according to an embodiment of the present disclosure.

Referring to FIG. 8A and FIG. 8B, the HO procedure generally is as follows. The AMF 803 communicates with G-AMF 804 to support service and/or session continuity for MB session. When HO occurs, the UE 102 sends all information associated with PDU Session and MB Session used by the UE 102 to the Source NG-(R)AN 801. The Source NG-(R)AN 801 sends an HO request to the Target NG-RAN 802. The Target NG-RAN 802 may perform admission control for the PDU sessions and MB sessions of the UE 102. The Target NG-RAN 802 may send to the AMF 803 a path switch message request, and may include information of all PDU Sessions and MB Sessions currently used by the UE 102. The AMF 803 forwards the HO request for MB Sessions to the G-AMF 804, or to the G-SMF 806. The G-AMF 804 communicates with G-SMF 806 to prepare radio resources in Target NG-(R)AN 802 and G-UPF 808 to support MB session(s). The G-SMF 806 sends an HO complete to AMF 803 directly or via the G-AMF 804. The HO procedure is accordingly complete.

At step 810, if the PLMN has configured secondary RAT usage reporting, the source NG-RAN node 801, during the handover execution phase, may provide RAN usage data Report (N2 SM Information (Secondary RAT usage data), Handover Flag, Source to Target transparent container) to the AMF 803. The source NG-RAN node 801 may provide the RAN usage data Report only when the Target NG-RAN 802 has confirmed handover over Xn interface. The Handover Flag indicates to the AMF 803 that it should buffer the N2 SM Information containing the usage data report before forwarding it.

If the source NG RAN 801 and target NG RAN 802 support radio capability signalling (RACS) as defined in TS 23.501, the Source to Target transparent container may contain the UE's UE Radio Capability ID instead of UE radio access capabilities.

The Source NG-RAN 801 may include the MB Session information that the UE is receiving MB data, the MB session information including one or more of: TMGI, MB Session ID, QoS profile(s), and UE ID (e.g. SUPI, GPSI);

At step 812, the Target NG-RAN 802 sends to AMF 803 an N2 Path Switch Request. The N2 Path Switch Request may comprise a list of PDU Sessions to be Switched with N2 SM Information, a list of PDU Sessions that failed to be established with the failure cause given in the N2 SM information element, UE Location Information, list of MB Sessions To Be Switched with N2 SM Information, and list of MB Sessions that failed to be established with the failure cause given in the N2 SM information element.

The Target NG-RAN 802 sends an N2 Path Switch Request message to an AMF, for example AMF 803, to inform that the UE 102 has moved to a new target cell, and the message provides a list Of PDU Sessions to be Switched. The AN Tunnel Info for each PDU Session to be switched is included in the N2 SM Information. The AN Tunnel Info for each MB Session to be switched is also included in the N2 SM Information.

If redundant transmission is performed for one or more QoS Flows in the PDU Session, two AN Tunnel Info are provided by the Target NG-RAN 802. The Target NG-RAN 802 may indicate to the SMF that one of the AN Tunnel Info is used as a redundancy tunnel for the PDU Session as described in clause 5.33.2.2 of TS 23.501. If only one AN Tunnel Info is provided by the Target NG-RAN 802 for the PDU session, the SMF may release the QoS Flows of the PDU session by triggering PDU Session Modification procedure as specified in clause 4.3.3 of TS 23.502 after the handover procedure.

The selected PLMN ID (or PLMN ID and NID, which further information is provided in TS 23.501, clause 5.34) is included in the N2 Path Switch Request. The target NG-RAN 802 may include the PDU Session in the PDU Sessions Rejected list in the following scenarios: if none of the QoS Flows of a PDU Session are accepted by the Target NG-RAN 802; if the corresponding network slice is not supported in the Target NG-RAN 802; or when the Target NG-RAN 802 cannot set up user plane resources fulfilling the User Plane Security Enforcement with a value Required (the Target NG-RAN rejects the establishment of user plane resources for the PDU Session).

If the Target NG-RAN 802 cannot set up user plane resources fulfilling the User Plane Security Enforcement with a value Preferred, the Target NG-RAN 802 establishes the user plane resources for the PDU session and may include the PDU Session in the PDU Sessions Modified list.

The PDU Sessions Rejected may contain an indication of whether the PDU session was rejected because User Plane Security Enforcement is not supported in the Target NG-RAN 802. Depending on the type of target cell, the Target NG-RAN 802 includes appropriate information in the N2 Path Switch Request message.

For the PDU Sessions to be switched to the Target NG-RAN 802, the N2 Path Switch Request message may include the list of accepted QoS Flows.

At step 814, the AMF 803 sends to SMF(s) 805 an Nsmf_PDUSession_UpdateSMContext Request comprising N2 SM information received from Target NG-RAN 802 in step 812 and N2 SM Information from source NG-RAN 801 (Secondary RAT usage data), UE Location Information, and UE presence in LADN service area). The N2 SM Information here from source NG-RAN 801 is the one buffered at step 810 when applicable.

The AMF 803 sends N2 SM information by invoking the Nsmf_PDUSession_UpdateSMContext request service operation for each PDU Session in the lists of PDU Sessions received in the N2 Path Switch Request.

The Nsmf_PDUSession_UpdateSMContext Request contains either an indication that the PDU Session Is To Be Switched (together with information on the N3 address to use and information on the transferred QoS flows) or an indication that the PDU Session is to be Rejected (together with a rejection cause).

For a PDU Sessions to be switched to the Target NG-RAN 802, upon receipt of the Nsmf_PDUSession_UpdateSMContext request, the SMF, for example SMF 805, determines whether the existing UPF, for example UPF 807, can continue to serve the UE 102. If the existing UPF, UPF 807, cannot continue to serve the UE 102 , steps 3-11 of clause 4.9.1.2.3 or 4.9.1.2.4 of TS 23.502 are performed depending on whether the existing UPF, UPF 807 is a PDU Session Anchor. Otherwise, the following steps 818 to 832 are performed if the existing UPFs, UPF 807, can continue to serve the PDU Session.

In the case that the AMF, for example AMF 803, determines that the PDU Session is related to a LADN, then the AMF provides the “UE presence in LADN service area” to the SMF 805. If the AMF 803 does not provide the “UE presence in LADN service area” indication and the SMF 805 determines that the DNN corresponds to a LADN, then the SMF 805 considers the UE 102 as OUT of the LADN service area. The SMF 805 takes actions for the LADN PDU Session as defined in TS 23.501 clause 5.6.5 based on the “UE presence in LADN service area” indication.

If a PDU Session is rejected by the Target NG-RAN 802 with an indication that the PDU session was rejected because User Plane Security Enforcement is not supported in the Target NG-RAN 802 and the User Plane Enforcement Policy indicates “Required” as described in clause 5.10.3 of TS 23.501, the SMF 805 triggers the release of this PDU Session. In all other cases of PDU Session rejection, the SMF 805 can decide whether to release the PDU Session or to deactivate the UP connection of this PDU Session.

If some of the QoS Flows of a PDU Session are not accepted by the Target NG-RAN 802, the SMF 805 may initiate the PDU Session Modification procedure to remove the non-accepted QoS Flows from the PDU Session(s) after the handover procedure is completed.

For the PDU Session(s) that do not have active N3 UP connections before handover procedure, the SMF(s) 805 may keep the inactive status after handover procedure.

If the UE 102 moves into a non-Allowed Area, the AMF, for example AMF 803, also notifies, via Namf_EventExposure_Notify, each NF Consumer (e.g. SMFs of the established PDU Sessions) which has subscribed for UE reachability event that the UE 102 is only reachable for regulatory prioritized services. The SMF 805 then deactivates the PDU session if this PDU Session is not for emergency service.

At step 816, the AMF 803 may notify the G-SMF 806 of the new location of the UE 102 if the G-SMF 806 has subscribed to AMF 803 for receiving notification of the UE location change. The new location of UE 102 may be represented by the Target NG RAN address.

Alternatively, the AMF 803 may use a service such as Nsmf_PDUSession_UpdateSMContext Request to notify the G-SMF of the new location of UE. The AMF 803 may include the AN tunnel information, which may include the AN address and TEID in the downlink.

At step 818, the SMF 805 sends to UPF 807 an N4 Session Modification Request (AN Tunnel Info, CN Tunnel Info).

For PDU Sessions that are modified by the Target NG-RAN 802, the SMF 805 sends an N4 Session Modification Request message to the UPF 807. The SMF 805 may notify the UPF that originated the Data Notification to discard downlink data for the PDU Sessions and/or to not provide further Data Notification messages.

Depending on the network deployment, the CN Tunnel Info of UPF used for connection to Target NG-RAN 802 and connection to Source NG-RAN 801 may be different due to, e.g. Source NG-RAN 801 and the Target NG-RAN 802 being in different IP domains. If the CN Tunnel Info (on N3) of UPF 807 need be re-allocated and CN Tunnel Info is allocated by the SMF 805, the SMF 805 provides the CN Tunnel Info (on N3) to the UPF 807. If redundant transmission is performed for one or more QoS Flows of a PDU Session, two CN Tunnel Info are provided to UPF 807. When two CN Tunnel Info are provided, the SMF 805 may indicate the UPF 807 that one CN Tunnel Info is used as the redundancy tunnel of the PDU session as described in clause 5.33.2.2 of TS 23.501.

At step 820, if the G-SMF 806 decides to add the Target NG RAN node 802 to the existing MB session, the G-SMF 806 may send to G-UPF 808 an N4 MB Session Modification Request. The message may include one or more of following information: the AN Tunnel Information if the AMF 803 sent this AN Tunnel Information to the G-SMF 806 in step 816; and CN Tunnel Information which may include the TEID of N3 interface in the uplink.

At step 822, the UPF 807 sends to SMF 805 an N4 Session Modification Response (CN Tunnel Info).

For the PDU Sessions that are switched, the UPF 807 returns an N4 Session Modification Response message to the SMF 805 after the requested PDU Sessions are switched. Tunnel identifiers for UL traffic are included only for PDU Sessions whose user plane resources are not being released, and only if the UPF 807 allocates CN Tunnel Info and different CN Tunnel Info need be allocated. If redundant transmission is performed for one or more QoS Flows of a PDU Session and different CN Tunnel Info need be allocated, the UPF 807 allocates two different CN Tunnel Info and indicates the SMF 805 that one CN Tunnel Info is used as the redundancy tunnel of the PDU session as described in clause 5.33.2.2 of TS 23.501. For the PDU Sessions that are deactivated, the UPF 807 returns an N4 Session Modification Response message to the SMF 805 after the N3 (R)AN tunnel information is released.

At step 824 the G-UPF 808 may send an N4 MB Session Modification Response to the G-SMF 806. The message may include the TEID for the UL if the UL TEID is generated by the G-UPF 808 for the MB Session.

In order to assist the reordering function in the Target NG-RAN 802, at step 826, the UPF 807 (as specified in TS 23.501, clause 5.8.2.9) sends to Source NG-RAN 801 one or more “end marker” packets for each N3 tunnel on the old path immediately after switching the path. At step 828, the Source NG-RAN 801 sends the N3 End market to Target NG-RAN 802.

Subsequently, referring to FIG. 8B, the UPF 807 starts sending downlink packets to the Target NG-RAN 802.

At step 830, the SMF 805 sends to AMF 803 an Nsmf_PDUSession_UpdateSMContext Response (CN Tunnel Info). The SMF 805 sends the Nsmf_PDUSession_UpdateSMContext response (CN Tunnel Info) to the AMF 803 for PDU Sessions which have been switched successfully. The CN Tunnel Info of UPF is sent to AMF 803 to setup N3 tunnel. If redundant transmission is performed for one or more QoS Flows of a PDU Session, two CN Tunnel Info are sent and the SMF 805 indicates to the Target NG-RAN 802 that one of the CN Tunnel Info is used as the redundancy tunnel of the PDU Session as described in clause 5.33.2.2 of TS 23.501. The SMF 80 sends the Nsmf_PDUSession_UpdateSMContext response without including the CN Tunnel Info to the AMF 803 for the PDU Sessions for which user plane resources are deactivated or released, and then the SMF 805 releases the PDU Session(s) which is to be released using a separate procedure as defined in clause 4.3.4 of TS 23.502.

It should be noted that step 830 can occur any time after receipt of N4 Session Modification Response at the SMF 805.

At step 832, the G-SMF 806 may send to G-AMF 804 a message to establish (set up) MB Session in the Target NG-RAN node 802. The message may be encapsulated in an N2 SM message. The message may include one or more of information: the QoS profile(s) of the DL QoS flows of MB Session, UE information (e.g. UE ID (e.g. SUPI, GPSI) that may receive the MB data), and CN tunnel information that may contain the UL N3 or N9 TEID.

At step 834, the AMF 803 sends to target NG-RAN 802 an N2 Path Switch Request Ack (N2 SM Information, Failed PDU Sessions, UE Radio Capability ID). Once the Nsmf_PDUSession_UpdateSMContext response is received from all SMFs 805, the AMF 803 aggregates the received CN Tunnel Info and sends this aggregated information as a part of N2 SM Information along with the Failed PDU Sessions in N2 Path Switch Request Ack to the Target NG-RAN 802. If none of the requested PDU Sessions have been switched successfully, the AMF 803 may send an N2 Path Switch Request Failure message to the Target NG-RAN 802.

If the UE Radio Capability ID is included in the N2 Path Switch Request Ack message, when there is no corresponding UE radio capabilities set for UE Radio Capability ID at the target NG-RAN 802, the target NG-RAN 802 may request the AMF 803 to provide the UE radio capabilities set corresponding to UE Radio Capability ID to the target NG-RAN 802.

At step 836, the G-AMF 804 may forward the message received from the G-SMF 806 in step 832 to the Target NG-RAN node 802.

At step 838, by sending a Release Resources message to the Source NG-RAN 801, the Target NG-RAN 802 confirms success of the handover. The Target NG-RAN 802 then triggers the release of resources with the Source NG-RAN 801.

At step 840, the Target NG-RAN node 802 may establish radio resources to support MB Session. The Target NG-RAN node 802 may broadcast the information of the new MB Session in a broadcast radio channel so that the UE 102 may receive the MB Session information and can receive the MB data from the radio channel.

The Target NG-RAN node 802 may send a message to the G-AMF 804 to confirm the establishment of the new MB Session. The message may include RAN tunnel information (e.g. RAN address and DL TEID) if the RAN tunnel information of the MB Session has not been included in message 812.

At step 842, the G-AMF 804 may forward the message received from the Target NG-RAN 802 to the G-SMF 806. If the message include the RAN Tunnel information of the Target NG-RAN 802, the G-SMF 806 may send an N4 MB Session modification request to the G-UPF 808. This message may include the DL tunnel information (e.g. Target NG-RAN address and TEID). Then the G-UPF 808 may start sending the DL MB data to the Target NG-RAN node 802. The G-UPF 808 may send to the G-SMF 806 an N4 MB Session modification response to confirm the MB Session updated.

Step 844 is a conditional step. At step 844, the UE 102 may initiate Mobility Registration Update procedure if one of the triggers of registration procedure applies as described in clause 4.2.2.2.2 of TS 23.502. In this case, only steps 1, 2, 3, 17 and 21 in clause 4.2.2.2.2 are performed.

For the mobility related events as described in clause 4.15.4 of TS 23.502, the AMF invokes the Namf_EventExposure_Notify service operation.

Upon reception of the Namf_EventExposure_Notify with an indication that UE 102 is reachable only for regulatory prioritized service, the SMF deactivates the PDU Session if the service of the PDU Session is not regulatory prioritized. For home routed roaming case, the V-SMF triggers the deactivation of the PDU Session, in addition, the H-SMF refrains from sending downlink signalling if the signalling is not related to regulatory prioritized service upon receiving the notification.

Binding a PDU Session and MB Session during PDU Session Establishment will now be discussed.

Embodiments discussed above provide solutions for a UE to switch from receiving DL data of a (unicast) PDU Session to receiving data from a MB Session. If the MB Session has been established before the UE requests a PDU Session, the network may indicate the binding of the PDU Session and one or multiple existing MB Sessions. This scenario may be useful when a UE establishes a PDU session to communicate with the application server. The mobile network may notify the UE of the MB Sessions currently associated with the UE.

Generally, the procedure for binding a PDU session and MB session during PDU session establishment is as follows. One or more MB Sessions have been established. During the PDU Session Establishment, the UE may need to perform third party authorization by a security server. The SMF sends the information provided by the UE to the security server. The security server may send back to the SMF the MB Sessions that the UE may access. The MB Session may be represented by TMGI. The SMF sends the MB Session information (e.g. including TMGI) to the UE in the PDU Session Accept message. The UE may access radio control channel(s) to find radio data channels that carry DL MB Session(s).

Secondary authorization/authentication by a DN Authentication, Authorization and Accounting (DN-AAA) server during the PDU Session establishment will now be discussed.

The PDU Session establishment authentication/authorization is optionally triggered by the SMF during a PDU Session establishment and performed transparently via a UPF or directly with the DN-AAA server without involving the UPF if the DN-AAA server is located in the 5GC and reachable directly, as described in TS 23.501, clause 5.6.6.

In the case of Home Routed Roaming, unless specified otherwise, the SMF in the information flow defined in this clause is the H-SMF.

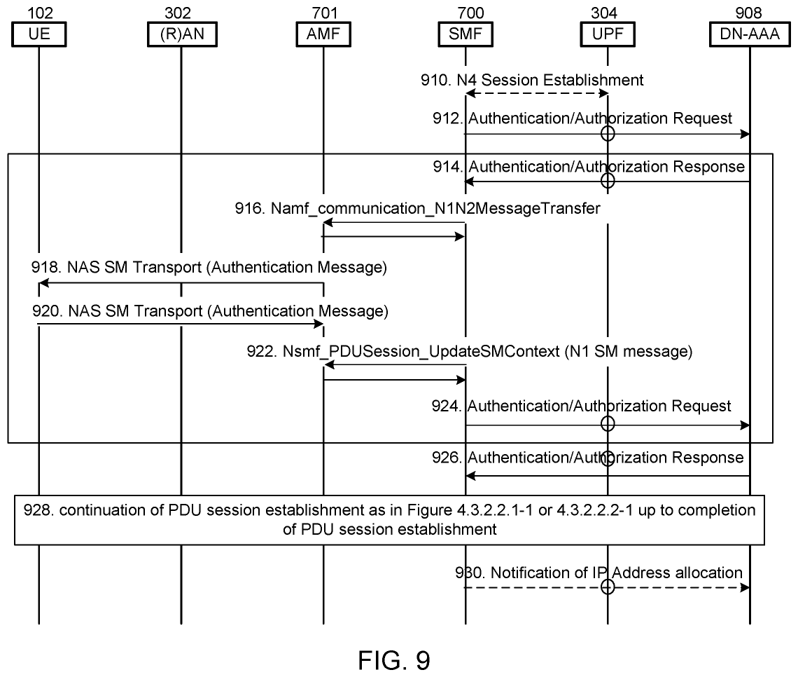

FIG. 9 is an illustration of a PDU Session Establishment authentication/authorization procedure by a DN-AAA server, according to an embodiment of the present disclosure.

Further, it should be noted that when the SMF 700 directly communicates with the DN-AAA server 908 without involving the a UPF, for example UPF 304, step 910 is skipped and step 912, 914, 924, and 930 are executed without involving the UPF 304.

Initially, the SMF 700 determines that it needs to contact the DN-AAA server 908. The SMF 700 identifies the DN-AAA server 908 based on local configuration, possibly using the SM PDU DN Request Container provided by the UE 102 in its NAS request.

At step 910, if there is no existing N4 session that can be used to carry DN-related messages between the SMF 700 and the DN-AAA 908, the SMF 700 selects a UPF 304 and triggers N4 session establishment.

At step 912, the SMF 700 provides an SM PDU DN Request Container received from the UE 102 to the DN-AAA 908 via the UPF 304.

When available, the SMF 700 provides the GPSI in the signalling exchanged with the DN-AAA 908. The UPF 304 transparently relays the message received from the SMF 700 to the DN-AAA server 908.

It should be noted that the content of the SM PDU DN Request Container is defined in TS 33.501 [15].

At step 914, the DN-AAA server 908 sends an Authentication/Authorization message towards the SMF 700. The message is carried via the UPF 304. The message may include the MB Session information that the UE 102 may access to get DL data. For each MB Session, the DN-AAA 908 may include one or more of following information: TMGI, a security code to decrypt the data sent over the DL MB Session if the data is encrypted. The MB Session information may be sent in a separate data container that the SMF 700 does not need to access.

In some embodiment, the DN-AAA 908 may send to the SMF 700 the TMGI of MB Session(s). The SMF 700 may not establish the DL user plane for the PDU session being established for the UE 102. In some embodiments, the SMF 700 may establish the DL user plane for the PDU session being established, but may not establish one or more QoS flows in the downlink since the DL data is being carried by one or more existing MB Session(s).

At steps 916 and 918, the SMF 700 transfer of DN Request Container information received from DN-AAA towards the UE 102 via AMF 701.

In non-roaming and LBO cases, the SMF 700 invokes the Namf_Communication_N1N2MessageTransfer service operation on the AMF 701 to transfer the DN Request Container information within N1 SM information sent towards the UE 102.

In the case of Home Routed roaming, the H-SMF initiates an Nsmf_PDUSession_Update service operation to request the V-SMF (which is SMF 700 in the case of home routed roaming and local breakout roaming) to transfer DN Request Container to the UE 102 and the V-SMF invokes the Namf_Communication_N1N2MessageTransfer service operation on the AMF 701 to transfer the DN Request Container information within N1 SM information sent towards the UE 102. In Nsmf_PDUSession_Update Request, the H-SMF additionally includes the H-SMF SM Context ID.

The DN Request Container information may include the MB Session information the SMF 700 received from the DN-AAA 908.

At step 918, the AMF 701 sends the N1 NAS message to the UE 102.

Steps 920, 922, and 924 provide for the transfer of DN Request Container information received from UE 102 towards the DN-AAA 908.

After step 920 (when the UE 102 responds to AMF 701 with a N1 NAS message containing DN Request Container information), at step 922, the AMF 701 informs the SMF 700 by invoking the Nsmf_PDUSession_UpdateSMContext service operation. The SMF 700 issues an Nsmf_PDUSession_UpdateSMContext response including N1 SM message.

In the case of Home Routed roaming, the V-SMF relays the N1 SM information to the H-SMF using the information of PDU Session received in step 916 via an Nsmf_PDUSession_Update service operation.

At step 924, the SMF 700 (In HR case it is the H-SMF) sends the content of the DN Request Container information (authentication message) to the DN-AAA server 908 via the UPF 304.

Steps 914-924 may be repeated until the DN-AAA server 908 confirms the successful authentication/authorization of the PDU Session.

At step 926, the DN-AAA server 908 confirms the successful authentication/authorization of the PDU Session. The DN-AAA server 908 may provide: an SM PDU DN Response Container to the SMF 700 to indicate successful authentication/authorization and DN Authorization Data as defined in TS 23.501 clause 5.6.6. The DN-AAA server 908 may further provide a request to get notified with the IP address(es) allocated to the PDU Session and/or with N6 traffic routing information or MAC address(es) used by the UE 102 for the PDU Session. The DN-AAA server 908 may further provide an IP address (or IPV6 Prefix) for the PDU Session.

The N6 traffic routing information is defined in TS 23.501 clause 5.6.7.

After the successful DN authentication/authorization, a session is kept between the SMF 700 and the DN-AAA 908. If the SMF 700 receives a DN Authorization Data, the SMF 700 uses the DN Authorization Profile Index to apply the policy and charging control as described in TS 23.501 clause 5.6.6.

At step 928, the PDU Session establishment continues and completes as described in TS 23.502, for example, with reference to FIG. 4.3.2.2.1-1 or 4.3.2.2.2-1 therein. In some embodiments, in the step 7b of the FIG. 4.3.2.2.1-1 of TS 23.502, if the SMF 700 receives the DN Authorization Profile Index in DN Authorization Data from the DN-AAA 908, the SMF 700 sends the DN Authorization Profile Index to retrieve the PDU Session related policy information (as described in TS 23.503, clause 6.4 published in Sep. 24, 2019) and the PCC rule(s) (as described in TS 23.503 clause 6.3) from the PCF. If the SMF 700 receives the DN authorized Session AMBR in DN Authorization Data from the DN-AAA 908, SMF 700 sends the DN authorized Session AMBR within the Session AMBR to the PCF to retrieve the authorized Session AMBR (as described in TS 23.503 clause 6.4).

At step 930, if requested so in step 926 or if configured so by local policies, the SMF 700 notifies the DN-AAA 908 with the IP/MAC address(es) and/or with N6 traffic routing information allocated to the PDU Session together with the GPSI.

The SMF 700 may notify the DN-AAA 908 if the DN-AAA 908 had requested to get notifications about: the allocation or release of an IPV6 Prefix for the PDU Session of IP type or addition or removal of source MAC addresses for the PDU Session of Ethernet type (e.g. using IPV6 multi-homing as defined in TS 23.501 clause 5.6.4.3). The SMF 700 may also notify the DN-AAA 908 if the DN-AAA 908 had requested to get notifications about the change of N6 traffic routing information.

When the PDU Session gets released as described in clause 4.3.4 of TS 23.502, the SMF 700 notifies the DN-AAA 908 of this release.

The DN-AAA server 908 may revoke the authorization for a PDU Session or update DN authorization data for a PDU Session. According to the request from DN-AAA server 908, which may be the revocation of the authorization for a PDU session or updating DN authorization data for a PDU session, the SMF 908 may release or update the PDU Session.

At any time after the PDU Session establishment, the DN-AAA server 908 or SMF 700 may initiate Secondary Re-authentication procedure for the PDU Session as specified in clause 11.1.3 in TS 33.501 [15]. Steps 914 to 924 are performed to transfer the Secondary Re-authentication message between the UE 102 and the DN-AAA 908 server. The Secondary Re-authentication procedure may start from step 914 (DN-AAA initiated Secondary Re-authentication procedure) or step 916 (SMF initiated Secondary Re-authentication procedure). For the DN-AAA server initiated Secondary Re-authentication, the message in step 914 includes GPSI, if available, and the IP/MAC address(es) of the PDU session, for the SMF 700 to identify the corresponding UE and PDU session.

The DN-AAA 908 may initiate DN-AAA Re-authorization without performing re-authentication based on local policy. Accordingly, DN-AAA Re-authorization procedure may start from step 926.

During Secondary Re-authentication/Re-authorization, if the SMF 700 receives DN Authorization Profile Index and/or DN authorized Session AMBR, the SMF 700 reports the received value(s) to the PCF (as described in TS 23.501) by triggering the Policy Control Request Trigger as described in TS 23.503.

The above embodiment, discussed in FIG. 9, allows a UE to quickly access the MB Session and receive shared data over MB channels even before the unicast PDU Session establishment is completed. For some application requiring fast connection establishment, this is crucial to reduce the time for the UE to receive the service. Further, the SMF may not need to establish the DL resources in the RAN and UPF, which can improve the resource utilization efficiency.

The selection of anchor UPF, e.g. the G-UPF, for the MB Session will now be discussed.

According to an embodiment, a method is provided for the G-SMF to select a MB Session Anchor (MBSA) UPF to serve the MB Session. The selection of MBSA UPF is optimized based on the UE location and AS location. The location of AS could be represented by the DNAI(s).

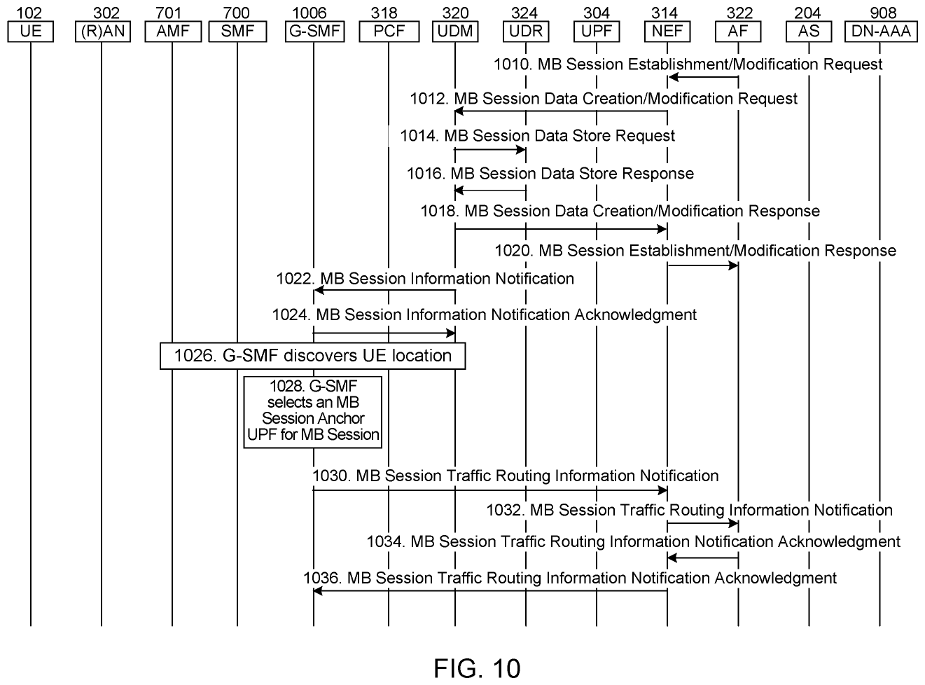

FIG. 10 is an illustration procedure for selection of a MB Session Anchor UPF for an MB session, according to an embodiment of the present disclosure.

At step 1010, the AF 322 may send a request to the core network via the NEF 314 to establish a new MB Session or to modify an existing MB Session. The message may include one or more of following information: information of the UE(s) that will join MB Session (e.g. UE ID, External Group ID, packet filter of the UE), Information of the Application Server (AS) (e.g. DNN, S-NSSAI, DNAI, AF-Service ID, Application ID, packet filter of the AS which may include address (IP address) and port number), MB Session information (e.g. previously assigned TMGI), location information (e.g. geographic zone ID(s), list of RAN ID(s), list of cell ID(s)), and time information (e.g. start and end time of MB Session, start time and duration of MB session).

At step 1012, the NEF 314 may send to the UDM 320 a request to store the new MB Session Data or to modify an existing MB Session Data in the UDM 320. The message includes all the information received from the AF 322.

At step 1014, the UDM 320 may send the MB Session Data to the UDR 324. For the new MB Session Data, the UDM 320 may request the UDR 324 to create a new MB Session Data entry. For an existing MB Session, the UDM 320 may request the UDR 324 to store the updated MB Session Data.

At step 1016, the UDR 324 may send a message MB Session Data Store Response to confirm that the data has been received and/or successfully stored in the UDR.

At step 1018, the UDM 320 may send a message MB Session Data Establishment/Modification Response to the NEF 314 to confirm that the MB Session Data has been received. If the AF 322 requested a new MB Session Establishment, the UDM 320 may create a new TMGI and includes the TMGI in the MB Session Establishment Response.

At step 1020, the NEF 314 may forward the information received in step 1018 to the AF 322.

At step 1022, the UDM 320 may send a message MB Session Information Notification to the G-SMF 1006, which has subscribed to receive the notification of MB Session Data. The G-SMF 1006 may subscribe the UDM 320 to receive new MB Session Data of new MB Session Establishment request, or the updated MB Session Data for existing MB Session. The G-SMF 1006 may subscribe to receive MB Session Data that are related to any combination of following parameters: DNN, S-NSSAI, AF Service ID, location, Application ID. The UDM 320 may notify the G-SMF 1006 the NEF address that was used to receive message from the AF 322 in step 1010. The G-SMF 1006 may use the same NEF 314 to communicate with the AF 322.

At step 1024, the G-SMF 1006 may send to the UDM 320 a message MB Session Information Notification Acknowledgment.

At step 1026, the G-SMF 1006 discovers the UE location. The G-SMF 1006 may communicate with the UDM 320 to discover which AMF function is currently serving the UEs. The G-SMF 1006 may use a service of UDM 320 to discover the serving AMF of the UE 102. The G-SMF 1006 may retrieve the UE location from the UDM 320 if the UE location has been sent from the AMF 701 to the UDM 320 and stored in the UDR 324.

After discovering the AMF address that serves the UE 102, the G-SMF 1006 may communicate with AMF(s) 701 to get UE location by using Namf_Location services of the AMF 701. The AMF 701 may send the location of UE to the G-SMF 1006. The location of UE could be represented by the serving cell ID or (R)AN 302 address (such as IP address of the (R)AN 302), or (R)AN 302 ID.

The G-SMF 1006 may subscribe to AMF(s) 701 to receive notification of the UE location.

At step 1028, the G-SMF 1006 may use the UE location information and/or MB Session information (such as DNN, S-NSSAI, DNAI) to select an MB Session Anchor (MBSA) UPF.

At step 1030, after selecting an MBSA UPF, the G-SMF 1006 may send an MB Session Traffic Routing Information Notification to the AF 322 to notify AF 322 about the MBSA UPF. The message may include one or more of following information: TMGI, MB Session ID, the packet filter of the MBSA UPF, such as IP address and port of the MBSA UPF for the AS to send DL MB data.

If the TMGI is created by the UDM 320, and the UDM 320 sent the TMGI to the G-SMF 1006 in step 1022, the G-SMF 1006 may include this TMGI in the MB Session Traffic Routing Information Notification.

If the UDM 320 does not create the TMGI, the G-SMF 1006 may create a TMGI.

The G-SMF 1006 may create a MB Session ID, which may be unique for the AF 322, or may be unique within the G-SMF 1006, or may be unique within the mobile network, or may be unique within the whole public land mobile network (PLMN) that serves the UEs.

At step 1032, the NEF 314 may forward the message received in step 1030 to the AF 322.

At step 1034 and 1036, the AF 322 may send an MB Session Traffic Routing Information Notification Acknowledgment to NEF 314, to be forwarded to the SMF 700.

At step 1036, the NEF 314 may forward the MB Session Traffic Routing Information Notification Acknowledgment received from the AF 322 to the G-SMF 1006.

The embodiment discussed above, in FIG. 10, provides a method for the G-SMF 1006 to select a MB Session Anchor (MBSA) UPF to serve the MB Session. The selection of MBSA UPF is optimized based on the UE location and AS location.

The mobile network (such as a PLMN) and the AS 204 may provide different levels of access control for the UE 102 to use MB services. In some embodiment the mobile network may allow UEs to receive broadcast data of one or multiple broadcast sessions. The (R)AN 302 may have a control channel that sends radio configuration parameters of the broadcast channels. The UE 102 may be in any connection state, for example RRC-Connected state, RRC-Idle state, RRC-Inactive state, CM-Connected state, CM-Idle state, and the UE 102 may access the control channel to receive radio configuration parameters of broadcast data radio bearer(s) (DRB). The broadcast PDUs may not be encrypted, hence the UE 102 may not need to get authorization from the mobile network to receive the content from these broadcast DRBs.

In some embodiments, the mobile network may allow only authorized UEs to receive the MB data. The mobile network may protect the MB data by encrypting the MB PDUs. The UE 102 may need to send a request for authorization to access a certain MB session. The MB session authorization request may be sent in an N1 NAS message to the AMF 308. The UE 102 may include in the N1 NAS message one or more of parameters: UE information (e.g. UE ID, SUPI, SUCI), MB session information (e.g. TMGI, MB Session ID), and an indication to receive the MB data. The MB Session information is the information that has been broadcasted by the (R)AN 302 in a control channel. The AMF 308 may forward the MB session authorization request to the UDM 320. The UDM 320 may check the subscription of the UE 102 and determine whether the UE request for MB Session authorization could be accepted or rejected. If the UE request is accepted, the UDM may send an MB Session Authorization Response to the AMF 308. The message may include an indication of accepted or rejected authorization. If the authorization request is accepted, and the data sent over the MB channel is encrypted by the MBSA UPF or the AS 204, the UDM 320 may send a decryption key to the UE 102. The UDM 320 may get the decryption key from the UDR 324. The AMF 308 receives the MB Session Authorization Response from the UDM 320. The AMF 308 may send an N1 NAS message to the UE 102 and an N2 message to the (R)AN 302. The N1 NAS message may carry the MB Session Authorization Response received from the UDM 320, a decryption key to decrypt the data encrypted by the (R)AN 302. The N2 message to the (R)AN 302 may include an indication that the UE 102 is authorized to receive MB data of an MB session represented by, e.g. MB Session ID, or TMGI. The (R)AN 302 may forward the received N1 NAS message to the UE 102. The (R)AN 302 may perform an RRC procedure to send the decryption key to the UE 102 if the (R)AN 302 encrypts the MB data sent over the MB DRB(s).

In some embodiments, the UE 102 may send a request for authorization to access an MB service and/or one or multiple MB Session(s) of the MB service to a CP NF-X, such as SMF 310, of the mobile network during PDU Session Establishment procedure. The NF-X, such as SMF 310, may forward the MB Session Authorization Request of the UE 102 to a third party AF 322, either directly or via the NEF 314. The NF-X, such as SMF 310, may include in the message the UE location information, such as geographic zone ID, (R)AN ID, and cell ID. After receiving the message from the NF-X, the AF 322 may send to the mobile network an authorization acceptance or rejection message. If the MB Session Authorization Request is accepted, the AF 322 may include in the MB Session Authorization Response a message-1 to be sent to the UE 102 and a message-2 to the NF-X. The message-1 for the UE may include information for the UE 102 to access the requested MB Service and/or the information to access one or multiple MB Session(s). For example, the information to access one MB Session may include one or more of following parameters: the MB Session ID, TMGI of the MB Session, Packet Filter(s) of the MB Session, the IP multicast address of the router that UE 102 may send a request to join the MB Session, the IP multicast of the G-UPF, which is MBSA UPF, that the UE 102 may send a request to join the MB Session. The message-2 for the NF-X, such as SMF 310, may include the MB Session information that the UE may join. The MB Session information may include one or more of following information: the MB Session ID, TMGI of the MB Session, Packet Filter(s) of the MB Session, the IP multicast address of the router that UE 102 may send a request to join the MB Session, the IP multicast address of the G-UPF 338 (or MBSA UPF) that the UE 102 may send a request to join the MB Session. The NF-X, such as SMF 310, may use the information in the message-2 to configure the UP path between the (R)AN 302 and the G-UPF 338 (which is also MBSA UPF) so that the G-UPF 338 may send the DL MB data to the (R)AN 302. The NF-X, such as SMF 310, may configure the G-UPF 338 to detect the UL message from the UE 102, e.g. IGMP Join, to join an MB Session. The NF-X may forward the message-1 to the UE 102. The UE 102 may use the information in message-1 to access the radio channel, such as MB DRB, that carries the MB data. The UE 102 may use the information in message-1 to send an Internet Group Management Protocol (IGMP) Join message to the G-UPF 338 to join the allowed MB Session.

The UP Establishment for a UE to join MB Session will now be discussed. This procedure may support the mobile network and/or another party to authorize the UE request to use an MB Service and/or to join an MB Session.

A UE may request to establish a PDU Session to receive data of an MB Session. The PDU Session Establishment procedure is described in clause 4.3.2.2 of TS 23.502. There are some additional steps and information elements needed to support the UE to join MB session, which will be further described below.

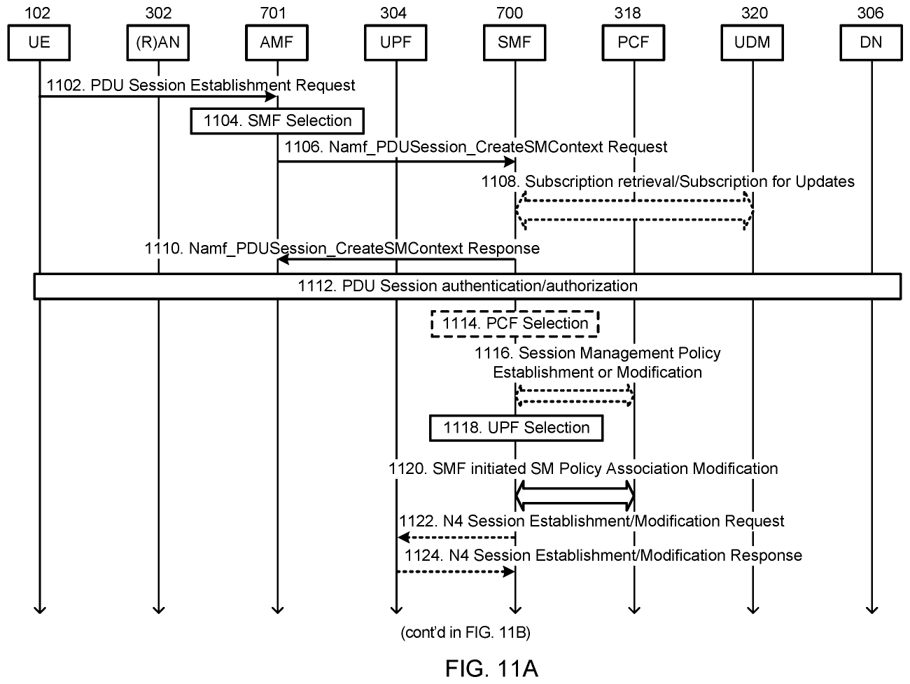

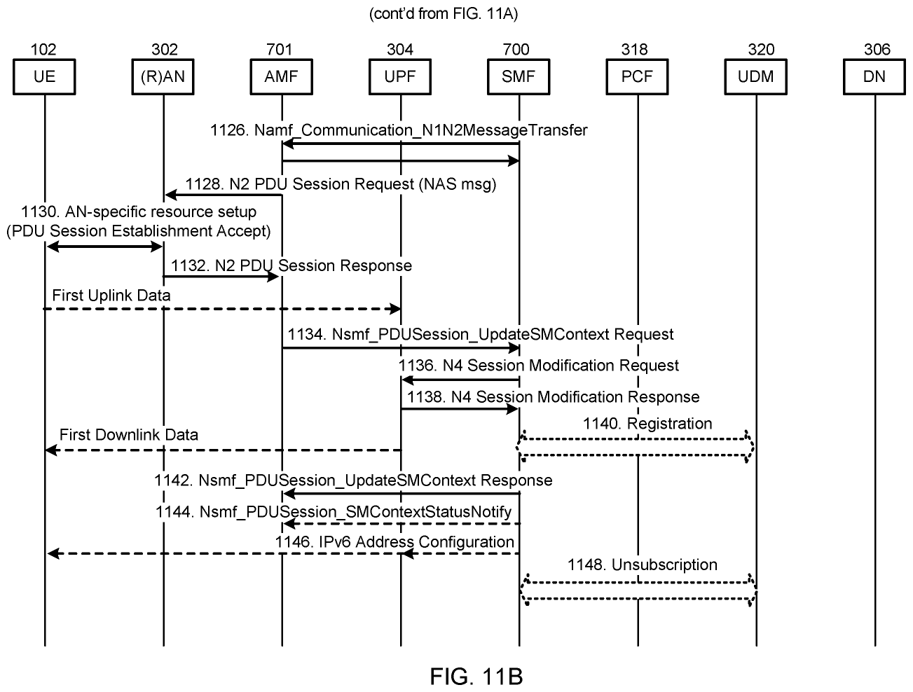

FIG. 11A and FIG. 11B are illustrations of a UE-requested PDU Session Establishment for non-roaming and roaming with local breakouts, according to an embodiment of the present disclosure.

The procedure embodiment in FIG. 11A and FIG. 11B assumes that the UE 102 has already registered with the AMF 701, thus, unless the UE is Emergency Registered, the AMF 701 has already retrieved the user subscription data from the UDM 320.

At step 1102, UE 102 sends to AMF 701, via (R)AN 302, a NAS Message comprising S-NSSAI(s), DNN, PDU Session ID, Request type, Old PDU Session ID, MB Session ID, UE Group ID, N1 SM container (PDU Session Establishment Request).

In order to establish a new PDU Session, the UE 1102 generates a new PDU Session ID.

The UE 102 initiates the UE Requested PDU Session Establishment procedure by the transmission of a NAS message, at step 1102, containing a PDU Session Establishment Request within the N1 SM container. The PDU Session Establishment Request includes a PDU session ID, Requested PDU Session Type, a Requested Service and Session Continuity (SSC) mode, 5GSM Capability PCO, SM PDU DN Request Container, Number of Packet Filters, UE Integrity Protection Maximum Data Rate, and optionally Always-on PDU Session Requested, MB Session ID, and UE Group ID.

The Request Type indicates “Initial request” if the PDU Session Establishment is a request to establish a new PDU Session, and the Request Type indicates “Existing PDU Session” if the request refers to an existing PDU Session switching between 3GPP access and non-3GPP access or to a PDU Session handover from an existing Packet Data Network (PDN) connection in EPC. If the request refers to an existing PDN connection in EPC, the S-NSSAI is set as described in TS 23.501 clause 5.15.7.2

When Emergency service is required and an Emergency PDU Session is not already established, a UE 102 initiates the UE Requested PDU Session Establishment procedure with a Request Type indicating “Emergency Request”.

The Request Type indicates “Emergency Request” if the PDU Session Establishment is a request to establish a PDU Session for Emergency services. The Request Type indicates “Existing Emergency PDU Session” if the request refers to an existing PDU Session for Emergency services switching between 3GPP access and non-3GPP access or to a PDU Session handover from an existing PDN connection for Emergency services in EPC.

The 5GSM Core Network Capability is provided by the UE 102 and handled by SMF 700 as defined in TS 23.501 clause 5.4.4b.

The Number of Packet Filters indicates the number of supported packet filters for signalled QoS rules for the PDU Session that is being established. The number of packet filters indicated by the UE 102 is valid for the lifetime of the PDU Session.

The UE Integrity Protection Maximum Data Rate indicates the maximum data rate up to which the UE 102 can support UP integrity protection. The UE 102 provides the UE Integrity Protection Data Rate capability independently of the Access Type over which the UE sends the PDU Session Establishment Request.

The NAS message sent by the UE 102 is encapsulated by the AN in an N2 message towards the AMF 701 that should include User location information and Access Type Information.

The PDU Session Establishment Request message may contain SM PDU DN Request Container containing information for the PDU Session authorization by the external DN.

The UE 102 includes the S-NSSAI from the Allowed NSSAI of the current access type. If the Mapping of Allowed NSSAI was provided to the UE 102, the UE 102 provides both the S-NSSAI of the VPLMN from the Allowed NSSAI and the corresponding S-NSSAI of the HPLMN from the Mapping Of Allowed NSSAI.

If the procedure is triggered for SSC mode 3 operation, the UE 102 also includes the Old PDU Session ID which indicates the PDU Session ID of the on-going PDU Session to be released, in the NAS message. The Old PDU Session ID is an optional parameter which is included only in this case.

The AMF 701 receives from the (R)AN 302 the NAS SM message together with User Location Information (e.g. Cell Id in case of the NG-RAN).

The UE 102 may not trigger a PDU Session establishment for a PDU Session corresponding to a LADN when the UE 102 is outside the area of availability of the LADN.

If the UE 102 is establishing a PDU session for IMS, and the UE 102 is configured to discover the P-CSCF address during connectivity establishment, the UE 102 includes an indicator that it requests a P-CSCF IP address(es) within the SM container.

The PS Data Off status is included in the PCO in the PDU Session Establishment Request message.

If the UE 102 requests to establish always-on PDU session, the UE 102 includes an Always-on PDU Session Requested indication in the PDU Session Establishment Request message.

The UE 102 may include an identifier to identify an existing multicast and/or broadcast (MB) session ID that the UE may want to join. This identifier may be the MB Session ID or some other identifiers.

The UE 102 may include a UE Group ID to identify the PDU Session to communicate with other UEs of the UE Group. The UE Group ID may be the TMGI, Internal Group ID, External Group ID. The UE 102 may include UE Group ID in the PDU Session Establishment Request.

At step 1104, the AMF 701 determines that the message received corresponds to a request for a new PDU Session based on the “initial request” indication of the Request Type and that the PDU Session ID is not used for any existing PDU Session(s) of the UE 102. If the NAS message does not contain an S-NSSAI, the AMF 701 determines a default S-NSSAI of the HPLMN for the requested PDU Session either according to the UE subscription, if it contains only one default S-NSSAI, or based on operator policy, and in the case of LBO, an S-NSSAI of the Serving PLMN which matches the S-NSSAI of the HPLMN. When the NAS Message contains an S-NSSAI of the Serving PLMN but it does not contain a DNN, the AMF 701 determines the DNN for the requested PDU Session by selecting the default DNN for this S-NSSAI if the default DNN is present in the UE's Subscription Information (or for the corresponding S-NSSAI of the HPLMN, in the case of LBO); otherwise the serving AMF 701 selects a locally configured DNN for this S-NSSAI of the Serving PLMN. If the AMF 701 cannot select an SMF (e.g. the UE provided DNN is not supported by the network, or the UE provided DNN is not in the Subscribed DNN List for the S-NSSAI (or its mapped value for the HPLMN in the case of LBO) and wildcard DNN is not included in the Subscribed DNN list), the AMF 701 may reject the NAS Message containing PDU Session Establishment Request from the UE with an appropriate cause.

The AMF 701 may select an SMF as described in clause 6.3.2 of TS 23.501 and clause 4.3.2.2.3. If the Request Type indicates “Initial request” or the request is due to handover from EPS or from non-3GPP access serving by a different AMF, the AMF 701 stores an association of the S-NSSAI(s), the DNN, the PDU Session ID, the SMF ID as well as the Access Type of the PDU Session.

If the Request Type is “initial request” and if the Old PDU Session ID indicating the existing PDU Session is also contained in the message, the AMF 701 selects an SMF as described in clause 4.3.5.2 of TS 23.502 and stores an association of the new PDU Session ID, the S-NSSAI(s), the selected SMF ID as well as Access Type of the PDU Session.

If the Request Type indicates “Existing PDU Session”, the AMF 102 selects the SMF based on SMF-ID received from UDM 320. In the case where the Request Type indicates “Existing PDU Session” and either the AMF 701 does not recognize the PDU Session ID or the subscription context that the AMF 701 received from UDM 320 during the Registration or Subscription Profile Update Notification procedure does not contain an SMF ID corresponding to the PDU Session ID, the case may be an error case. The AMF 701 updates the Access Type stored for the PDU Session.

If the Request Type indicates “Existing PDU Session” referring to an existing PDU Session moved between 3GPP access and non-3GPP access, then if the Serving PLMN S-NSSAI of the PDU Session is present in the Allowed NSSAI of the target access type, the PDU Session Establishment procedure can be performed in the following cases. The PDU Session Establish procedure can be performed when the SMF ID corresponding to the PDU Session ID and the AMF 701 belong to the same PLMN; and when the SMF ID corresponding to the PDU Session ID belongs to the HPLMN. Otherwise the AMF 701 may reject the PDU Session Establishment Request with an appropriate reject cause.

It should be noted that the SMF ID includes the PLMN ID that the SMF belongs to.

The AMF 701 may reject a request from an Emergency Registered UE where the Request Type indicates neither “Emergency Request” nor “Existing Emergency PDU Session”. When the Request Type indicates “Emergency Request”, the AMF 701 is not expecting any S-NSSAI and DNN value provided by the UE 102; instead, the AMF 701 may use locally configured values. The AMF 701 stores the Access Type of the PDU Session.

If the Request Type indicates “Emergency Request” or “Existing Emergency PDU Session”, the AMF 701 selects the SMF as described in TS 23.501, clause 5.16.4.

If the UE 102 provides the MB Session ID and/or UE Group ID, the AMF 701 may select an SMF based on the MB Session ID and/or UE Group ID. For example, the AMF 701 may use the NRF 316 to discover the SMF or the SMF set that is configured or previously selected to serve the MB Session with MB Session ID, and/or UE Group ID. The AMF 701 may include the MB Session ID and/or UE Group ID in the message sent to the NRF 316 so that the NRF 316 may send a message to inform the AMF 701 which SMF(s) or SMF set(s) can serve the UE 102. Another method is that the SMF or SMF set may previously notify the AMF 701 about the SMF ID or SMF Set ID that currently serves the MB Session and/or UE Group ID. The AMF 701 may select the same SMF or SMF Set that is currently serving the MB Session and/or UE Group ID.

At step 1106, the AMF 701 sends to SMF 700 either an Nsmf_PDUSession_CreateSMContext Request (SUPI, DNN, S-NSSAI(s), PDU Session ID, AMF ID, Request Type, PCF ID, Priority Access, MB Session ID, UE Group ID, N1 SM container (PDU Session Establishment Request), User location information, Access Type, PEI, GPSI, UE presence in LADN service area, Subscription For PDU Session Status Notification, DNN Selection Mode, Trace Requirements) or an Nsmf_PDUSession_UpdateSMContext Request (SUPI, DNN, S-NSSAI(s), SM Context ID, AMF ID, Request Type, N1 SM container (PDU Session Establishment Request), User location information, Access Type, RAT type, PEI).

If the AMF 701 does not have an association with an SMF for the PDU Session ID provided by the UE 102 (e.g. when Request Type indicates “initial request”), the AMF 701 invokes the Nsmf_PDUSession_CreateSMContext Request, but if the AMF 701 already has an association with an SMF for the PDU Session ID provided by the UE 102 (e.g. when Request Type indicates “existing PDU Session”), the AMF 701 invokes the Nsmf_PDUSession_UpdateSMContext Request.

The AMF 701 sends the S-NSSAI of the Serving PLMN from the Allowed NSSAI to the SMF 700. For roaming scenario in local breakout (LBO), the AMF 701 also sends the corresponding S-NSSAI of the HPLMN from the Mapping of Allowed NSSAI to the SMF 700.

The AMF ID is the UE's GUAMI which uniquely identifies the AMF serving the UE. The AMF 701 forwards the PDU Session ID together with the N1 SM container containing the PDU Session Establishment Request received from the UE 102. The GPSI may also be included if available at AMF 701.

The AMF 701 determines Access Type and RAT Type based on the Global RAN Node ID associated with the N2 interface.

The AMF 701 may provide the PEI instead of the SUPI when the UE 102 in limited service state has registered for Emergency services (i.e. Emergency Registered) without providing a SUPI. The PEI is defined in TS 23.501 clause 5.9.3. In case the UE in limited service state has registered for Emergency services (i.e. Emergency Registered) with a SUPI but has not been authenticated, the AMF 701 indicates that the SUPI has not been authenticated. The SMF 700 determines that the UE has not been authenticated when it does not receive a SUPI for the UE or when the AMF 701 indicates that the SUPI has not been authenticated.

If the AMF 701 determines that the DNN corresponds to an LADN, then the AMF 701 provides the “UE presence in LADN service area” that indicates if the UE 102 is IN or OUT of the LADN service area.

If the Old PDU Session ID is included in step 1102, and if the SMF is not to be reallocated, the AMF 701 also includes the Old PDU Session ID in the Nsmf_PDUSession_CreateSMContext Request.

The AMF may also determine the DNN Selection Mode, which indicates whether an explicitly subscribed DNN has been provided by the UE in its PDU Session Establishment Request.

The SMF 700 may use DNN Selection Mode when deciding whether to accept or reject the UE request.

When the Establishment cause received as part of AN parameters during the Registration procedure or Service Request procedure is associated with priority services (e.g. MPS, MCS), the AMF 701 may include a Message Priority header to indicate priority information. The SMF 700 uses the Message Priority header to determine if the UE request is subject to exemption from NAS level congestion control. Other NFs relay the priority information by including the Message Priority header in service-based interfaces, as specified in TS 29.500 [17].

In the local breakout case, if the SMF 700 (in the VPLMN) is not able to process some part of the N1 SM information that Home Routed Roaming is required, the SMF 700 may respond to the AMF 701 that it is not the right SMF to handle the N1 SM message by invoking Nsmf_PDUSession_CreateSMContext Response service operation. The SMF 700 includes a proper N11 cause code triggering the AMF 701 to proceed with home routed case. The procedure starts again at step 2 of clause 4.3.2.2.2, TS 23.502.

The AMF 701 may include a PCF ID in the Nsmf_PDUSession_CreateSMContext Request. This PCF ID identifies the H-PCF in the non-roaming case and the V-PCF in the local breakout roaming case.

The AMF 701 may include Trace Requirements if Trace Requirements have been received in subscription data. The AMF 701 may include the MB Session ID if the MB Session ID has been provided in the PDU Session Establishment Request. The AMF 701 may include the UE Group ID if the UE Group ID has been provided in the PDU Session Establishment Request.

At step 1108, if Session Management Subscription data for corresponding SUPI, DNN and S-NSSAI of the HPLMN is not available, then SMF 700 retrieves the Session Management Subscription data using Nudm_SDM_Get (SUPI, Session Management Subscription data, DNN, S-NSSAI of the HPLMN) and subscribes to be notified when this subscription data is modified using Nudm_SDM_Subscribe (SUPI, Session Management Subscription data, DNN, S-NSSAI of the HPLMN). The UDM 320 may get this information from the UDR by Nudr_DM_Query (SUPI, Subscription Data, Session Management Subscription data, DNN, S-NSSAI of the HPLMN) and may subscribe to notifications from UDR for the same data by Nudr_DM_subscribe.

The SMF 700 may use DNN Selection Mode when deciding whether to retrieve the Session Management Subscription data e.g. in case the DNN and S-NSSAI of the HPLMN is not explicitly subscribed, in which the SMF 700 may use local configuration instead of Session Management Subscription data.

If the Request Type in step 1106 indicates “Existing PDU Session” or “Existing Emergency PDU Session” the SMF 700 determines that the request is due to switching between 3GPP access and non-3GPP access or due to handover from EPS. The SMF 700 identifies the existing PDU Session based on the PDU Session ID. In such a case, the SMF 700 may not create a new SM context but instead update the existing SM context and provide the representation of the updated SM context to the AMF 701 in the response.

If the Request Type is “Initial request” and if the Old PDU Session ID is included in Nsmf_PDUSession_CreateSMContext Request, the SMF 700 identifies the existing PDU Session to be released based on the Old PDU Session ID.

The Subscription data includes the Allowed PDU Session Type(s), Allowed SSC mode(s), default 5QI and Allocation and Retention Priority (ARP), and subscribed Session-AMBR. The Static IP address/prefix may be included in the subscription data if the UE 102 has subscribed to it.

The Subscription data may include the allowed MB Service. The MB Service could be a V2X MB service, public safety service, TV service, movie service, IPTV streaming service, video or voice conferencing service, multi-party gaming service, live concert streaming service, live sport streaming service, or 5G LAN (local Area Network) service. The MB Service may be represented by one or more of following parameters for example: Application ID, DNN, S-NSSAI, Internal Group ID, External Group ID.

The SMF 700 may check the validity of the UE request by determining whether the UE request is compliant with the user subscription and with local policies. In the case that the DNN corresponds to a local area data network (LADN), the SMF 700 may check the validity of the UE request by determining whether the UE is located within the LADN service area based on the “UE presence in LADN service area” indication from the AMF 701. If the AMF 701 does not provide the “UE presence in LADN service area” indication and the SMF 700 determines that the DNN corresponds to a LADN, then the SMF considers that the UE is OUT of the LADN service area.

The SMF 700 may also check the validity of the UE request by determining whether the UE 102 is allowed to access the MB Session identified by MB Session ID, and/or whether the UE is a member of the UE Group identified by UE Group ID.

If the UE request is considered as not valid, the SMF 700 may decide not to accept the request to establish the PDU Session.

At step 1110, the SMF 700 sends to AMF 701 either an Nsmf_PDUSession_CreateSMContext Response (Cause, SM Context ID or N1 SM container (PDU Session Reject (Cause))) or an Nsmf_PDUSession_UpdateSMContext Response depending on the request received in step 1106.

If the SMF 700 received Nsmf_PDUSession_CreateSMContext Request in step 1106 and the SMF 700 is able to process the PDU Session establishment request, the SMF 700 creates an SM context and responds to the AMF 701 by providing an SM Context ID.

In the case that the UP Security Policy for the PDU Session is determined to have Integrity Protection set to “Required”, the SMF 700 may, based on local configuration, decide whether to accept or reject the PDU Session request based on the UE Integrity Protection Maximum Data Rate. It should be noted that the SMF 700 can be configured e.g. to reject a PDU Session if the UE Integrity Protection Maximum Data Rate has a very low value, in case the services provided by the DN would require higher bitrates.

When the SMF 700 decides not to accept the request to establish a PDU Session, the SMF 700 rejects the UE request via NAS SM signalling including a relevant SM rejection cause by responding to the AMF 701 with an Nsmf_PDUSession_CreateSMContext Response. The SMF 700 also indicates to the AMF 701 that the PDU Session ID is to be considered as released, then, the SMF 700 proceeds to step 1148 (unsubscription) and the PDU Session Establishment procedure is stopped.

Step 1112 is an optional Secondary authentication/authorization. If the Request Type in step 1106 indicates “Existing PDU Session”, the SMF 700 does not perform a secondary authentication/authorization. If the Request Type received in step 1106 indicates “Emergency Request” or “Existing Emergency PDU Session”, the SMF 700 may not perform secondary authentication\authorization. Step 1112 may be used to provide authorization to access the service hosted in the DN 306. The application server in DN 306 may provide authorization to access the service and/or the authorization to access one or multiple MB Session(s) of the MB service.

If the SMF 700 needs to perform secondary authentication/authorization during the establishment of the PDU Session by a DN-AAA server as described in TS 23.501 clause 5.6.6, the SMF 700 triggers the PDU Session establishment authentication/authorization as described in clause 4.3.2.3 of TS 23.502.

If the UE 102 has provided the MB Session ID, the SMF 700 may send the MB Session ID to the DN-AAA. If the UE 102 has provided the UE Group ID, the SMF 700 may send the UE Group ID to the DN-AAA. The DN-AAA server may provide authorization confirmation to the SMF 700 that the UE 102 is authorized to receive MB data of the MB Session indicated by an MB Session ID. The DN-AAA may notify the SMF 102 about the MB Session ID(s) and/or TMGI(s) of the MB Session(s) that the UE may join. The DN-AAA server may notify the SMF 700 about the UE Group ID(s) of the UE Group the UE may communicate with other UEs in the UE Group(s).

Instead of the DN-AAA, the SMF 700 may send the MB Session ID and/or UE Group ID to another entity, such as an AF or an AS 204, in the DN 306. The entity in the DN 306, such as an AF or an AS, may send to the SMF 700 one or more of following information: the information to identify the MB Services that the UE 102 is authorized to use, e.g. Application ID(s); the information to identify the MB Session(s) that the UE 102 is authorized to join, e.g. the MB Session ID(s), TMGI(s), and IP multicast address of MB session(s).

At step 1114, if dynamic PCC is to be used for the PDU Session, the SMF 700 performs PCF selection as described in TS 23.501, clause 6.3.7.1. If the Request Type indicates “Existing PDU Session” or “Existing Emergency PDU Session”, the SMF 700 may use the PCF 318 already selected for the PDU Session. Otherwise, the SMF 700 may apply local policy.

At step 1116, the SMF 700 may perform an SM Policy Association Establishment procedure as defined in clause 4.16.4 to establish an SM Policy Association with the PCF 318 and get the default PCC Rules for the PDU Session. The GPSI may be included if available at SMF 700. If the Request Type in step 1106 indicates “Existing PDU Session”, the SMF 700 may provide information on the Policy Control Request Trigger condition(s) that have been met by an SMF initiated SM Policy Association Modification procedure as defined in clause 4.16.5.1. The PCF 318 may provide policy information defined in clause 5.2.5.4 (and in TS 23.503) to SMF.

The PCF 318, based on the Emergency DNN, sets the ARP of the PCC rules to a value that is reserved for Emergency services as described in TS 23.503.

It should be noted that the purpose of step 1114 and 1116 is to receive PCC rules before selecting the UPF 304. If PCC rules are not needed as an input for UPF selection, steps 1114 and 1116 can be performed after step 1118 (UPF selection).

At step 1118, if the Request Type in step 1106 indicates “Initial request”, the SMF 700 may select an SSC mode for the PDU Session as described in TS 23.501, clause 5.6.9.3. The SMF 700 may also select one or more UPFs 304 as needed as described in TS 23.501 clause 6.3.3. In case of PDU Session Type IPv4 or IPv6 or IPv4v6, the SMF 700 allocates an IP address/prefix for the PDU Session as described in TS 23.501 clause 5.8.1. In case of PDU Session Type IPv6 or IPv4v6, the SMF 700 also allocates an interface identifier to the UE 102 for the UE 102 to build its link-local address. For Unstructured PDU Session Type the SMF 700 may allocate an IPv6 prefix for the PDU Session and N6 point-to-point tunnelling (based on UDP/IPv6) as described in TS 23.501, clause 5.6.10.3. For Ethernet PDU Session Type, neither a MAC nor an IP address is allocated by the SMF 700 to the UE 102 for this PDU Session.

If the Request Type in Step 1106 is “Existing PDU Session”, the SMF 700 maintains the same IP address/prefix that has already been allocated to the UE 102 in the source network.

If the Request Type in step 1106 indicates “Existing PDU Session” referring to an existing PDU Session moved between 3GPP access and non-3GPP access, the SMF 700 maintains the SSC mode of the PDU Session, the current PDU Session Anchor and IP address.

It should be noted that the SMF 700 may decide to trigger e.g. new intermediate UPF insertion or allocation of a new UPF as described in step 5 in clause 4.2.3.2, TS 23.502.

If the Request Type indicates “Emergency Request”, the SMF 700 may select the UPF 304 as described in TS 23.501, clause 5.16.4 and may select SSC model.

The SMF 700 may send a request message to the G-SMF (not shown in FIG. 11A and 11B) to request for UPF selection information. The SMF 700 may include in the request message one or more of the following information: UE ID (e.g. SUPI, GUTI), MB Session ID, UE Group ID, DNAI, Application ID, DNN, S-NSSAI.

The G-SMF 311 may send the UPF address information (e.g. UPF ID, UPF FQDN), and the information to identify the N4 interface to modify the MB Session Context in the UPF (e.g. N4 Session ID, N4 Group Session ID). This UPF may be an anchor UPF (such as MBSA UPF) that the user plane (UP) of the PDU Session may be connected to.

In some embodiments, the SMF 700 and G-SMF 311 may be configured by the OAM 326 to be grouped in the same SMF set. The SMF 700 may directly access the memory in the SMF set that store the MB Session Context created by the G-SMF 311. The SMF 700 may get the MBSA UPF information in the MB Session Context.

In some embodiments, the SMF 700 and G-SMF 311 are just one SMF instance. It means that one SMF instance is configured to serve all the MB Sessions and PDU Sessions that may share some common characteristics. The common characteristics could be one or more of following: accessing the same DNN(s), the same S-NSSAI(s); the same NSI ID; the same application(s) represented by e.g. Application ID(s), AF Service ID(s), AF ID(s); serving the UEs of the same UE group represented by e.g. the External Group ID(s), or the same Internal Group ID, or TMGI; the same location represented by e.g. geographical zone IDs, tracking area ID(s), registration area(s), and the same customer(s).

At step 1120, the SMF 700 may perform an SMF initiated SM Policy Association Modification procedure as defined in clause 4.16.5.1 to provide information on the Policy Control Request Trigger condition(s) that have been met. If Request Type is “initial request” and dynamic PCC is deployed and PDU Session Type is IPv4 or IPv6 or IPv4v6, SMF 700 notifies the PCF 318 (if the Policy Control Request Trigger condition is met) with the allocated UE IP address/prefix(es).

When the PCF 318 is deployed, the SMF 700 may further report the PS Data Off status to PCF 318 if the PS Data Off Policy Control Request Trigger is provisioned; the additional behaviour of SMF 700 and PCF 318 for 3GPP PS Data Off is defined in TS 23.503.

It should be noted that if an IP address/prefix has been allocated before step 1114 (e.g. subscribed static IP address/prefix in UDM/UDR) or steps 1114 and 1116 are performed after step 1118, the IP address/prefix can be provided to PCF 318 in step 1116, and the IP address/prefix notification in this step can be skipped.

The PCF 318 may provide updated policies to the SMF 700. The PCF 318 may provide policy information defined in clause 5.2.5.4 (and in TS 23.503) to SMF 700.

The PCF 318 may provide the information identifying the MB Service(s) that the UE 102 may be authorized to use.

At steps 1122, if Request Type indicates “initial request”, the SMF 700 initiates an N4 Session Establishment procedure with the selected UPF 304, otherwise it initiates an N4 Session Modification procedure with the selected UPF 304:

The SMF 700 sends an N4 Session Establishment/Modification Request to the UPF 304 and provides Packet detection, enforcement and reporting rules to be installed on the UPF 304 for this PDU Session. If CN Tunnel Info is allocated by the SMF 700, the CN Tunnel Info is provided to UPF 304 in this step. If the selective User Plane deactivation is required for this PDU Session, the SMF 700 determines the Inactivity Timer and provides it to the UPF 304. The SMF 700 provides Trace Requirements to the UPF 304 if it has received Trace Requirements.

The SMF 700 may provide MB Session ID and UE Group ID to the UPF 304. The SMF 700 may assign a separate UL N3 (or N9) CN Tunnel ((R)AN ID, UL TEID) to the UPF 304. The SMF 700 may send the DL CN Tunnel information to the UPF 304, which may include (R)AN ID and DL TEID of N3 (or N9) interface. The DL TEID may be a shared DL TEID, which is assigned to send DL PDUs of a group of UEs or DL PDUs of the MB Session identified by the MB Session ID. If a new DL Tunnel is assigned to the MB Session, or to the UE Group, the UPF 304 may modify the FAR in the UPF 304 according to the FAR provided by the SMF 700 so that the DL MB data may be sent to the DL Tunnel of the UE (or UE Group), or MB Session.

At step 1124, the UPF 304 acknowledges by sending an N4 Session Establishment/Modification Response to SMF 700. If CN Tunnel Info is allocated by the UPF 304, the CN Tunnel Info may also be provided to SMF 700 in this step. If multiple UPFs 304 are selected for the PDU Session, the SMF 700 may initiate N4 Session Establishment/Modification procedure with each UPF 304 of the PDU Session in this step. If the Request Type indicates “Existing PDU Session”, and the SMF 700 creates CN Tunnel Info, then this step is skipped. Otherwise, this step is performed to obtain the CN Tunnel Info from the UPF 304 using the N4 Session Modification Procedure.

At step 1126, referring to FIG. 11B, the SMF 700 sends to AMF 701 an Namf_Communication_N1N2MessageTransfer (PDU Session ID, N2 SM information (PDU Session ID, QFI(s), QoS Profile(s), CN Tunnel Info, S-NSSAI from the Allowed NSSAI, Session-AMBR, PDU Session Type, User Plane Security Enforcement information, UE Integrity Protection Maximum Data Rate, MB Session ID, UE Group ID), N1 SM container (PDU Session Establishment Accept (QoS Rule(s) and QoS Flow level QoS parameters if needed for the QoS Flow(s) associated with the QoS rule(s), selected SSC mode, S-NSSAI(s), DNN, allocated IPv4 address, interface identifier, Session-AMBR, selected PDU Session Type, Reflective QoS Timer (if available), P-CSCF address(es), [Always-on PDU Session], MB Session ID, UE Group ID))). If multiple UPFs 304 are used for the PDU Session, the CN Tunnel Info may contain tunnel information related with the UPF 304 that terminates N3.

The N2 SM information carries information that the AMF 304 is to forward to the (R)AN. The N2 SM information may include the CN Tunnel Info corresponding to the Core Network address of the N3 tunnel corresponding to the PDU Session. The CN Tunnel Info could indicate the same UL Tunnel that has been used by some other UEs; these other UEs may be in the same UE Group as the UE 102, or these UEs may join the same MB Session indicated by the MB Session ID and/or TMGI. The N2 SM information may also include one or multiple QoS profiles and the corresponding QFIs, which is further described in TS 23.501, clause 5.7. The N2 SM information may also include the PDU Session ID that may be used by AN signalling with the UE 102 to indicate to the UE the association between (R)AN resources and a PDU Session for the UE 102. The N2 SM information may also include a PDU Session that is associated to an S-NSSAI of the HPLMN and, if applicable, to a S-NSSAI of the VPLMN, and a DNN. The S-NSSAI provided to the (R)AN, is the S-NSSAI with the value for the Serving PLMN (i.e. the HPLMN S-NSSAI or, in LBO roaming case, the VPLMN S-NSSAI). The N2 SM information may also include User Plane Security Enforcement information which is determined by the SMF 700 as described in clause 5.10.3 of TS 23.501.

If the User Plane Security Enforcement information indicates that Integrity Protection is “Preferred” or “Required”, the SMF 700 may also include the UE Integrity Protection Maximum Data Rate as received in the PDU Session Establishment Request in the N2 SM information. The N2 SM information may also include the MB Session ID, TMGI, and UE Group ID. For the MB Session ID and/or TMGI, and/or UE Group ID, the (R)AN 302 may use the MB Session ID to determine whether to establish a separate DL tunnel for the PDU Session or to use an existing DL tunnel, e.g. a shared DL N3 (or N9) tunnel, to receive DL PDUs of the MB Session. The (R)AN 302 may use the MB Session ID, and/or TMGI, and/or UE Group ID to associate the UE 102 with a Group Context, such as MB Session Context, or Group PDU Session Context in which the UE members of the group may have the same QoS parameters of QoS profiles.

The N1 SM container may contain the PDU Session Establishment Accept that the AMF 701 is to provide to the UE 102. If the UE 102 requested P-CSCF discovery, then the message may also include the P-CSCF IP address(es) as determined by the SMF 700. The PDU Session Establishment Accept includes S-NSSAI from the Allowed NSSAI. For LBO roaming scenario, the PDU Session Establishment Accept includes the S-NSSAI from the Allowed NSSAI for the VPLMN and also includes the corresponding S-NSSAI of the HPLMN from the Mapping Of Allowed NSSAI that the SMF 700 received in step 1106. If the PDU Session being established was requested to be an always-on PDU Session, the SMF 700 may indicate whether the request is accepted by including an Always-on PDU Session Granted indication in the PDU Session Establishment Accept message. If the PDU Session being established was not requested to be an always-on PDU Session but the SMF 700 may determine that the PDU Session needs to be established as an always-on PDU Session, the SMF 700 may include an Always-on PDU Session Granted indication in the PDU Session Establishment Accept message indicating that the PDU session is an always-on PDU Session. The SMF 700 may also include the MB Session ID and/or TMGI so that the UE 102 knows that this PDU Session is established for the UE to receive DL MB data of a MB Session identified by MB Session ID and/or TMGI. The SMF 700 may also include the UE Group ID and/or TMGI so that the UE 102 knows that this PDU is established for the UE 102 to communicate with UEs of a UE Group identified by UE Group ID and/or TMGI.

The PDU Session Establishment Accept within the N1 SM and in the N2 SM information may also include multiple QoS Rules and QoS Flow level QoS parameters if needed for the QoS Flow(s) associated with those QoS rule(s) and QoS Profiles.

The Namf_Communication_N1N2MessageTransfer may contain the PDU Session ID, and/or MB Session ID, and/or TMGI, and/or UE Group ID, allowing the AMF 701 to know which type of access network towards the UE 102 to use.

If the PDU session establishment failed anywhere between step 1110 and step 1126, then the Namf_Communication_N1N2MessageTransfer request may include the N1 SM container with a PDU Session Establishment Reject message (as described in clause 8.3.3 of TS 24.501) and may not include any N2 SM container. The (R)AN 302 may then send the NAS message containing the PDU Session Establishment Reject to the UE 102. In this case, steps 1128 to 1142 are skipped.

At step 1128, the AMF 701 sends to (R)AN 302 an N2 PDU Session Request (N2 SM information, NAS message (PDU Session ID, N1 SM container (PDU Session Establishment Accept))).

The AMF 701 sends the NAS message containing PDU Session ID and PDU Session Establishment Accept targeted to the UE 102 and the N2 SM information received from the SMF 700 within the N2 PDU Session Request to the (R)AN 302.

At step 1130, the (R)AN 302 may issue AN specific signalling exchange with the UE 102 that is related with the information received from SMF 700. For example, in case of a NG-RAN, an RRC Connection Reconfiguration may take place with the UE 102 establishing the necessary NG-RAN resources related to the QoS Rules for the PDU Session request received in step 1128.

The (R)AN 302 also allocates (R)AN N3 Tunnel Info for the PDU Session. In case of Dual Connectivity, the Master RAN node may assign some (zero or more) QFIs to be setup to the Master RAN node and other QFIs to the Secondary RAN node. The AN Tunnel Info includes a tunnel endpoint for each involved (R)AN node, and the QFIs assigned to each tunnel endpoint. A QFI can be assigned to either the Master RAN node or the Secondary RAN node but not to both.

The (R)AN 302 forwards the NAS message (PDU Session ID, N1 SM container (PDU Session Establishment Accept)) provided in step 1128 to the UE 102. The (R)AN 302 may only provide the NAS message to the UE 102 if the AN specific signalling exchange with the UE 102 includes the (R)AN resource additions associated to the received N2 command.

If Mobile Initiated Connection Only (MICO) mode is active and the NAS message Request Type in step 1102 indicates an “Emergency Request”, then the UE 102 and the AMF 701 may locally deactivate MICO mode.

If the MB Session ID and/or TMGI is provided in the N2 PDU Session Request, the (R)AN 302 may notify the UE 102 about the radio configuration of the existing radio channel that is used to deliver DL MB PDUs. The (R)AN 302 may include the MB Session ID and/or TMGI, UE Group ID.

At step 1132 the (R)AN 302 sends to AMF 701 an N2 PDU Session Response (PDU Session ID, Cause, N2 SM information (PDU Session ID, AN Tunnel Info, List of accepted/rejected QFI(s), User Plane Enforcement Policy Notification)).

The AN Tunnel Info corresponds to the Access Network address of the N3 tunnel corresponding to the PDU Session. The (R)AN 302 may use the MB Session ID, and/or TMGI, and/or UE Group ID to decide whether to establish a new N3 DL tunnel or use an existing DL N3 tunnel (the same DL N3 TEID) that is currently used for an existing MB Session, to connect with the UPF 304 for DL data transmission. If a new DL N3 tunnel is established, the UPF 304 may send the DL MB data over this newly established DL N3 tunnel to the (R)AN 302. If an existing DL N3 tunnel is used, the UPF 304 may send the MB data of the MB Session over this shared existing DL N3 tunnel for the group of UEs.

If the (R)AN 302 rejects QFI(s), the SMF 700 is responsible for updating the QoS rules and QoS Flow level QoS parameters if needed for the QoS Flow associated with the QoS rule(s) in the UE accordingly.

When the NG-RAN cannot fulfil User Plane Security Enforcement information with a value of Required, the NG-RAN rejects the establishment of UP resources for the PDU Session. The NG-RAN notifies the SMF 700 when it cannot fulfil a User Plane Security Enforcement with a value of Preferred.

At step 1134, the AMF 701 sends to SMF 700 an Nsmf_PDUSession_UpdateSMContext Request (SM Context ID, N2 SM information, Request Type). The AMF 701 forwards the N2 SM information received from (R)AN 302 to the SMF 700.

If the list of rejected QFI(s) is included in the N2 SM information, the SMF 700 may release the rejected QFI(s) associated QoS profiles.

If the User Plane Enforcement Policy Notification in the N2 SM information indicates that no user plane resources could be established, and the User Plane Enforcement Policy indicates “required” as described in clause 5.10.3 of TS 23.501, the SMF 700 may reject the PDU session establishment by including an N1 SM container with a PDU Session Establishment Reject message (further described in clause 8.3.3 of TS 24.501) in the Nsmf_PDUSession_UpdateSMContext Response in step 1142. In this case, steps 1136, 1138 and 1140 are skipped.

At step 1136, the SMF 700 initiates an N4 Session Modification procedure with the UPF 304. The SMF 700 provides the AN Tunnel Info to the UPF 304 as well as the corresponding forwarding rules.

If the (R)AN 302 sends a new DL N3 tunnel ID (TEID) for the MB Session in step 1132, the forwarding rules may indicate which QoS flow of the PDU Session is to carry the DL MB data.

It should be noted that if the PDU Session Establishment Request was due to mobility between 3GPP and non-3GPP access or mobility from EPC, the downlink data path is switched towards the target access in this step.

At step 1138, the UPF 304 provides an N4 Session Modification Response to the SMF 700. If multiple UPFs 304 are used in the PDU Session, the UPF 304 in steps 1136 and 1138 refers to the UPF terminating N3.

After this step, 1138, the UPF 304 delivers any down-link packets to the UE 102 that may have been buffered for this PDU Session.

At step 1140, if Request Type in step 1106 indicates neither “Emergency Request” nor “Existing Emergency PDU Session” and, if the SMF 700 has not yet registered for this PDU Session, then the SMF 700 registers with the UDM 320 using Nudm_UECM_Registration (SUPI, DNN, PDU Session ID, SMF Identity) for a given PDU Session. As a result, the UDM 320 stores the following information: SUPI, SMF identity and the associated DNN and PDU Session ID. The UDM 320 may further store this information in UDR by Nudr_DM_Update (SUPI, Subscription Data, UE context in SMF data).

If the Request Type received in step 1106 indicates “Emergency Request”, for an authenticated non-roaming UE, based on operator configuration (e.g. related with whether the operator uses a fixed SMF for Emergency calls, etc.), the SMF 700 may register in the UDM 320 using Nudm_UECM_Registration (SUPI, PDU Session ID, SMF identity, Indication of Emergency Services) for a given PDU Session that is applicable for the emergency services. As a result, the UDM 320 stores the applicable PDU Session for Emergency services.

If the Request Type received in step 1106 indicates “Emergency Request”, for an unauthenticated UE or a roaming UE, the SMF 700 may not register in the UDM 320 for a given PDU Session.

If the PDU Session is established for a UE to join an MB Session and receive MB data, the SMF 700 may send one or more of following information to the UDM 320 in step 1140: MB Session ID, PDU Session ID, TMGI, and UE Group ID.

At step 1142, the SMF 700 sends to AMF 701 an Nsmf_PDUSession_UpdateSMContext Response (Cause).

The SMF 700 may subscribe to the UE mobility event notification from the AMF 701 (e.g. location reporting, UE moving into or out of Area of Interest), after this step by invoking Namf_EventExposure_Subscribe service operation as specified in clause 5.2.2.3.2. For LADN, the SMF 700 may subscribe to the UE moving into or out of LADN service area event notification by providing the LADN DNN as an indicator for the Area of Interest (as described in clause 5.6.5 and 5.6.11 of TS 23.501).

After this step, the AMF 701 forwards relevant events subscribed by the SMF 700.

Step 1144 is a conditional step in which the SMF 700 sends to AMF 701 an Nsmf_PDUSession_SMContextStatusNotify (Release).

If during the procedure, any time after step 1110, the PDU Session establishment is not successful, the SMF 700 informs the AMF 701 by invoking Nsmf_PDUSession_SMContextStatusNotify (Release). The SMF 700 may also release any N4 session(s) created, any PDU Session address if allocated (e.g. IP address) and the association with PCF, if any. In this case, step 1146 is skipped.

At step 1146, the SMF 700 sends to UE 102, via the UPF 304 the IPv6 Address Configuration. In case of PDU Session Type IPv6 or IPv4v6, the SMF 700 generates an IPv6 Router Advertisement and sends it to the UE 102 via N4 and the UPF 304.

At step 1148, if the PDU Session establishment failed after step 1108 and if the SMF 700 is no longer handling a PDU Session of the UE for this DNN, S-NSSAI of the HPLMN, the SMF 700 may perform the following: the SMF 700 may unsubscribe to the modifications of Session Management Subscription data for the corresponding SUPI, DNN, S-NSSAI of the HPLMN, using Nudm_SDM_Unsubscribe (SUPI, Session Management Subscription data, DNN, S-NSSAI of the HPLMN). Further, the UDM 320 may unsubscribe to the modification notification from UDR by invoking the Nudr_DM_Unsubscribe (SUPI, Subscription Data, Session Management Subscription data, S-NSSAI of the HPLMN, DNN).

An alternative method for a UE to use an existing PDU Session to receive the MB data will now be discussed. First the UE 102 may establish a PDU session to communicate with the AS 204 in the DN 306. The UE 102 may send a request to the AS 204 to join an MB Session in the UP. The AS 204 may send a response to the UE 102, including in the response the information to identify the MB Session, such as any combination of parameters: MB Session ID, TMGI, packet filter(s) of the DL MB data stream(s), IP multicast address(es) of the router or the server, the UPF that may provide UP connection to the existing MB Session(s). The UE 102 then may send a request to the mobile network to join one or more MB Sessions. In the request, the UE 102 includes some information received from the AS 204 to help mobile network identify the MB Session that the UE wants to join.

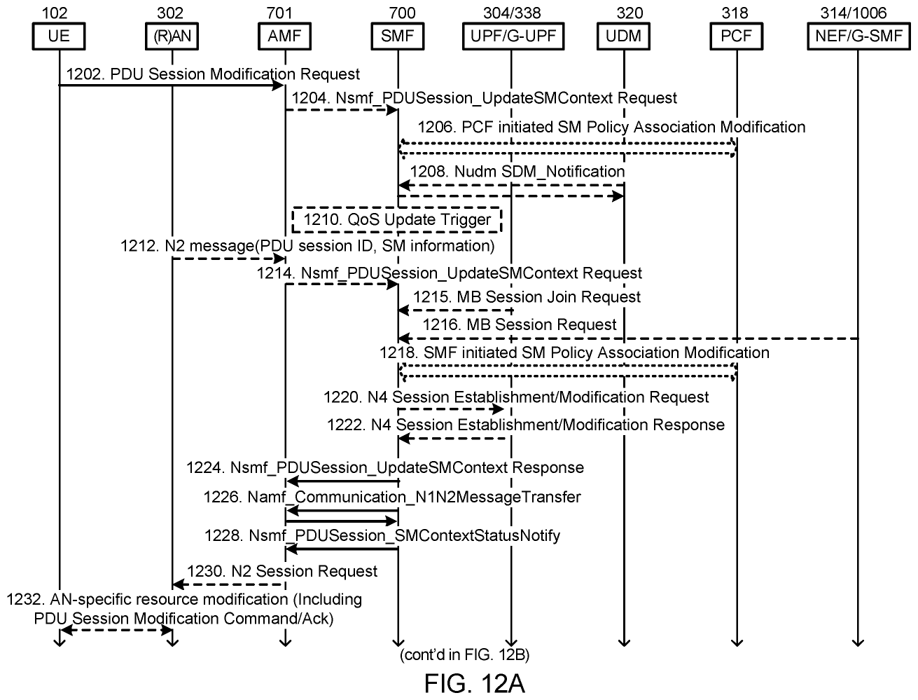

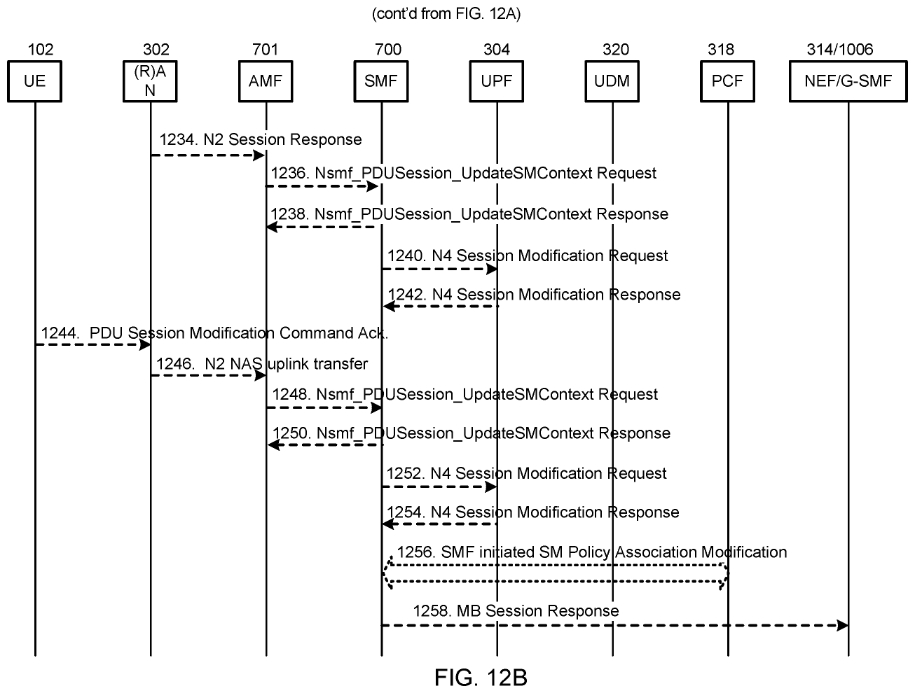

FIG. 12A and FIG. 12B are illustrations of a method for using an existing PDU session to allow a UE joining an MB Session by a UE or a network requested PDU session modification procedure for non-roaming and roaming with local breakout, according to an embodiment of the present disclosure.

The PDU Session Modification procedure may be triggered via one or more of the following steps: 1202, 1204, 1206, 1208, 1210, 1212, 1214 and 1216 as will be further discussed below.

Step 1202 is a UE initiated PDU Session modification procedure. At step 1202, the UE 102 initiates the PDU Session Modification procedure by the transmission of an NAS message. The NAS massage my comprise N1 SM container (PDU Session Modification Request (PDU session ID, Packet Filters, Operation, Requested QoS, Segregation, 5GSM Core Network Capability, Number Of Packet Filters, [Always-on PDU Session Requested])), PDU Session ID, UE Integrity Protection Maximum Data Rate MB Session ID, TMGI, IP Multicast Address, and UE Group ID. Depending on the Access Type, if the UE 102 was in CM-IDLE state, this SM-NAS message is preceded by the Service Request procedure. The NAS message is forwarded by the (R)AN 302 to the AMF 308 with an indication of User location Information.

At step 1204, the AMF 308 invokes Nsmf_PDUSession_UpdateSMContext (SM Context ID, N1 SM container (PDU Session Modification Request)) toward SMF 700.

When the UE 102 requests specific QoS handling for selected SDF(s), the PDU Session Modification Request includes Packet Filters describing the SDF(s), the requested Packet Filter Operation (add, modify, delete) on the indicated Packet Filters, the Requested QoS and optionally a Segregation indication. The Segregation indication is included when the UE 102 recommends the network to bind the applicable SDF(s) on a distinct and dedicated QoS Flow, which may occur even if an existing QoS Flow can support the requested QoS. The network should abide by the UE request, but the network is allowed to proceed instead with binding the selected SDF(s) on an existing QoS Flow.

The UE 102 may use the PDU Session Modification Request to request the mobile network to establish a new QoS in order to receive the DL MB data from the AS. The PDU Session Modification Request may include the MB Session ID, TMGI, IP Multicast Address, and Packet Filter(s) of the data flow that currently transports the MB PDUs. The UE 102 may receive the MB Session ID, TMGI, IP Multicast Address, and Packet Filters sent from the AS 204 earlier. The Packet Filter(s) may include the IP multicast address of the MBSA UPF. The Packet Filter may also include the IP multicast address of the AS. The requested Packet Filter Operation is set to “Add” so that the SMF 700 may recognize the UE request to receive the MB data from an AS.

It should be noted that only one QoS Flow is used for traffic segregation. If the UE 102 makes subsequent requests for segregation of additional SDF(s), the additional SDF(s) are multiplexed on the existing QoS Flow that is used for segregation.

The UE 102 may not trigger a PDU Session Modification procedure for a PDU Session corresponding to a LADN when the UE 102 is outside the area of availability of the LADN.

The PS Data Off status, if changed, may be included in the PCO in the PDU Session Modification Request message.

For a PDU Session which was established in the EPS, when the UE 102 moves from EPS to 5GS for the first time, the UE 102 includes an Always-on PDU Session Requested indication in the PDU Session Modification Request message if it wants to change the PDU Session to an always-on PDU Session.

When PCF 318 is deployed, the SMF 700 further reports the PS Data Off status to PCF 318 if the PS Data Off event trigger is provisioned, the additional behaviour of SMF 700 and PCF 318 for 3GPP PS Data Off is defined in TS 23.503.

The 5GSM Core Network Capability is provided by the UE and handled by SMF 700 as defined in TS 23.501 clause 5.4.4b.

The UE Integrity Protection Maximum Data Rate indicates the maximum data rate up to which the UE can support UP integrity protection.

The Number of Packet Filters indicates the number of supported packet filters for signalled QoS rules as described in TS 23.501 clause 5.17.2.2.2.

Step 1206 is an SMF requested PDU Session modification trigger. The PCF 318 performs a PCF initiated SM Policy Association Modification procedure as defined in TS 23.502, clause 4.16.5.2 to notify the SMF 700 about the modification of policies. This may have been triggered by a policy decision or upon AF requests, e.g. Application Function influence on traffic routing as described in step 5 in clause 4.3.6.2, of TS 23.502. The PCF 318 may receive a request from the AF to support DL MB session.

At step 1208, the UDM 320 updates the subscription data of SMF 700 by Nudm_SDM_Notification (SUPI, Session Management Subscription Data). The SMF 700 updates the Session Management Subscription Data and acknowledges the UDM 320 by returning an Ack with (SUPI).

The UDM 320 may receive from the AF 322, either directly or indirectly, the information on the UEs (e.g. UE ID like SUPI, GPSI) that are part of a UE group, or the UE ID(s) that wants to join an existing MB Session. The UDM 320 may notify the SMF 700 with one or more of following information in the Session Management Subscription Data: UE Group ID (e.g. Internal Group ID, External Group ID), an indication to establish one or more DL QoS flow to receive MB data, the DL packet filter(s) associated with QoS flow carrying the MB data, MB Session ID, TMGI, IP Multicast Address, Application ID, DNAI(s), DNN(s), and S-NSSAI(s).

At step 1210, the SMF 700 may decide to modify the PDU Session based on a locally configured policy or a trigger from the (R)AN 302 (as described in TS 23.502 clause 4.2.6 and clause 4.9.1). The SMF request modification may also be triggered if the UP connection is activated (as described in Service Request procedure in clause 4.2.3 of TS 23.502) and the SMF 700 has marked that the status of one or more QoS Flows are deleted in the 5GC but not synchronized with the UE 102 yet.

If the SMF 700 receives one of the triggers in steps 1206, 1208, or 1210, the SMF 700 starts an SMF requested PDU Session Modification procedure.

Step 1212 is an AN initiated PDU Session modification procedure. At step 1212, the (R)AN 302 indicates to the SMF 700, via AMF 700, when the AN resources onto which a QoS Flow is mapped are released irrespective of whether the notification control is configured. The (R)AN 302 sends an N2 message comprising PDU Session ID and N2 SM information to the AMF 701. The N2 SM information includes the QFI, User location Information and an indication that the QoS Flow is released.

At step 1214, the AMF 701 invokes Nsmf_PDUSession_UpdateSMContext (SM Context ID, N2 SM information) toward SMF 700.

In the case that the notification control is configured for a GBR Flow, the (R)AN 302 sends an N2 message (PDU Session ID, N2 SM information) to SMF 700 when the (R)AN 302 decides that the QoS targets of the QoS Flow cannot be fulfilled or can be fulfilled again. The N2 SM information includes the QFI and an indication that the QoS targets for that QoS Flow cannot be fulfilled or can be fulfilled again, respectively. The AMF 701 invokes Nsmf_PDUSession_UpdateSMContext (SM Context ID, N2 SM information). If the PCF 318 has subscribed to the QoS notification control event, the SMF 700 reports this event to the PCF 318 for each PCC Rule for which notification control is set, as discussed in step 1218 below. Alternatively, if dynamic PCC does not apply for this DNN, and depending on locally configured policy, the SMF 700 may start SMF requested PDU Session Modification procedure, as discussed in step 1222 below.

At step 1215, the UPF 304 or G-UPF 338 (or MBSA UPF) may detect a packet sent from the UE 102 in the UL indicating that the UE requests to join an MB Session. This packet could carry IGMP-Join message. The UPF 304 or G-UPF 338 forwards the MB Session Join Request of the UE 102 to the SMF 700. The MB Session Join Request may contain information to identify the MB Session, for example the UE ID (such as SUPI, GPSI, MB Session ID, TMGI, UE Group ID (e.g. Internal Group ID, External Group ID), IP Packet Filter(s) of the DL MB data flow, IP Multicast address(es) of the DL MB data flow. The SMF 700 may send an acknowledgment message to the UPF 304 or G-UPF 338; this message is not shown in FIG. 12A.

At step 1216, the NEF 314 or G-SMF 1006 may send a message to the SMF 700 to request the SMF 700 to add or modify existing QoS flows. The new QoS flow may be used to carry DL MB PDUs. One or more existing QoS flow of a PDU session may be used to carry DL MB PDUs. The message may include one or more of following information: MB Session ID, TMGI, DNN, S-NSSAI, Application ID, MBSA UPF, DNAI, QoS information (e.g. 5QI, maximum flow bit rate (MFBR), guaranteed flow bit rate (GFBR)), DL packet filter(s) of QoS flows and PDU Session, IP Multicast of G-UPF 388 (not shown in FIG. 12A and FIG. 12B).

The SMF 700 may be configured to support PDU sessions of some or all UEs of a UE Group. The NEF 314 may use the NRF services to discover the SMF 700 based on one or more of following information: DNN, S-NSSAI, and UE Group ID (e.g. Internal Group ID, External Group ID), MB Session ID, TMGI. The SMF 700 may also subscribe to NEF 314 to receive information sent from the AF 322 related to traffic routing between the UPF 304 (or G-UPF 338) and DN 306.

At step 1218, the SMF 700 may need to report some subscribed event to the PCF 318 by performing an SMF initiated SM Policy Association Modification procedure as defined in clause 4.16.5.1 of TS 23.502. This step may be skipped if the PDU Session Modification procedure is triggered by step 1206 or 1210. If dynamic PCC is not deployed, the SMF 700 may apply local policy to decide whether to change the QoS profile.

Steps 1220 to 1238 are not invoked when the PDU Session Modification requires only action at a UPF (e.g. gating).

At step 1220, if redundant transmission has not been activated for the PDU session and the SMF 700 decides to perform redundant transmission for a new QoS Flow, the SMF 700 allocates an additional CN Tunnel Info if CN Tunnel Info is allocated by the SMF 700. The additional CN Tunnel Info is provided to the UPF 304 via N4 Session Modification Request. The SMF 700 also indicates the UPF 304 to perform packet duplication and elimination for the QoS Flow.

If redundant transmission has been activated for the PDU Session, and the SMF 700 decides to stop redundant transmission, the SMF 700 indicates the UPF 304 to release the CN Tunnel Info which is used as the redundancy tunnel of the PDU Session, and also indicates the UPF 304 to stop packet duplication and elimination for the corresponding QoS Flow(s).

It should be noted that the method to perform elimination and reordering on RAN/UPF based on the packets received from the two GTP-U tunnels is up to RAN/UPF implementation. The two GTP-U tunnels are terminated at the same RAN node and UPF.

If redundant transmission has not been activated for the PDU Session and the SMF 700 decides to perform redundant transmission for a new QoS Flow with two intermediate UPFs (I-UPF) between the PSA UPF and the NG-RAN, the SMF 700 allocates CN Tunnel Info of the two I-UPFs if CN Tunnel Info is allocated by the SMF 700. The CN Tunnel Info of the two I-UPFs is provided to the I-UPFs via N4 Session Establishment Request messages including UL CN Tunnel Info of the PSA UPF. An N4 Session Modification Request message including the DL CN Tunnel Info of the two I-UPFs is sent to the PSA UPF. The SMF 700 indicates the PSA UPF to perform packet duplication and elimination for the QoS Flow.

In step 1220, the SMF 700 may configure one or more UPF, such as UPF 304 and G-UPF 338. In some embodiments, SMF 700 may further configure some I-UPF, UL CL, or branching point (BP) UPF if the I-UPF, and/or UL CL, and/or BP is needed to support DL UP connection between the G-UPF 338 and (R)AN 302. In some embodiments, the UPF 304 and G-UPF 338 may be two different UPFs. In some embodiments, the UPF 304 and G-UPF 339 may be the same UPF.

If the one or more messages in steps 1202, 1206, 1215, 1216 include information to support a UE joining an MB Session, the SMF 700 may send an N4 Session Modification request to the UPF304 (or G-UPF 338). The message may include one or more of following information: the information to identify MB Session (e.g. IP Multicast Address, DL Packet Filter(s), MB Session ID, TMGI), information to identify the DL N3 tunnel (e.g. (R)AN address and DL TEID), N9 DL tunnel information (e.g. address of UPF 304 or another I-UPF), forward action rule(s) (FAR), usage reporting rule(s) (URR), QoS Enforcement Rule(s) (QER), Packet Detection Rule(s) (PDR) updates. The QER may include the new values of QoS values, such as the QoS parameters defined in Table 5.8.2.11.4-1 of TS 23.501. For example, the SMF 700 (or G-SMF 311) may provide new value(s) for maximum bit rate for UL and DL QoS flow(s) and/or PDU session, new value(s) for guaranteed bit rate for UL/DL QoS flow(s) and/or PDU session (session-AMBR). The UPF 304 (or G-UPF 338) may then use the information provided by the SMF 700 to forward MB packets received from the DN 306 in the DL and/or from other UEs in the UL to send to the DL N3 or N9 tunnel.

If the N9 DL tunnel is needed to connect the G-UPF 338 and the UPF 304, the UPF-304 may become a BP UPF. The SMF 700 may configure the UPF 304 to become a BP UPF.

In some embodiments, if the same DL UP path, which may include one or more of N3 tunnel and/or N9 DL tunnel, is used to carry MB PDUs from UPF 304 (or G-UPF 338 or MBSA UPF) to the (R)AN 302 for all UEs served by the same (R)AN 302, steps 1220 and 1222 may be skipped. At step 1222, the UPF 304 and/or G-UPF 338 responds to the SMF 700. If redundant transmission has not been activated for the PDU session and the SMF 700 indicated the UPF 304 to perform packet duplication and elimination for the QoS Flow in step 1220, the UPF 304 allocates an additional CN Tunnel Info if CN Tunnel Info is allocated by UPF 304. The additional CN Tunnel Info is provided to the SMF 700.

If redundant transmission has not been activated for the PDU Session and the SMF 700 decides to perform redundant transmission for new QoS Flow with two I-UPFs in step 1220, the I-UPFs allocate CN Tunnel Info if CN Tunnel Info is allocated by UPF. The CN Tunnel Info of two I-UPFs is provided to the SMF 700.

For UE or AN initiated modification, at step 1224, the SMF 700 responds to the AMF 701 through Nsmf_PDUSession_UpdateSMContext (N2 SM information (PDU Session ID, QFI(s), QoS Profile(s), Session-AMBR), N1 SM container (PDU Session Modification Command (PDU Session ID, QoS rule(s), QoS rule operation, QoS Flow level QoS parameters if needed for the QoS Flow(s) associated with the QoS rule(s), Session-AMBR, [Always-on PDU Session Granted]))). The QoS Profile, QoS rule and QoS Flow level QoS parameters are described in clause 5.7 of TS 23.501.

If the PDU Session Modification was requested by the UE 102 to modify a PDU Session to an always-on PDU Session, the SMF 700 may include an Always-on PDU Session Granted indication in the PDU Session Modification Command to indicate whether the PDU Session is to be changed to an always-on PDU Session or not.

If the PDU Session Modification was requested by the UE 102, or UDM 320, or NEF 314, or G-SMF 1006 for the UE 102 to join an MB Session, the SMF 700 may check whether the UE 102 is authorised to join the MB Session. The SMF 700 may have UE subscription information obtained from the UDM 320. If the SMF 700 does not have UE subscription information related to the MB Service, the SMF 700 may send a request to the UDM 320 to get the UE Subscription related to the MB Service. For example, the SMF 700 may send Nudm_SDM_Get to the UDM 320, including one or more of the following parameters: NF ID is the SMF 700 ID, Subscription data type may be set to MB Service Subscription (e.g. IPTV, Public Safety, V2X, IoT), Key for each Subscription data type may be set to UE ID (e.g. SUPI or GPSI), Data Sub Key may be set to specific MB Session information (e.g. MB Session ID, TMGI, IPTV channel, IP Multicast address). The UDM 320 may send to the SMF 700 one or more of following information: the MB Service Subscription information, an indication to accept or reject the UE request to join the MB Session. Based on the information provided by the UDM 320, the SMF 700 may decide whether to accept or reject the UE request to join MB Session(s).

If the PDU Session Modification requested by the UE 102, or UDM 320, or NEF 314, or G-SMF 1006 for the UE 102 to join an MB Session is accepted, the SMF 700 may send to the AMF 701 one or more of the following information related to the MB Session: UE ID (e.g. SUPI, GPSI) to join an MB Session, MB Session ID, TMGI, UE Group ID. The AMF 701 may store the received information in an MB Session Context.

The N2 SM information carries information that the AMF 701 provides to the (R)AN 302. The N2 SM information may include the QoS profiles and the corresponding QFIs to notify the (R)AN 302 that one or more QoS flows were added, or modified. The N2 SM information may further include only QFI(s) to notify the (R)AN 302 that one or more QoS flows were removed. The SMF 700 may indicate for each QoS Flow whether redundant transmission may be performed by a corresponding redundant transmission indicator. If the PDU Session Modification was triggered by the (R)AN Release as discussed in step 1212, the N2 SM information carries an acknowledgement of the (R)AN Release. If the PDU Session Modification was requested by the UE 102 for a PDU Session that has no established User Plane resources, the N2 SM information provided to the (R)AN 302 includes information for establishment of User Plane resources.

If redundant transmission has been activated for the PDU Session, and the SMF 700 decides to stop the redundant transmission, the SMF 700 indicates to the (R)AN 302 to release the AN Tunnel Info which is used as the redundancy tunnel of the PDU Session. The SMF 700 also indicates to the (R)AN 302 to stop packet duplication and elimination for the corresponding QoS Flow(s).

The N1 SM container carries the PDU Session Modification Command that the AMF 701 is to provide to the UE 102. The N1 SM container may include the QoS rules, QoS Flow level QoS parameters if needed for the QoS Flow(s) associated with the QoS rule(s) and corresponding QoS rule operation and QoS Flow level QoS parameters operation to notify the UE that one or more QoS rules were added, removed or modified.

If the UE 102 requested to add one or more QoS flows by requesting to add Packet Filter(s) in step 1202, and if the SMF 700 does not have the anchor UPF information, the SMF 700 may communicate with the G-SMF 1006 to get the anchor UPF information (such as MBSA UPF or G-UPF 338). This step is not shown in FIG. 12A. The SMF 700 may send a message to the G-SMF 1006, which may include one or more of following information: Packet Filters that was provided by the UE 102, the MB Session ID, TMGI, and UE Group ID. The G-SMF 1006 may have the UE Group information, which may indicate that the UE is authorized to receive the MB data. This indication could be part of UE Subscription information stored in the UDR and managed by the UDM 320. If the UE 102 is authorized to receive the MB data, the G-SMF 1006 may send a response message to the SMF 700 indicating the address of the anchor UPF. The anchor UPF could be the G-UPF 700, or MBSA UPF or a local switching UPF. If the UE is not authorized to receive the MB data, the G-SMF 1006 may send a response message to the SMF 700 that includes a rejection response and a cause of rejection.

In some embodiments, the G-AMF 309 (not shown in FIG. 12A) may have been selected or pre-configured to serve the MB Session. SMF 700, or G-SMF 311 may send information to G-AMF 309, the information including at least some MB Session information for the G-AMF 309, N2 SM message for the (R)AN 302, and N1 SM container for the UE 102. The MB Session information that is to be received by the G-AMF 309 may include one or more of the following parameters: UE ID (e.g. SUPI, GPSI) to join an MB Session, MB Session ID, TMGI, UE Group ID, and UE location information (such as (R)AN 302 address, cell ID). The AMF 701 may store the received MB Session information in an MB Session Context. The N2 SM message may contain the UE ID, MB Session ID, TMGI, UE Group ID (e.g. Internal Group ID), DL N3 tunnel information, an indication to establish a new DL tunnel for the MB data flow, QoS Profile(s) for the DL MB QoS flow(s), and QoS Profile(s) for UL QoS flow(s). The DL N3 tunnel may be an existing DL tunnel used to carry DL MB PDUs for all UEs that join the MB Session. The N1 SM message may include one or more of information: an indication of whether the UE request to join an MB Session is accepted or rejected, MB Session ID, TMGI, UE Group ID, Packet filter(s) of DL MB data flow, IP Multicast address of DL MB data flow. If the UE request to join the MB Session is accepted, the N1 SM container may include one or more of parameters: a decryption or deciphering key to decrypt the MB packets if the MB packets are encrypted or cyphered, QoS Rule(s) for the DL MB QoS flow(s), and QoS Rule(s) for UL QoS flow(s). The G-AMF 309 may send the N1 SM message towards the UE 102 via the AMF 701 and (R)AN 302. In some embodiments, the G-SMF 311 may send the N1 SM message towards the UE 102 via the AMF 701. The AMF 701 then send the N1 SM message to the (R)AN 302, and the (R)AN 302 sends the N1 SM message to the UE 102. The UE 102 may use an existing UL QoS flow or establish a new UL QoS flow to communicate with AS 204 in the DN 306.

For SMF requested modification, at step 1226, the SMF 700 invokes, toward AMF 701, Namf_Communication_N1N2MessageTransfer comprising N2 SM information (PDU Session ID, QFI(s), QoS Profile(s), Session-AMBR), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR)).

If the UE 102 is in CM-IDLE state and an ATC is activated, the AMF 701 updates and stores the UE context based on the Namf_Communication_N1N2MessageTransfer and steps 1230, 1232, 1234, 1236, and 1238 are skipped. When the UE 102 is reachable e.g. when the UE enters CM-CONNECTED state, the AMF 701 forwards the N1 message to synchronize the UE context with the UE.

The SMF 700 may add or modify one of more QoS flows parameters in the N2 SM information message and N1 SM container to support DL MB.

For SMF requested modification due to updated SMF-Associated parameters from the UDM 320, at step 1228, the SMF 700 may provide the SMF derived CN assisted RAN parameters tuning to the AMF 701. The SMF 700 invokes Nsmf_PDUSession_SMContextStatusNotify (SMF derived CN assisted RAN parameters tuning) towards the AMF 701. The AMF 701 stores the SMF derived CN assisted RAN parameters tuning in the associated PDU Session context for this UE.

At step 1230, the AMF 701 may send N2 PDU Session Request (N2 SM information received from SMF 700, NAS message (PDU Session ID, N1 SM container (PDU Session Modification Command))) Message to the (R)AN 302.

At step 1230, if the SMF 700 or G-SMF 311 notified the AMF 701 that the UE request to join the MB Session is accepted, the AMF 701 may send an N1 MM message (or N1 MM container) to the (R)AN 302 for the UE 102. The N1 MM message may contain one or more of the following parameters: Information to identify MB Session (e.g. MB Session ID, TMGI, UE group ID (e.g. Internal Group ID), packet filter(s) of DL MB data flow, IP Multicast address of DL MB data flow), security information for the UE to decode (or decrypt, decipher) the MB DL PDUs if the MB DL PDU(s) are encoded (encrypted, or ciphered), and service area of the MB Session (e.g. a list of (R)AN IDs, a list of cell ID(s), a list of tracking area IDs, a list of registration area IDs, a list of geographical zone ID(s)).

At step 1232, the (R)AN 302 may issue AN specific signalling exchange with the UE 102 that is related with the information received from SMF 700. For example, in case of a NG-RAN, an RRC Connection Reconfiguration may take place with the UE modifying the necessary (R)AN resources related to the PDU Session.

The (R)AN 302 may consider the updated CN assisted RAN parameters tuning to reconfigure the AS parameters.

At step 1232, if the (R)AN 302 received an N2 SM message from the SMF 700 or G-SMF 311, the (R)AN 302 may assign resources to serve the DL MB QoS flow(s) and/or UL QoS flow. The (R)AN 302 may assign one or more new DL tunnel (N3 DL tunnel ID (TEID)) for the UPF 304 (or G-UPF 338) to send DL MB PDUs. The (R)AN 302 may use an existing DL N3 tunnel (or DL N3MB tunnel) to receive the DL MB data for the UE 102. Based on the information of UE 102 and/or other UEs currently receiving the DL MB data of the same MB Session, indicated by e.g. MB Session ID or TMGI, the (R)AN 302 may select a suitable radio configuration parameters to deliver DL MB PDUs to the UE 102. For example, the (R)AN 102 may establish a separate unicast DRB for the UE 102; the (R)AN 102 may use an existing DRB, such as point-to-multipoint (PTM) or broadcast DRB, for the UE 102 and other UEs. The (R)AN 302 may send radio configuration parameters to the UE 102 so that the UE 102 can receive the DL MB PDUs. The (R)AN 302 may send to the UE 102 the N1 SM container received from the SMF 700 or G-SMF 311.

Referring to FIG. 12.B, at step 1234, the (R)AN 302 may acknowledge the N2 PDU Session Request by sending an N2 PDU Session Ack (N2 SM information (List of accepted/rejected QFI(s), AN Tunnel Info, PDU Session ID, Secondary RAT usage data), User location Information) Message to the AMF 701. In case of Dual Connectivity, if one or more QFIs were added to the PDU Session, the Master RAN node may assign one or more of these QFIs to a NG-RAN node which was not involved in the PDU Session earlier. In this case, the AN Tunnel Info includes a new N3 tunnel endpoint for QFIs assigned to the new NG-RAN node. Correspondingly, if one or more QFIs were removed from the PDU Session, a (R)AN node may no longer be involved in the PDU Session, and the corresponding tunnel endpoint is removed from the AN Tunnel Info. The NG-RAN may reject QFI(s) if it cannot fulfil the User Plane Security Enforcement information for a corresponding QoS Profile, e.g. due to the UE Integrity Protection Maximum Data Rate being exceeded.

If the PLMN has configured secondary RAT usage reporting, the NG-RAN node may provide RAN Usage Data Report.

If the redundant transmission has not been activated for the PDU session, and the SMF 700 indicates to the RAN 302 that one of the QoS Flow may perform redundant transmission, the RAN 302 includes an additional AN tunnel info in N2 SM information.

At step 1234, the (R)AN 302 may include in the N2 SM information message the DL AN tunnel for the DL MB QoS data flow. The DL AN tunnel may be a new or an existing DL AN tunnel. The DL AN tunnel may include (R)AN address and TEID.

At step 1234, the (R)AN 302 may send the N2 SM information to the G-AMF 309 (not shown in FIG. 12B).

At step 1236, the AMF 701 forwards the N2 SM information and the User location Information received from the (R)AN 302 to the SMF 700 via Nsmf_PDUSession_UpdateSMContext service operation. At step 1238, the SMF 700 replies with an Nsmf_PDUSession_UpdateSMContext Response. The N2 SM information may include Secondary RAT Usage Data.

If the (R)AN 302 rejects QFI(s), the SMF 700 is responsible for updating the QoS rules and QoS Flow level QoS parameters if needed for the QoS Flow(s) associated with the QoS rule(s) in the UE accordingly.

At step 1236, the AMF 701 may forward the N2 SM information to the G-SMF 311 (not shown in FIG. 12B).

In some embodiments, at step 1236, the AMF 701 may forward the N2 SM information to the G-AMF 309 (not shown in FIG. 12B), the G-AMF 309 may then forward the N2 SM information to the G-SMF 311.

At step 1240, the SMF 700 may update the N4 session of the UPF(s) that are involved in the PDU Session Modification by sending N4 Session Modification Request message to the UPF 304. At step 1242, the UPF 304 sends an N4 Session Modification Response to SMF 700.

If new QoS Flow(s) are to be created, the SMF 700 updates the UPF 304 with UL PDRs of the new QoS Flow. This allows the UL packets with the QFI of the new QoS Flow to be transferred.

It should be noted that if an additional AN Tunnel Info is returned by RAN 302 in step 1234, the SMF 700 informs the UPF 302 about this AN Tunnel Info for redundant transmission. In the case of redundant transmission with two I-UPFs, the SMF 700 provides AN Tunnel Info to the two I-UPFs. If the CN Tunnel Info of the two I-UPFs is allocated by the UPFs in step 1222, the SMF 700 also provides the DL CN Tunnel Info of the two I-UPFs to the UPF (PSA).

If the current UPF needs to be connected to the MBSA UPF, the SMF 700 may configure the UPF to become an intermediate UPF (I-UPF) or a Branching Point (BP) UPF. The SMF 700 may provide the N9 DL tunnel information that provides DL connection between the MBSA UPF (of G-UPF 338) and the UPF 304 (e.g. N9 DL TEID and MBSA UPF address).

The SMF 700 may also send N4 Session Modification Request to the MBSA UPF. The message may include one or more of following information: DL tunnel information and packet processing rules. The DL tunnel information could include N9 DL tunnel information (e.g. destination UPF (I-UPF, Switching Point UPF) address in the DL and DL TEID. The packet processing rules could include the packet forwarding action rule to connect the DL N6 interface and the DL N3 or N9 interface so that the MBSA UPF can distribute MB PDUs to the UEs.

If at step 1220, the SMF 700 (or G-SMF 311) decided to use an existing DL UP path to deliver the DL MB data to the UE 102, steps 1240 and 1242 may be skipped.

At step 1244, the UE 102 acknowledges the PDU Session Modification Command by sending a NAS message (PDU Session ID, N1 SM container (PDU Session Modification Command Ack)) message to (R)AN 302.

At step 1246, the (R)AN 302 forwards the NAS message to the AMF 701.

At step 1248, the AMF 701 forwards the N1 SM container (PDU Session Modification Command Ack) and User Location Information received from the (R)AN 302 to the SMF 700 via Nsmf_PDUSession_UpdateSMContext service operation. At step 1250, the SMF 700 replies with a Nsmf_PDUSession_UpdateSMContext Response.

If the SMF initiated modification is to delete QoS Flows (e.g. triggered by the PCF 318) which do not include QoS Flow associated with the default QoS rule and the SMF 700 does not receive a response from the UE 102, the SMF 700 marks that the status of those QoS Flows is to be synchronized with the UE 102.

The PDU Session Modification Command Ack may indicate the acknowledgment from the UE 102 to successfully join the requested MB Session.

At step 1248, the AMF 701 may forwards the N1 SM container to the G-SMF 311, either directly or via the G-AMF 309. This message is not shown in FIG. 12B.

At step 1252, the SMF 700 may update the N4 session of the UPF(s) 304 that are involved by the PDU Session Modification by sending an N4 Session Modification Request (N4 Session ID) message to the UPF 304. For a PDU Session of Ethernet PDU Session Type, the SMF 700 may notify the UPF 304 to add or remove Ethernet Packet Filter Set(s) and forwarding rule(s).

At step 1254, the UPF 304 may respond to SMF 700 with an N4 Session Modification Response.

It should be noted that the UPFs 304 that are impacted in the PDU Session Modification procedure depends on the modified QoS parameters and on the deployment. For example, in case of the session AMBR of a PDU Session with an UL CL changes, only the UL CL is involved. This also applies to step 1240 and 1242.

At step 1256, if the SMF 700 interacted with the PCF 318 in step 1206 or 1218, the SMF 700 notifies the PCF 318 whether the PCC decision could be enforced or not by performing an SMF initiated SM Policy Association Modification procedure as defined in clause 4.16.5.1 of TS 23.502.

The SMF 700 notifies any entity that has subscribed to User Location Information related with PDU Session change.

At step 1258, the SMF 700 may send an MB Session Response to the NEF 314 (or G-SMF 1006) to confirm the establishment of the UP for sending DL MB PDUs to the UE 102.

If step 1206 is triggered to perform Application Function influence on traffic routing by step 5 in clause 4.3.6.2 of TS 23.502, the SMF 700 may reconfigure the User Plane of the PDU Session as described in step 6 in clause 4.3.6.2 of TS 23.502.

In some embodiments the disclosure provides methods and systems for switching between downlink unicast delivery and downlink MB delivery for group communications. In some embodiments the disclosure provides methods and system for releasing or deactivating downlink user plane resources of a PDU session. In some embodiments the disclosure provides methods and system supporting service and session continuity during handover. In some embodiments the disclosure provides methods and system for fast notification of MB session to the UE during PDU session establishment. In some embodiments the disclosure provides methods and system for binding MB sessions to unicast PDU session during PDU session establishment to avoid assigning network resources for PDU session.

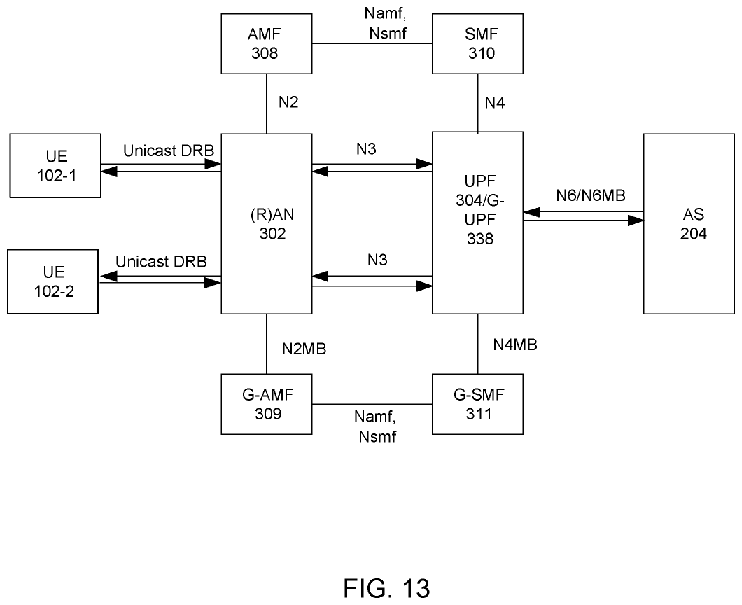

The disclosure further provides for methods for allowing an AS 204 to send MB data to one or multiple UE as shown in FIG. 13. The mobile network may establish individual UP path for each UE (UE 102-1 and UE 102-2) to forward MB data received from the G-UPF 338 (or UPF 304, or MBSA UPF) to each UE (UE 102-1 and UE 102-2). Each UP path may use a non-shared N3 (and N9) interface between the G-UPF 338 (or MBSA UPF) and the (R)AN node 302, and a unicast DRB between (R)AN 302 and the UE (UE 102-1 and UE 102-2). The (R)AN 302 may transmit the data received from the N3 interface to the UE by using a non-shared unicast DRB.

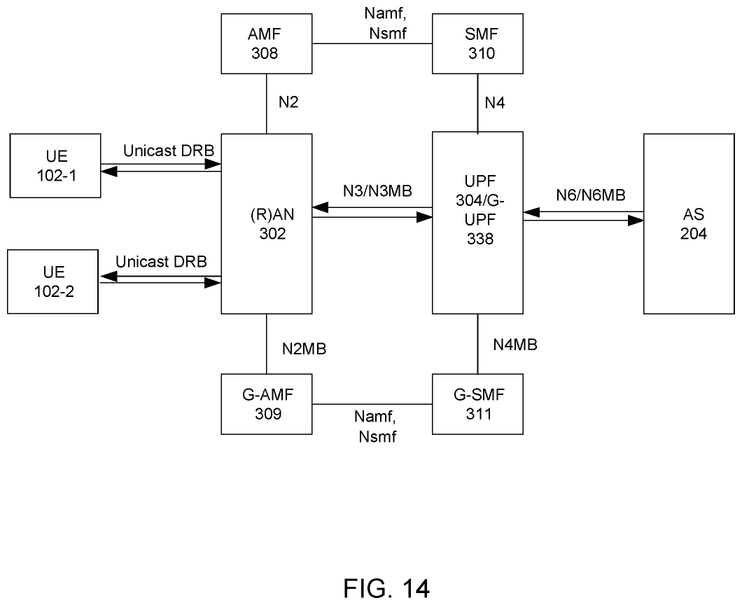

The disclosure further provides for methods for allowing an AS 204 to send MB data to one or multiple UE (UE 102-1 and UE 102-2) as shown in FIG. 14. The mobile network may establish a shared N3 interface (and shared N9 interface if I-UPF(s) is required) or shared N3MB interface between the G-UPF 308 (or UPF 304, or MBSA UPF) and the (R)AN node 302 to send MB data from the G-UPF 338 (or UPF 304, or MBSA UPF) to the (R)AN 302. The (R)AN 302 may establish multiple unicast DRB, each unicast DRB is used to send the MB data to each UE(UE 102-1 and UE 102-2).

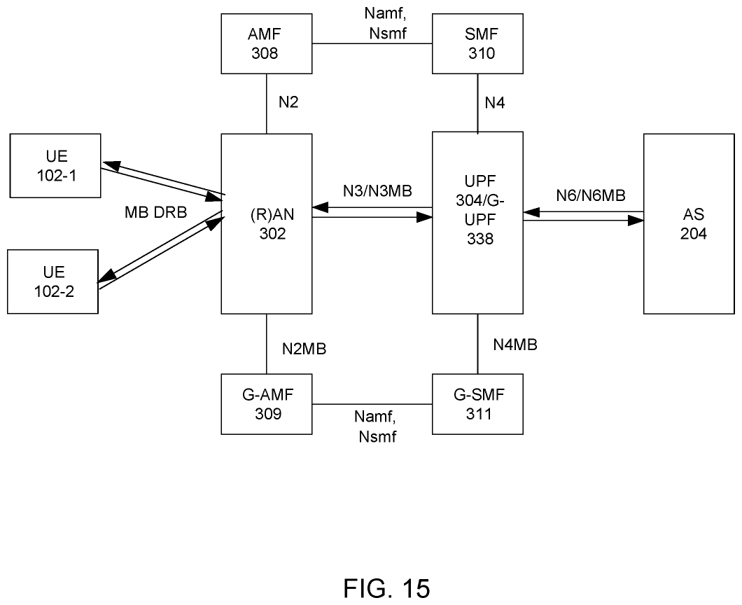

The disclosure further provides for methods for allowing an AS 204 to send MB data to one or multiple UE (UE 102-1 and UE 102-2) as shown in FIG. 15. The mobile network may establish a shared N3 interface (and shared N9 interface if I-UPF(s) is required) or shared N3MB interface between the G-UPF 308 (or UPF 304, or MBSA UPF) and the (R)AN node 302 to send MB data from the G-UPF 338 (or UPF 304, or MBSA UPF) to the (R)AN 302. The (R)AN 302 may establish a shared MB DRB unicast DRB to send the MB data to the targeted UEs or all UEs, which may receive the radio signal of the (R)AN 302.

An aspect of the disclosure provides for a network node including at least one network interface, at least one processor, and a non-transient computer readable memory for storing instructions which when executed by the at least one processor configure the network node to execute the methods described here. For example, such a network node is configured for receiving a request from a network exposure function (NEF), for session modification of a previously established protocol data unit (PDU) session for a user equipment (UE), the request indicating a switch of a unicast downlink (DL) delivery and a shared DL delivery. The network node is further configured for sending instructions to other network functions to implement the modification. The network node is further configured for sending a response to the NEF confirming the execution of the request

Another aspect of the disclosure provides for a method by a unified data management function (UDM). The method includes receiving a session establishment request from an application function (AF) via a network exposure function (NEF), wherein the session establishment request is for one of a multicast session and a broadcast session, the request including data of the one of the multicast session and the broadcast session. The method further includes creating a temporary mobile group identity (TMGI) to identify the multicast session and broadcast session according to the session establishment request. The method further includes sending a response to the AF via the NEF, the response including the TMGI. The method further includes notifying the data to a session management function (SMF) for the establishment of the session. In some embodiments the method further includes sending a request to a UDR to store the new session data. In some embodiments the method further includes receiving a response from the UDR indicating the storing of the session data.

Another aspect of the disclosure provides for a method of selecting a session anchor user plane function (UPF), by a session management function (SMF). The method includes subscribing to a unified data management function (UDM) for receiving data of one of a multicast session and a broadcast session associated with a session establishment request. The method further includes receiving the data, from the UDM, wherein the data includes information on a user equipment (UE). The method further includes selecting the session anchor UPF based on at least one of the data and a UE location of the UE. In some embodiments the user equipment (UE) location of the UE is obtained by the SMF from an access and mobility management function (AMF). In some embodiments the method further includes storing, by the SMF, the UE location of the UE into the UDM. In some embodiments, the method further includes sending, by the SMF, an acknowledgement response to the UDM.

Another aspect of the disclosure provides for a method, by a session management function (SMF). The method includes receiving a trigger associated with a session, the session being one of a multicast session and a broadcast session. The method further includes sending session information associated with the trigger to an access and mobility management function (AMF). The method further includes configuring other functions to transmit data of the session, wherein the data of the session includes data of a first UE and other UEs, the session being received by the first UE and the other UEs. In some embodiments, the trigger associated with the session is a request received from the AMF, wherein the request is associated with a PDU session modification request from the UE. In some embodiments, before the other functions are configured to transmit the data of the session, data of the first UE is transmitted in a unicast session. In some embodiments, the method further includes retrieving the session information according to the request from a UDM function.

Another aspect of the disclosure provides for a method, by a session management function (SMF). The method includes receiving, from a NEF, a trigger associated with a session, the session being one of a multicast session and a broadcast session. The method further includes configuring other functions to transmit data of the session, wherein the data of the session includes data of a first UE and other UEs and the session being received by the first UE and the other UEs. In some embodiments, the trigger from the NEF is received from an AF. In some embodiments, before the other functions are configured to transmit the data of the session, data of the first UE is transmitted in a unicast session.

Another aspect of the disclosure provides for a method, by a session management function (SMF). The method includes receiving, from a network function, an indication that a user equipment (UE) served by a first radio access network (RAN) node is to be served by a second RAN node, wherein the session being one of a multicast session and a broadcast session, and wherein the UE receiving data of a session associated with a user plane (UP) connection between a UPF and the first RAN node when the UE is served by the first RAN node. The method further includes establishing a UP connection for the session between the UPF and the second RAN node, wherein the UE receiving data of the session associated with the UP connection between the UPF and the second RAN node when the UE is served by the second RAN node. In some embodiments, the SMF sends information associated with the session to the second RAN node via an access and mobility management function (AMF) to trigger the establishment of the UP connection for the session between the UPF and the second RAN node.

Another aspect of the disclosure provides for a system including a session management function (SMF) and a network exposure function (NEF). In some embodiments, the SMF is configured for receiving a request from the NEF, for session modification of a previously established protocol data unit (PDU) session for a user equipment (UE), the request indicating a switch of a unicast downlink (DL) delivery and a shared DL delivery. In some embodiments the SMF is further configured for sending instructions to other network functions to implement the modification. In some embodiments the SMF is further configured for sending a response to the NEF confirming the execution of the request. In some embodiments, the NEF is configured for receiving a request from an application function and forwarding the request to the SMF.

Another aspect of the disclosure provides for a system including a network exposure function (NEF), a unified data management function (UDM), and a session management function (SMF). In some embodiments the UDM is configured for receiving a session establishment request from an application function (AF) via the NEF, wherein the session establishment request is for one of a multicast session and a broadcast session, and the request including data of the one of the multicast session and the broadcast session. In some embodiments the UDM is further configured for creating a temporary mobile group identity (TMGI) to identify the multicast session and broadcast session according to the session establishment request. In some embodiments the UDM is further configured for sending a response to the AF via the NEF, the response including the TMGI. In some embodiments the UDM is further configured for notifying the data to the session management function (SMF) for the establishment of the session. In some embodiments the SMF is configured for establishing the session using the TMGI.

Another aspect of the disclosure provides for a unified data management function (UDM). The UDM includes at least one network interface. The UDM further includes at least one processor. The UDM further includes a non-transient computer readable memory for storing instructions which when executed by the at least one processor configures the UDM to perform the methods described herein. For example, the UDM is configured for receiving a session establishment request from an application function (AF) via a network exposure function (NEF), wherein the session establishment request is for one of a multicast session and a broadcast session, the request including data of the one of the multicast session and the broadcast session. The UDM is further configured for creating a temporary mobile group identity (TMGI) to identify the multicast session and broadcast session according to the session establishment request. The UDM is further configured for sending a response to the AF via the NEF, the response including the TMGI. The UDM is further configured for notifying the data to a session management function (SMF) for the establishment of the session.

Another aspect of the disclosure provides for a session management function (SMF). The SMF includes at least one network interface. The SMF further includes at least one processor. The SMF further includes a non-transient computer readable memory for storing instructions which when executed by the at least one processor configures the SMF to perform the methods described herein. For example, the SMF is configured subscribing to a unified data management function (UDM) for receiving data of one of a multicast session and a broadcast session associated with a session establishment request. The SMF is further configured for receiving the data, from the UDM, wherein the data includes information on a user equipment (UE). The SMF is further configured for selecting the session anchor UPF based on at least one of the data and a UE location of the UE.

Another aspect of the disclosure provides for a system for selecting a session anchor user plane function (UPF). The system includes a session management function (SMF) and a unified data management function (UDM). In some embodiments, the SMF configured for subscribing to the UDM for receiving data of one of a multicast session and a broadcast session associated with a session establishment request. In some embodiments, the SMF is further configured for receiving the data, from the UDM, wherein the data includes information on a user equipment (UE). In some embodiments, the SMF is further configured for selecting the session anchor UPF based on at least one of the data and a UE location of the UE.

Another aspect of the disclosure provides for a session management function (SMF). The SMF includes at least one network interface. The SMF further includes at least one processor. The SMF further includes a non-transient computer readable memory for storing instructions which when executed by the at least one processor configures the SMF to perform the methods described herein. For example, the SMF is configured for receiving a trigger associated with a session, the session being one of a multicast session and a broadcast session. The SMF is further configured for sending session information associated with the trigger to an access and mobility management function (AMF). The SMF is further configured for configuring other functions to transmit data of the session, wherein the data of the session includes data of a first UE and other UEs, the session being received by the first UE and the other UEs.

Another aspect of the disclosure provides for a session management function (SMF). The SMF includes at least one network interface. The SMF further includes at least one processor. The SMF further includes a non-transient computer readable memory for storing instructions which when executed by the at least one processor configures the SMF to perform the methods described herein. For example, the SMF is configured for receiving, from a NEF, a trigger associated with a session, the session being one of a multicast session and a broadcast session. The SMF is further configured for configuring other functions to transmit data of the session, wherein the data of the session includes data of a first UE and other UEs, the session being received by the first UE and the other UEs.

Another aspect of the disclosure provides for a session management function (SMF). The SMF includes at least one network interface. The SMF further includes at least one processor. The SMF further includes a non-transient computer readable memory for storing instructions which when executed by the at least one processor configures the SMF to perform the methods described herein. For example, the SMF is configured for receiving, from a network function, an indication that a user equipment (UE) served by a first radio access network (RAN) node is to be served by a second RAN node, wherein the UE receiving data of a session associated with a user plane (UP) connection between a UPF and the first RAN node when the UE is served by the first RAN node, and the session being one of a multicast session and a broadcast session. The SMF is further configured for establishing a UP connection for the session between the UPF and the second RAN node; the UE receiving data of the session associated with the UP connection between the UPF and the second RAN node when the UE is served by the second RAN node.

Another aspect of the disclosure provides for a method for a service and session continuity, the method performed by a session management function (SMF). The method includes receiving, from a first access and mobility management function (AMF), a notification of a new location of a user equipment (UE), the notification indicating that the UE served by a source radio access network (RAN) node associated with a multicast/broadcast (MB) session is to be served by a target RAN node, the notification comprising an address of the target radio access network (RAN) node. The method further includes sending, to a user plane function (UPF), an N4 MB session modification request comprising one or more of: access network (AN) tunnel information and core network (CN) tunnel information. The method further includes receiving, from the user plane function (UPF), an N4 MB session modification response. The method allows for supporting service and session continuity for a MB session during a hand-over. The method further provides for performing handover procedure without UPF re-allocation.

In some embodiments, the method further includes sending, to the target RAN node via a second AMF, a message to establish the MB session in the target RAN node, the message comprising one or more of: a quality of service (QoS) profile of a DL QoS flow of the MB session; UE information; and CN information. In some embodiments, the method further includes receiving from the target RAN node via the second AMF, a message indicating confirmation of establishment of the MB session in the target RAN node. In some embodiments, the method further includes sending, to the UPF, an N4 MB session modification request comprising downlink DL tunnel information of the target RAN node for the UPF to send DL MB data to the target RAN node. In some embodiments, the method further includes receiving, from the UPF, an N4 session modification response indicating an update to the MB session.

Another aspect of the disclosure provides for a system for service and session continuity. The system includes a first access and mobility management function (AMF) configured for receiving, from a target radio access network (RAN) node, a path switch request indicating that a user equipment (UE) served by a source RAN node associated with a multicast/broadcast (MB) session is to be served by the target RAN node. The AMF further configured for sending, to a session management function (SMF), a notification of a new location of the UE, the notification comprising an address of the target RAN node. The system further includes the session management function (SMF) configured for receiving the notification from the first AMF. The SMF further configured for sending, to a user plane function (UPF), an N4 MB session modification request comprising one or more of: access network (AN) tunnel information and core network (CN) tunnel information. The SMF further configured for receiving, from the user plane function (UPF), an N4 MB session modification response. The system allows for supporting service and session continuity for a MB session during a hand-over. The system further provides for performing handover procedure without UPF re-allocation.

In some embodiments, the SMF is further configured for sending, to a second AMF, a message to establish the MB session in the target RAN node, the message comprising one or more of: a quality of service (QoS) profile of a DL QoS flow of the MB session; UE information; and CN information. In some embodiments, the system further includes the second AMF configured for receiving, from the SMF, the message to establish the MB session. In some embodiments, the second AMF is further configured for sending, to the target RAN node, the message to establish the MB session. In some embodiments, the second AMF is further configured for receiving, from the target RAN node, a message indicating confirmation of establishment of the MB session, the message comprising RAN tunnel information including RAN address and downlink (DL) N3 tunnel identifier (TEID). In some embodiments, the second AMF is further configured for sending to the SMF, the message indicating confirmation of establishment of the MB session in the target RAN node. In some embodiments, the SMF is further configured for receiving from the second AMF, a message indicating confirmation of establishment of the MB session in the target RAN node. In some embodiments, the SMF is further configured for sending, to the UPF, an N4 MB session modification request comprising downlink DL tunnel information of the target RAN node for the UPF to send DL MB data to the target RAN node. In some embodiments, the second AMF is further configured for receiving, from the UPF, an N4 session modification response indicating an update to the MB session.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

We claim:

1. A method, by a session management function (SMF), comprising:
receiving, from a network exposure function (NEF), a request for a protocol data unit (PDU) session modification, the request associated with at least one PDU session of at least one user equipment (UE), the request further indicating a switching between one of two different downlink (DL) delivery methods;
sending instructions to other network functions according to the request; and
sending, to the NEF, a response indicating a result of the request.

2. The method of claim 1, wherein the request further comprises at least one of:
packet filter information;
an indication to release network resources assigned to at least one DL QoS flow of the at least one UE;
an indication to deactivate network resources assigned to the at least one DL QoS flow of the at least one UE;
time information, and
location information.

3. The method of claim 1, wherein the step of sending instructions to other network functions according to the request comprises:
sending, to at one user plane function (UPF), instructions to monitor one or more DL quality of service (QoS) flow associated with at least one packet detection rule (PDR), and
receiving, from the at least one UPF, a notification indicating that no packets were detected for the DL QoS flow.

4. The method of claim 3, wherein the SMF receives the notification after an expiration of a time period included in the instructions.

5. The method of claim 1, wherein the request includes an indication to release network resources assigned to at least one DL quality of service flow (QoS), the step of sending instructions to other network functions according to the request comprises:
sending an N4 session modification request to at least one user plane function (UPF) to release information of the at least one DL QoS flow.

6. The method of claim 5, wherein the information of the at least one DL QoS flow comprises a packet filter in at least one of a packet detection rule (PDR) and a packet forwarding action rule (FAR).

7. The method of claim 1, wherein the request includes an indication to deactivate network resources assigned to at least one DL QoS flow, the step of sending instructions to other network functions according to the request comprises:
sending an N 4 session modification request to at least one user plane function (UPF) to release at least one packet forwarding action rule (FAR) associated with the at least one DL QoS flow.

8. The method of claim 7, further comprising:
receiving, from the at least one UPF, a notification indicating detection of a packet associated with the at least one DL QoS flow.

9. The method of claim 1, wherein the step of sending instructions to other network functions according to the request comprises:
sending to a radio access network (RAN) node, via an access and mobility management function (AMF), information indicating one or more of: addition, modification, and removal of one or more DL quality of service (QoS) flows, wherein the information comprising one or more of: a QoS profile and a QoS flow identifier (QFI).

10. The method of claim 1, wherein the two different DL delivery methods include a first DL delivery method being a unicast delivery associated with a unicast PDU session of the at least one PDU session and a second DL delivery method being a multicast/broadcast (MB) delivery associated with a MB session of the at least one PDU session.

11. The method of claim 10, wherein the request comprises:
information on DL Quality of Service (QoS) flow of the unicast PDU session used for delivering shared data; and
information on the MB session.

12. The method of claim 10, wherein the switching is from the second DL method to the first DL method:
the request comprises:
a list of at least one UE identifier for receiving data according to the first DL delivery method; and
one or more locations associated with the first DL delivery method.

13. A network node comprising:
at least one network interface;
at least one processor;
a non-transient computer readable memory for storing instructions which when executed by the at least one processor configure the network node for:
receiving, from a network exposure function (NEF), a request for a protocol data unit (PDU) session modification, the request associated with at least one PDU session of at least one user equipment (UE), the request further indicating a switching between one of two different downlink (DL) delivery methods;
sending instructions to other network functions according to the request; and
sending, to the NEF, a response indicating a result of the request.

14. The network node of claim 13, wherein the configuration for sending instructions to other network functions according to the request comprises:
sending, to at one user plane function (UPF), instructions to monitor one or more DL quality of service (QoS) flow associated with at least one packet detection rule (PDR), and
receiving, from the at least one UPF, a notification indicating that no packets were detected for the DL QoS flow.

15. The network node of claim 14, wherein the network node is configured to receives the notification after an expiration of a time period included in the instructions.

16. The network node of claim 13, wherein:
the request includes an indication to release network resources assigned to at least one DL quality of service flow (QoS); and
the configuration for sending instructions to other network functions according to the request comprises: sending an N4 session modification request to at least one user plane function (UPF) to release information of the at least one DL QoS flow.

17. The network node of claim 13, wherein:
the request includes an indication to deactivate network resources assigned to at least one DL QoS flow; and
the configuration for sending instructions to other network functions according to the request comprises: sending an N 4 session modification request to at least one user plane function (UPF) to release at least one packet forwarding action rule (FAR) associated with the at least one DL QoS flow.

18. The network node of claim 13, wherein the instructions further configure the network node for: receiving, from the at least one UPF, a notification indicating detection of a packet associated with the at least one DL QoS flow.

19. The network node of claim 13, wherein the configuration for sending instructions to other network functions according to the request comprises: sending to a radio access network (RAN) node, via an access and mobility management function (AMF), information indicating one or more of: addition, modification, and removal of one or more DL quality of service (QoS) flows, wherein the information comprising one or more of: a QoS profile and a QoS flow identifier (QFI).

20. The network node of claim 13, wherein the two different DL delivery methods include a first DL delivery method being a unicast delivery associated with a unicast PDU session of the at least one PDU session and a second DL delivery method being a multicast/broadcast (MB) delivery associated with a MB session of the at least one PDU session.
